(19) United States
(12) Patent Application Publication
(10) Pub. No.: US 2020/0301213 A1
(43) Pub. Date: Sep. 24, 2020

(54) LIQUID CRYSTAL DISPLAY ELEMENT AND METHOD FOR MANUFACTURING SAME

(71) Applicant: DIC Corporation, Tokyo (JP)

(72) Inventors: Shota Kosaka, Kitaadachi-gun (JP); Kazuki Kurisawa, Kitaadachi-gun (JP)

(73) Assignee: DIC Corporation, Tokyo (JP)

(21) Appl. No.: 16/088,694

(22) PCT Filed: Mar. 30, 2017
(86) PCT No.: PCT/JP2017/013197

§ 371 Date: Sep. 26, 2018

(30) Foreign Application Priority Data
Apr. 12, 2016 (JP) 2016-079556

(51) Int. Cl. G02F 1/1337; C09K 19/44; C09K 19/30; C09K 19/14; C09K 19/56

(52) U.S. Cl. CPC G02F 1/133788; C09K 19/44; C09K 19/30; G02F 2201/121; C09K 19/56; G02F 1/133711; G02F 2201/123; C09K 19/14

(57) ABSTRACT

The liquid crystal display device including a liquid crystal layer between a first substrate and a second substrate, the first substrate having a common electrode and a color filter, the second substrate having a plurality of pixels and having a pixel electrode in each pixel, the liquid crystal layer containing a liquid crystal composition, wherein the liquid crystal display device has no alignment film on one or both of the first substrate and the second substrate, but has an alignment control layer formed of a polymer of two or more polymerizable compounds, and contains a compound represented by the general formula (III).

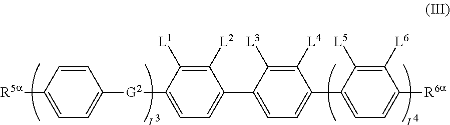

### TECHNICAL FIELD

The present invention relates to a liquid crystal display device that is useful as a constituent of liquid crystal TVs and the like and a method for manufacturing the liquid crystal display device.

### BACKGROUND ART

Liquid crystal display devices are used in various measuring instruments, automotive panels, word processors, electronic notebooks, printers, computers, television sets, clocks and watches, and advertising boards, as well as clocks and watches and electronic calculators. Typical liquid crystal display modes include twisted nematic (TN), super-twisted nematic (STN), vertical alignment (VA) with a thin-film transistor (TFT), and in-plane switching (IPS) with a TFT. Liquid crystal compositions for use in such liquid crystal display devices should be resistant to external factors, such as water, air, heat, and light, have a liquid crystal phase in as wide a temperature range as possible around room temperature, have low viscosity, and have a low drive voltage. A liquid crystal composition is composed of several to tens of compounds so as to achieve optimum dielectric constant anisotropy (Δε) or optimum refractive index anisotropy (Δn) of each liquid crystal display device.

VA displays include liquid crystal compositions of negative Δε and are widely used in liquid crystal TVs. There is a demand for low-voltage drive, high-speed response, and a wide operating temperature range in any drive mode. In other words, there is a demand for a high absolute Δε, a low viscosity (η), and a high nematic phase-isotropic liquid phase transition temperature (T_{NI}). Furthermore, in order to set the product Δn×d of Δn and the cell gap (d) at a predetermined value, the Δn of a liquid crystal composition must be adjusted in an appropriate range for the cell gap. Furthermore, because high-speed responsivity is important for liquid crystal display devices for use in television sets, liquid crystal compositions should have low rotational viscosity (γ₁).

In order to improve the viewing angle characteristics of VA displays, multi-domain vertical alignment (MVA) liquid crystal display devices have widely been used, which include protrusions on a substrate to align liquid crystal molecules in a pixel in different directions. Although MVA liquid crystal display devices have good viewing angle characteristics, the response speed of liquid crystal molecules near protrusions on a substrate is different from the response speed of liquid crystal molecules far from the protrusions. Thus, MVA liquid crystal display devices have the problem of an insufficient overall response speed because liquid crystal molecules far from protrusions have a low response speed, and also have the problem of low transmittance due to the protrusions. To solve the problems, polymer sustained alignment (PSA) liquid crystal display devices (including polymer stabilized (PS) liquid crystal display devices) have been developed. Unlike typical MVA liquid crystal display devices, PSA liquid crystal display devices have a uniform pretilt angle in a divided pixel without nontransparent protrusions in a cell. PSA liquid crystal display devices are manufactured by adding a small amount of polymerizable compound to a liquid crystal composition, injecting the liquid crystal composition into a liquid crystal cell, and polymerizing the polymerizable compound in the liquid crystal composition by active energy beam irradiation while a voltage is applied between electrodes. Thus, an appropriate pretilt angle can be provided in a divided pixel. This results in improved contrast due to improved transmittance and in high-speed responsivity due to the uniform pretilt angle (see Patent Literature 1, for example).

PSA liquid crystal display devices include a vertical alignment film on two substrates. In a liquid crystal display device proposed, a process for forming a vertical alignment film is eliminated to simplify the manufacturing process, improve the yield, and consequently reduce the cost. (See Patent Literature 2, for example).

It is described that like PSA liquid crystal display devices, a liquid crystal display device of this type can have improved transmittance, improved contrast, and possibly high-speed responsivity. However, a device thus manufactured sometimes has variations in display resulting from the manufacturing process. To reduce such variations in display, a method involving the use of a particular liquid crystal material is disclosed (see Patent Literature 3).

In such a liquid crystal display device in which a process for forming a vertical alignment film can be simplified to reduce the cost, a polymer produced by polymerization of a polymerizable compound in a liquid crystal composition is directly formed as an alignment control layer on a transparent electrode substrate on which no vertical alignment film is formed. Thus, fast polymerization of a polymerizable compound is very important in terms of productivity of a device. Furthermore, even a minute amount of residual polymerizable compound in a liquid crystal composition after polymerization may adversely affect the alignment consistency or alignment stability of liquid crystal molecules in the liquid crystal device. Thus, an alignment control layer should be stable and unchanged for extended periods.

### CITATION LIST

### Patent Literature

PTL 1: Japanese Unexamined Patent Application Publication No. 2002-357830

PTL 2: Japanese Unexamined Patent Application Publication No. 2004-302061

PTL 3: WO 2014/123056 A1

### SUMMARY OF INVENTION

### Technical Problem

In view of the situations described above, the present invention provides a liquid crystal display device and a method for manufacturing the liquid crystal display device, wherein a process for forming a vertical alignment film on an electrode substrate is simplified, and a polymerizable compound in a liquid crystal composition is polymerized to form an alignment control layer on the electrode substrate. The liquid crystal display device has display performance of high-contrast and high-speed response. The time required to form the alignment control layer on the electrode substrate by polymerization of the polymerizable compound is greatly reduced. The amount of residual polymerizable compound is decreased to greatly reduce the temporal changes of the alignment control layer. This improves the alignment stability of liquid crystal molecules and consequently improves display quality and reliability.

### Solution to Problem

The present inventors have studied various liquid crystal compositions and polymerizable compounds in the liquid crystal compositions to solve these problems. The present inventors have completed the present invention by finding that the problems can be solved by forming no vertical alignment film on one or both of substrates constituting a liquid crystal cell and combining particular compounds as a liquid crystal compound and a polymerizable compound in a method that includes introducing a liquid crystal composition containing a polymerizable compound into a liquid crystal cell and polymerizing the polymerizable compound in the liquid crystal composition by active energy beam irradiation while a voltage is applied between electrodes.

The present invention provides a liquid crystal display device that includes a liquid crystal layer between a first substrate and a second substrate, the first substrate having a common electrode, the second substrate having a plurality of pixels and having a pixel electrode in each pixel, the liquid crystal layer containing a liquid crystal composition, wherein the liquid crystal display device has no alignment film on one or both of the first substrate and the second substrate but has an alignment control layer formed of a polymer of two or more polymerizable compounds, and the liquid crystal composition contains a compound represented by the general formula (III)

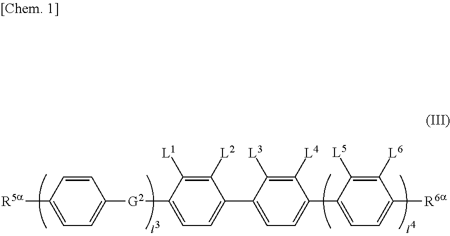

(wherein R^{5α} and R^{6α} independently represent an alkyl group having 1 to 8 carbon atoms, an alkenyl group having 2 to 8 carbon atoms, an alkoxy group having 1 to 8 carbon atoms, or an alkenyloxy group having 2 to 8 carbon atoms, 1³ and 1⁴ independently represent 0 or 1, G² represents a single bond, —CH₂O—, —OCH₂—, —CF₂O—, or —OCF₂—, and L¹ to L⁶ independently represent a hydrogen atom or a fluorine atom)

and a compound represented by the general formula (II).

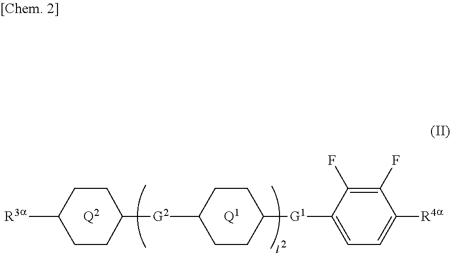

(wherein R^{3α} represents an alkyl group having 1 to 8 carbon atoms, an alkenyl group having 2 to 8 carbon atoms, an alkoxy group having 1 to 8 carbon atoms, or an alkenyloxy group having 2 to 8 carbon atoms, R^{4α} represents an alkyl group having 1 to 8 carbon atoms, an alkenyl group having 4 to 8 carbon atoms, an alkoxy group having 1 to 8 carbon atoms, or an alkenyloxy group having 3 to 8 carbon atoms, Q¹, if present, represents a 1,4-phenylene group or a trans-1,4-cyclohexylene group, Q² represents a trans-1,4-cyclohexylene group or a trans-1,4-cyclohexenylene group, G¹ represents —CH₂CH₂—, —CH₂O—, —OCH₂—, —CF₂O—, or —OCF₂—, G², if present, represents a single bond, —CH₂CH₂—, —CH₂O—, —OCH₂—, —CF₂O—, or —OCF₂—, 1² represents 0, 1, or 2, and if 1² is 2, then two Q¹s may be the same or different, and two G²s may be the same or different)

The present invention also provide a method for manufacturing a liquid crystal display device including a liquid crystal layer between a first substrate and a second substrate, the first substrate having a common electrode and a color filter layer, the second substrate having a plurality of pixels and having a pixel electrode in each pixel, the liquid crystal layer containing a liquid crystal composition, each of the pixels having two or more regions with different pretilt directions, wherein the liquid crystal display device has no alignment film on one or both of the first substrate and the second substrate but contains a polymerizable-compound-containing liquid crystal composition between the first substrate and the second substrate, the polymerizable-compound-containing liquid crystal composition containing a compound represented by the general formula (III)

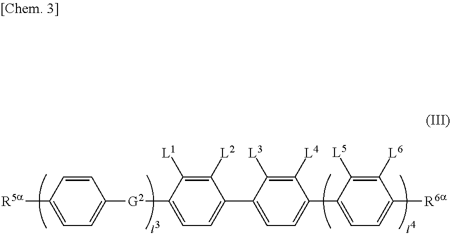

(wherein R^{5α} and R^{6α} independently represent an alkyl group having 1 to 8 carbon atoms, an alkenyl group having 2 to 8 carbon atoms, an alkoxy group having 1 to 8 carbon atoms, or an alkenyloxy group having 2 to 8 carbon atoms, 1³ and 1⁴ independently represent 0 or 1, G² represents a single bond, —CH₂O—, —OCH₂⁻, —CF₂O—, or —OCF₂—, and L¹ to L⁶ independently represent a hydrogen atom or a fluorine atom)

and a compound represented by the general formula (II)

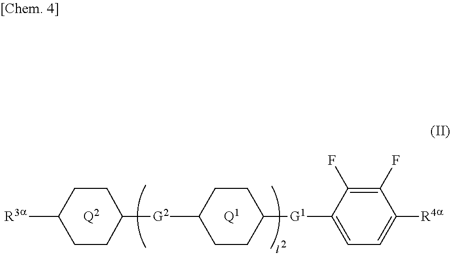

(wherein R^{3α} represents an alkyl group having 1 to 8 carbon atoms, an alkenyl group having 2 to 8 carbon atoms, an alkoxy group having 1 to 8 carbon atoms, or an alkenyloxy group having 2 to 8 carbon atoms, R^{4α} represents an alkyl group having 1 to 8 carbon atoms, an alkenyl group having 4 to 8 carbon atoms, an alkoxy group having 1 to 8 carbon atoms, or an alkenyloxy group having 3 to 8 carbon atoms, Q¹, if present, represents a 1,4-phenylene group or a trans-1,4-cyclohexylene group, Q² represents a trans-1,4-cyclohexylene group or a trans-1,4-cyclohexenylene group, G¹ represents —CH₂CH₂—, —CH₂O—, —OCH₂—, —CF₂O—, or —OCF₂—, G², if present, represents a single bond, —CH₂CH₂—, —CH₂O—, —OCH₂—, —CF₂O—, or —OCF₂—, 1² represents 0, 1, or 2, and if 1² is 2, then two Q¹s may be the same or different, and two G²s may be the same or different)

and containing two or more polymerizable compounds, and

the method comprising polymerizing the two or more polymerizable compounds by active energy beam irradiation while a voltage for providing a pretilt angle for liquid crystal molecules in the polymerizable-compound-containing liquid crystal composition is applied between the pixel electrode and the common electrode, and forming an alignment control layer between the first substrate and the second substrate and the liquid crystal layer using the polymerizable-compound-containing liquid crystal composition as the liquid crystal composition.

### Advantageous Effects of Invention

The present invention can provide a liquid crystal display device and a method for manufacturing the liquid crystal display device, wherein the manufacturing process is simplified, high productivity is achieved with a shorter time required for the polymerization process, and the amount of residual portion of a polymerizable compound to form an alignment control layer is greatly reduced. This significantly reduces display defects, such as image-sticking and drop marks during manufacture, and temporal changes. The liquid crystal display device has high contrast and a high response speed.

### BRIEF DESCRIPTION OF DRAWINGS

FIG. 1 is a schematic perspective view of a liquid crystal display device according to an embodiment of the present invention.

FIG. 2 is a schematic plan view of an example of a slit electrode (interdigitated electrode) for use in a liquid crystal display device according to the present invention.

FIG. 3 is a schematic view illustrating the definition of the pretilt angle in a liquid crystal display device according to the present invention.

### DESCRIPTION OF EMBODIMENTS

A liquid crystal display device according to an embodiment of the present invention and a method for manufacturing the liquid crystal display device will be described below.

The present embodiments are specifically described for better understanding of the gist of the present invention and are not intended to limit the scope of the present invention, unless otherwise specified.

### <Liquid Crystal Display Device>

A liquid crystal display device according to the present invention includes a liquid crystal layer containing a liquid crystal composition between a pair of substrates. A voltage is applied to the liquid crystal layer to cause Freedericksz transition of liquid crystal molecules in the liquid crystal layer, thereby allowing the liquid crystal layer to function as an optical switch. In this regard, a well-known conventional art can be used.

In a typical vertical alignment liquid crystal display device, which has an electrode on two substrates for Freedericksz transition of liquid crystal molecules, electric charges are usually applied vertically between the substrates. In this case, one of the electrodes functions as a common electrode, and the other electrode functions as a pixel electrode. A typical embodiment of this type will be described below.

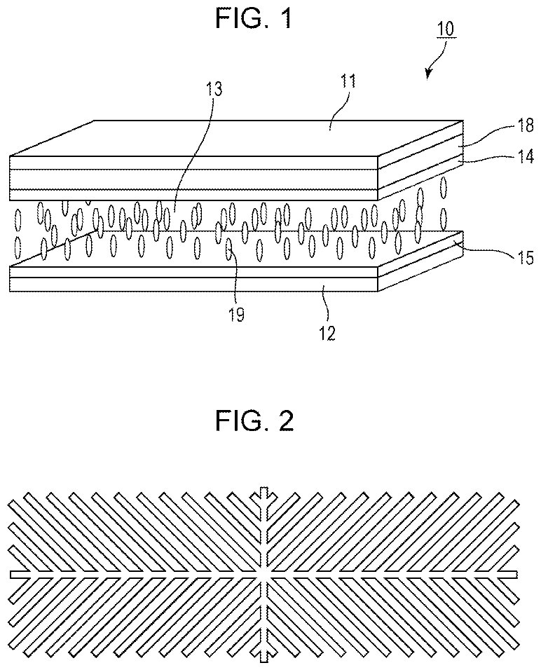

FIG. 1 is a schematic perspective view of a liquid crystal display device according to an embodiment of the present invention.

A liquid crystal display device 10 according to the present embodiment is mainly composed of a first substrate 11, a second substrate 12, a liquid crystal layer 13 containing a liquid crystal composition between the first substrate 11 and the second substrate 12, a common electrode 14 on top of the first substrate 11 facing the liquid crystal layer 13, a pixel electrode 15 on the second substrate 12 facing the liquid crystal layer 13, and a color filter 18 between the first substrate 11 and the common electrode 14.

The first substrate 11 and the second substrate 12 are glass substrates or plastic substrates, for example.

The plastic substrates include acrylic resin, methacrylate resin, poly(ethylene terephthalate), polycarbonate, cyclic olefin resin, and other resin substrates.

The common electrode 14 and the pixel electrode 15 are typically composed of a transparent material, such as indium tin oxide (ITO).

The pixel electrode 15 has a matrix arrangement on the second substrate 12. The pixel electrode 15 is controlled by a drain electrode of an active device exemplified by a TFT switching device (not shown). The TFT switching device has a matrix of gate lines, which are address signal lines, and source lines, which are data lines.

The pixel electrode 15 includes two or more regions with different pretilt directions of liquid crystal molecules in the pixel. The viewing angle characteristics are improved by pixel division, which defines the pretilt direction of liquid crystal molecules and divides a pixel according to the pretilt direction of liquid crystal molecules in the pixel.

For pixel division, for example, a pixel electrode having a slit (a portion without an electrode) of a striped or V-shaped pattern is provided in each pixel.

FIG. 2 is a schematic plan view of a typical slit electrode (interdigitated electrode) that divides a pixel into four regions. This slit electrode has comb-like slits in four directions around the center of the pixel. Upon voltage application, liquid crystal molecules in the pixel almost vertically aligned on the substrate when no voltage is applied turn their directors in four different directions and approach horizontal alignment. Consequently, liquid crystal molecules in the pixel can be divided in a plurality of alignment directions, thus achieving very wide viewing angle characteristics.

In the liquid crystal display device 10, the pixel electrode 15 preferably has a slit (slit electrode).

Pixel division can be performed by a method of providing the slit electrode, a method of providing a structure such as a linear protrusion in a pixel, or a method of providing an electrode other than the pixel electrode and the common electrode (not shown). The method of providing a structure is preferred. The structure is disposed on the first substrate 11 or the second substrate 12 or both.

The use of a slit electrode is preferred in terms of transmittance and the ease of manufacture. Slit electrodes cannot drive liquid crystal molecules when no voltage is applied, and cannot provide liquid crystal molecules with a pretilt angle. However, the present invention can provide a pretilt angle by the formation of an alignment control layer described later and can combine the alignment control layer with a slit electrode for pixel division to achieve a wide viewing angle by pixel division.

The phrase “have a pretilt angle”, as used herein, means that the direction perpendicular to a substrate face (a face of the first substrate 11 or the second substrate 12 adjacent to the liquid crystal layer 13) when no voltage is applied is slightly different from the direction of a director of a liquid crystal molecule.

A liquid crystal display device according to the present invention is a vertical alignment (VA) liquid crystal display device. Thus, the directors of liquid crystal molecules are almost vertically aligned on the substrate face when no voltage is applied. In typical VA liquid crystal display devices, liquid crystal molecules are vertically aligned by a polyimide, polyamide, or polysiloxane vertical alignment film disposed between a first substrate and a liquid crystal layer and between a second substrate and the liquid crystal layer. In a liquid crystal display device according to the present invention, however, at least one substrate has no vertical alignment film. If one substrate has a vertical alignment film, for example, a polyimide, polyamide, benzocyclobutene polymer (BCB), or poly(vinyl alcohol) transparent organic material may be used. In a liquid crystal display device according to the present invention, in the same manner as in the PSA liquid crystal display devices, while a voltage is applied between electrodes to slightly tilt liquid crystal molecules, a polymerizable compound in a liquid crystal composition is polymerized by irradiation with an active energy beam, such as ultraviolet light, to provide an appropriate pretilt angle. It should be noted that in a liquid crystal display device according to the present invention, a polymerizable compound, more specifically a polymerizable compound described later, is polymerized to form an alignment control layer.

The phrase “a liquid crystal molecule is almost vertically aligned”, as used herein, means that the director of the liquid crystal molecule vertically aligned is slightly tilted relative to the vertical direction and has a pretilt angle. When a liquid crystal molecule is completely vertically aligned, the angle between the direction completely parallel to a substrate face and the direction of the director of the liquid crystal molecule is 90 degrees. When a liquid crystal molecule is completely homogeneously aligned (horizontally aligned on a substrate face), the angle is 0 degrees. When a liquid crystal molecule is almost vertically aligned, the angle preferably ranges from 89 to 85 degrees, more preferably 89 to 87 degrees.

At least two polymerizable compounds are used as the polymerizable compounds to form an alignment control layer in a liquid crystal display device according to the present invention.

Of the two or more polymerizable compounds, a first polymerizable compound is a bifunctional polymerizable compound with a ring structure, and a second polymerizable compound is an aliphatic polymerizable compound with a linear or branched structure, a monofunctional polymerizable compound with a ring structure, a trifunctional or higher functional polymerizable compound with a ring structure, or a fused ring polymerizable compound.

The polymerizable compounds, which initiate polymerization by the action of light or heat, are preferably (meth)acrylate compounds.

The term “(meth)acrylate”, as used herein, refers to both acrylate and methacrylate. Likewise, the term “(meth)acryloyl group”, as used herein, refers to both an acryloyl group (H₂C═CH—CO—) and a methacryloyl group (H₂C═C(CH₃)—CO—) and refers to the same structure as the formulae (R-1) and (R-2) described above.

Unless otherwise specified, “—COO—” refers to “—C(═O)—O—”, and “—OCO—” refers to “—O—C(═O)—”.

Unless otherwise specified, the term “alkylene group” in the context of the formula of a compound refers to a divalent group produced by removing a hydrogen atom from each terminal carbon atom in a linear or branched aliphatic hydrocarbon. In this case, substitution of a halogen atom or an alkyl group for a hydrogen atom or substitution of an oxygen atom, —CO—, —COO—, or —OCO— for a methylene group is explicitly specified. The term “alkylene chain length”, for example, in the context of a linear alkylene group refers to n in the general formula “—(CH₂)ₙ— (wherein n represents an integer of 1 or more)”.

The first polymerizable compound, a bifunctional polymerizable compound with a ring structure, may be a compound represented by the general formula (X1a):

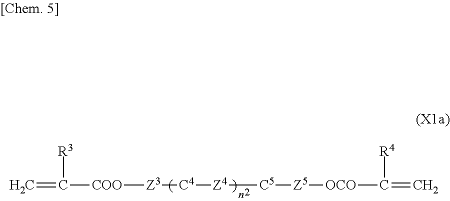

(wherein R³ and R⁴ independently represent a hydrogen atom or a methyl group,

C⁴ and C⁵ independently represent a 1,4-phenylene group, a 1,4-cyclohexylene group, a pyridine-2,5-diyl group, a pyrimidine-2,5-diyl group, a pyridazine-3,6-diyl group, a 1,3-dioxane-2,5-diyl group, a cyclohexene-1,4-diyl group, a decahydronaphthalene-2,6-diyl group, a 1,2,3,4-tetrahydronaphthalene-2,6-diyl group, a phenanthrene-2,7-diyl group, an anthracene-2,6-diyl group, a 2,6-naphthylene group, or an indan-2,5-diyl group (among these groups, one or two or more hydrogen atoms in the 1,4-phenylene group, the 1,2,3,4-tetrahydronaphthalene-2,6-diyl group, the 2,6-naphthylene group, and the indan-2,5-diyl group are independently optionally substituted with a fluorine atom, a chlorine atom, a methyl group, a trifluoromethyl group, or a trifluoromethoxy group),

Z³ and Z⁵ independently represent a single bond or an alkylene group having 1 to 15 carbon atoms (one or two or more methylene groups in the alkylene group are independently optionally substituted with an oxygen atom, —CO—, —COO—, or —OCO—, provided that oxygen atoms are not directly bonded to each other, and one or two or more hydrogen atoms in the alkylene group are independently optionally substituted with a fluorine atom, a methyl group, or an ethyl group),

Z⁴ represents a single bond, —CH₂CH₂—, —CH₂O—, —OCH₂—, —CH₂CH₂O—, —OCH₂CH₂—, —CH₂CH₂CH₂O—, —OCH₂CH₂CH₂—, —CH₂CH₂OCO—, —COOCH₂CH₂—, —CH₂CH₂COO—, —OCOCH₂CH₂—, —CH═CH—, —C≡C—, —CF₂O—, —OCF₂—, —CH═CHCOO—, —OCOCH═CH—, —COO—, or —OCO—, and

n² represents 0, 1, or 2, and if n² is 2, then pluralities of C⁴s and Z⁴s may be the same or different C⁴s and Z⁴s, respectively)

In a compound represented by the general formula (X1a), C⁴ and C⁵ independently represent a 1,4-phenylene group, a 1,4-cyclohexylene group, a pyridine-2,5-diyl group, a pyrimidine-2,5-diyl group, a pyridazine-3,6-diyl group, a 1,3-dioxane-2,5-diyl group, a cyclohexene-1,4-diyl group, a decahydronaphthalene-2,6-diyl group, a 1,2,3,4-tetrahydronaphthalene-2,6-diyl group, a phenanthrene-2,7-diyl group, an anthracene-2,6-diyl group, a 2,6-naphthylene group, or an indan-2,5-diyl group (among these groups, one or two or more hydrogen atoms in the 1,4-phenylene group, the 1,2,3,4-tetrahydronaphthalene-2,6-diyl group, the 2,6-naphthylene group, and the indan-2,5-diyl group are independently optionally substituted with a fluorine atom, a chlorine atom, a methyl group, a trifluoromethyl group, or a trifluoromethoxy group), preferably a 1,4-phenylene group, a 2-fluoro-1,4-phenylene group, a 3-fluoro-1,4-phenylene group, a 2,3-difluro-1,4-phenylene group, a 2-methyl-1,4-phenylene group, a 3-methyl-1,4-phenylene group, a 1,4-cyclohexylene group, or a 2,6-naphthylene group. Z⁴ represents a single bond, —CH₂CH₂—, —CH₂O—, —OCH₂—, —CH₂CH₂O—, —OCH₂CH₂—, —CH₂CH₂CH₂O—, —OCH₂CH₂CH₂—, —CH₂CH₂OCO—, —COOCH₂CH₂—, —CH₂CH₂COO—, —OCOCH₂CH₂—, —CH═CH—, —C≡C—, —CF₂O—, —OCF₂—, —CH═CHCOO—, —OCOCH═CH—, —COO—, or —OCO—, preferably a single bond, —CH₂CH₂—, —COOCH₂CH₂—, —CH₂CH₂COO—, —OCOCH₂CH₂—, —C≡C—, —CH═CHCOO—, —OCOCH═CH—, —COO—, or —OCO—. n² represents 0, 1, or 2, preferably 0 or 1.

More specifically, a compound represented by the general formula (X1a) may be a compound represented by one of the formulae (X1a-101) to (X1a-140).

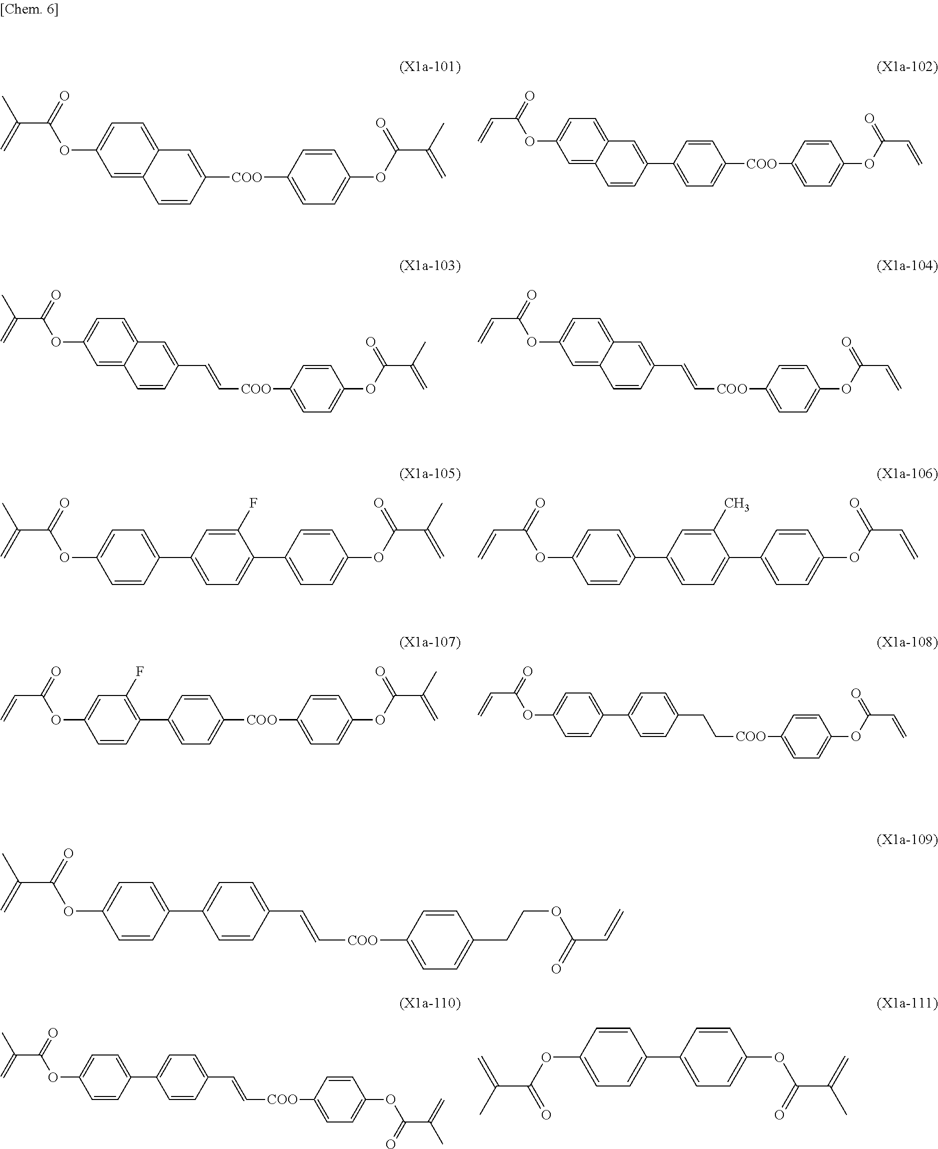

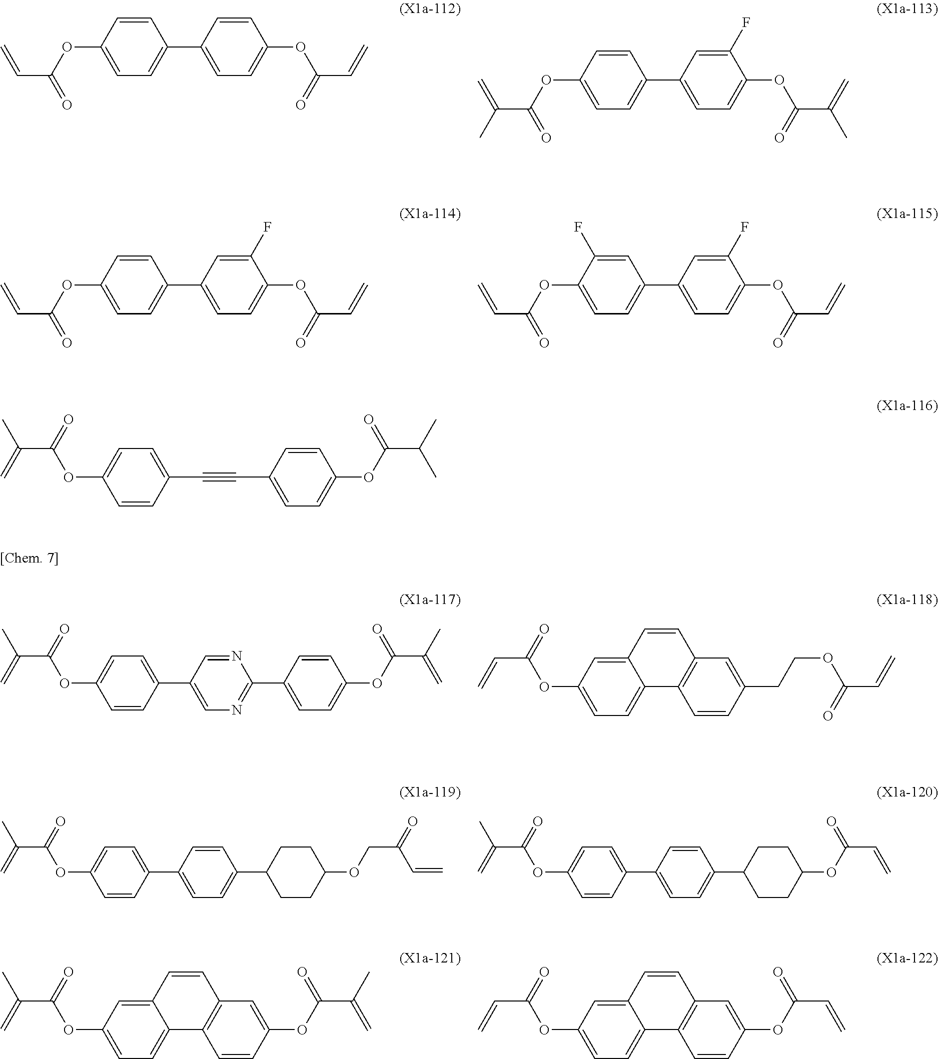

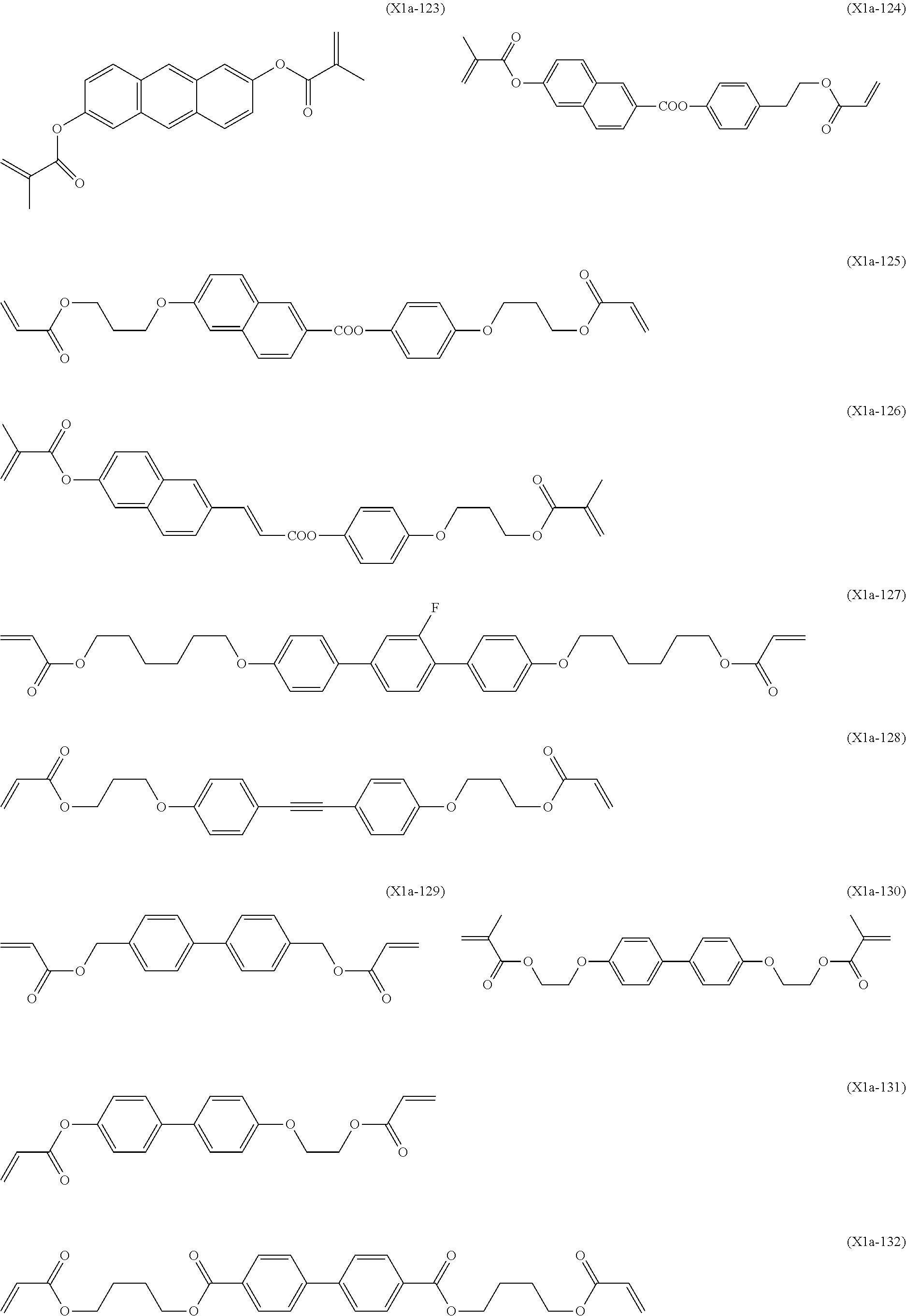

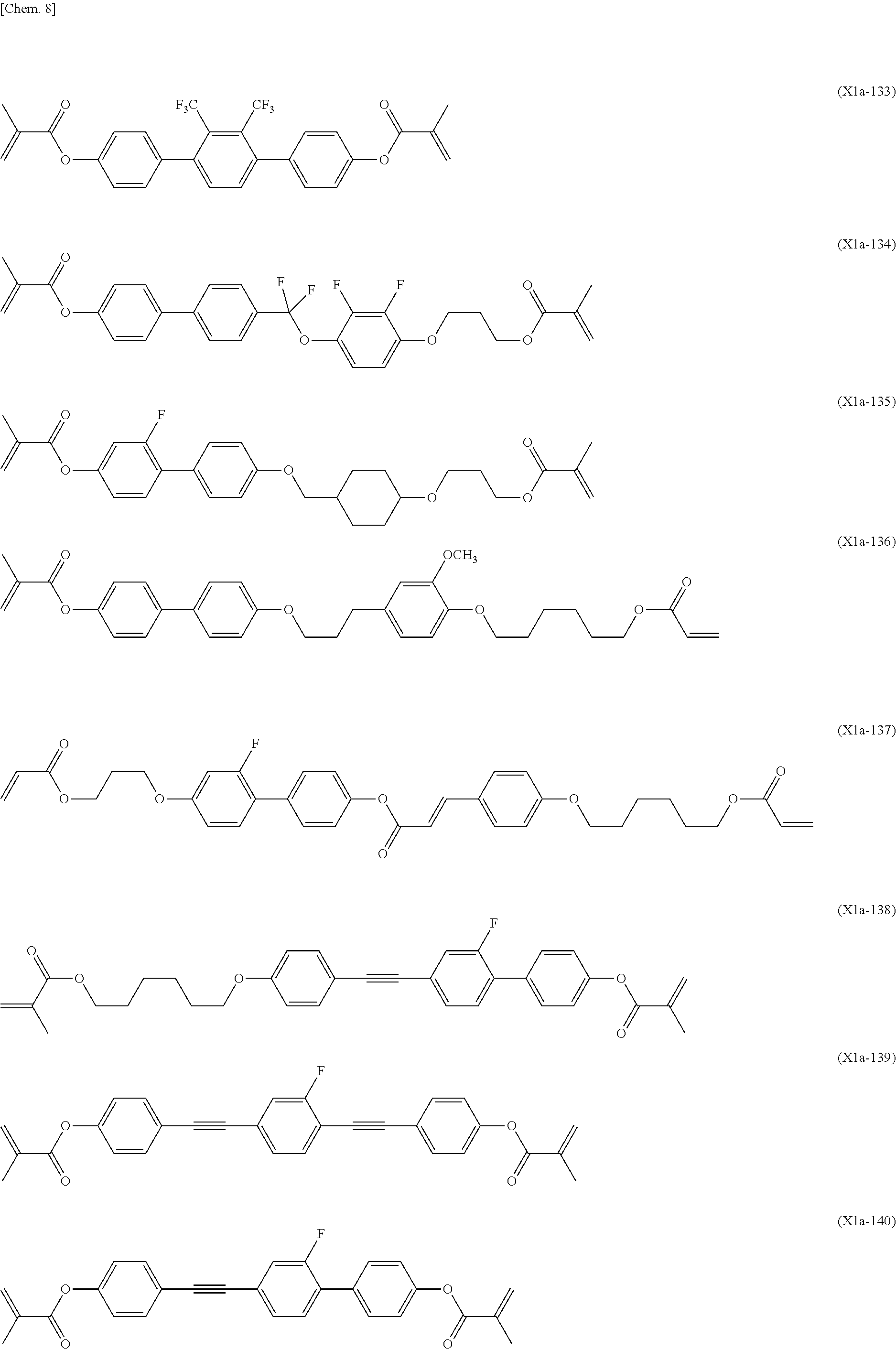

More specifically, a second polymerizable compound, an aliphatic polymerizable compound with a linear or branched structure, may be a compound represented by the general formula (X2a):

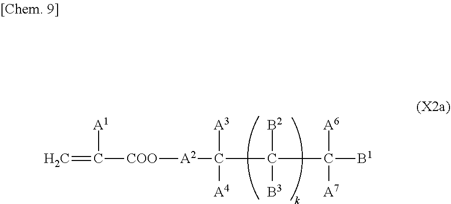

(wherein A¹ represents a hydrogen atom or a methyl group,

A² represents a single bond or an alkylene group having 1 to 15 carbon atoms (one or two or more methylene groups in the alkylene group are independently optionally substituted with an oxygen atom, —CO—, —COO—, or —OCO—, provided that oxygen atoms are not directly bonded to each other, and one or two or more hydrogen atoms in the alkylene group are independently optionally substituted with a fluorine atom, a methyl group, or an ethyl group),

A³ and A⁶ independently represent a hydrogen atom, a halogen atom, or an alkyl group having 1 to 18 carbon atoms (one or two or more methylene groups in the alkyl group are independently optionally substituted with an oxygen atom, —CO—, —COO—, or —OCO—, provided that oxygen atoms are not directly bonded to each other, and one or two or more hydrogen atoms in the alkyl group are independently optionally substituted with a halogen atom or an alkyl group having 1 to 17 carbon atoms),

A⁴ and A⁷ independently represent a hydrogen atom, a halogen atom, or an alkyl group having 1 to 10 carbon atoms (one or two or more methylene groups in the alkyl group are independently optionally substituted with an oxygen atom, —CO—, —COO—, or —OCO—, provided that oxygen atoms are not directly bonded to each other, and one or two or more hydrogen atoms in the alkyl group are independently optionally substituted with a halogen atom or an alkyl group having 1 to 9 carbon atoms),

k represents 1 to 40, and

B¹, B², and B³ independently represent a hydrogen atom, a linear or branched alkyl group having 1 to 10 carbon atoms (one or two or more methylene groups in the alkyl group are independently optionally substituted with an oxygen atom, —CO—, —COO—, or —OCO—, provided that oxygen atoms are not directly bonded to each other, and one or two or more hydrogen atoms in the alkyl group are independently optionally substituted with a halogen atom or a trialkoxysilyl group having 3 to 6 carbon atoms), or a group represented by the following general formula (I-b),

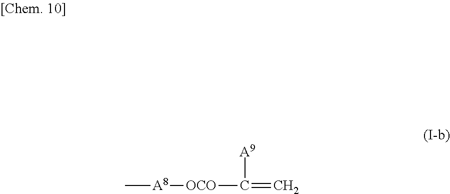

(wherein A⁹ represents a hydrogen atom or a methyl group, and

A⁸ represents a single bond or an alkylene group having 1 to 15 carbon atoms (one or two or more methylene groups in the alkylene group are independently optionally substituted with an oxygen atom, —CO—, —COO—, or —OCO—, provided that oxygen atoms are not directly bonded to each other, and one or two or more hydrogen atoms in the alkylene group are independently optionally substituted with a fluorine atom, a methyl group, or an ethyl group),

provided that the number of groups represented by the general formula (I-b) in B¹, B², and B³, if present, is 0 or 1)

In the general formula (X2a), the alkyl group having 1 to 18 carbon atoms in A³ and A⁶ may be linear, branched, or cyclic, preferably linear or branched, for example, a methyl group, an ethyl group, a n-propyl group, an isopropyl group, a n-butyl group, an isobutyl group, a sec-butyl group, a tert-butyl group, a n-pentyl group, an isopentyl group, a neopentyl group, a tert-pentyl group, a 1-methylbutyl group, a n-hexyl group, a 2-methylpentyl group, a 3-methylpentyl group, a 2,2-dimethylbutyl group, a 2,3-dimethylbutyl group, a n-heptyl group, a 2-methylhexyl group, a 3-methylhexyl group, a 2,2-dimethylpentyl group, a 2,3-dimethylpentyl group, a 2,4-dimethylpentyl group, a 3,3-dimethylpentyl group, a 3-ethylpentyl group, a 2,2,3-trimethylbutyl group, a n-octyl group, an isooctyl group, a nonyl group, a decyl group, an undecyl group, a dodecyl group, a tridecyl group, a tetradecyl group, a pentadecyl group, a hexadecyl group, a heptadecyl group, or an octadecyl group.

In the general formula (X2a), the halogen atom in A³ and A⁶ may be a fluorine atom, a chlorine atom, or a bromine atom, preferably a fluorine atom.

The alkyl group having 1 to 17 carbon atoms that substitutes for a hydrogen atom in the alkyl group in A³ and A⁶ may be the same as the alkyl group in A³ and A⁶ except that the number of carbon atoms is different.

The halogen atom that substitutes for a hydrogen atom in the alkyl group in A³ and A⁶ may be the same as the halogen atom in A³ and A⁶.

In the general formula (X2a), an alkylene group having 1 to 15 carbon atoms in A² may be a divalent group produced by removing one hydrogen atom from an alkyl group having 1 to 15 carbon atoms in A³ and A⁶.

In the general formula (X2a), an alkyl group having 1 to 10 carbon atoms in A⁴ and A⁷ may be the same as the alkyl group in A³ and A⁶ except that the number of carbon atoms is different.

The alkyl group having 1 to 9 carbon atoms that substitutes for a hydrogen atom in the alkyl group in A⁴ and A⁷ may be the same as the alkyl group in A³ and A⁶ except that the number of carbon atoms is different.

The halogen atom that substitutes for a hydrogen atom in the alkyl group in A⁴ and A⁷ may be the same as the halogen atom in A³ and A⁶.

In the general formula (X2a), a linear or branched alkyl group having 1 to 10 carbon atoms in B¹, B², and B³ may be the same as a linear or branched alkyl group having 1 to 10 carbon atoms in A³ and A⁶.

The trialkoxysilyl group having 3 to 6 carbon atoms that substitutes for a hydrogen atom in the alkyl group in B¹, B², and B³ may have three alkoxy groups selected from a methoxy group and an ethoxy group bonded to the same silicon atom. The three alkoxy groups bonded to the same silicon atom may be the same, or two of the three alkoxy groups may be the same. More specifically, the trialkoxysilyl group may be a trimethoxysilyl group, a triethoxysilyl group, an ethoxydimethoxysilyl group, or a diethoxymethoxysilyl group.

The halogen atom that substitutes for a hydrogen atom in the alkyl group in B¹, B², and B³ may be the same as the halogen atom in A³ and A⁶.

In the general formula (X2a), the total number of B¹, B² and B³ is 2k+1. The number of groups represented by the general formula (I-b) is 0 or 1. Any of B¹, B², and B³ may be, preferably B¹ is, a group represented by the general formula (I-b).

Specific examples of a compound represented by the general formula (X2a) in which B¹, B², or B³ is a group represented by the general formula (I-b) include a compound represented by the general formula (X2a-1),

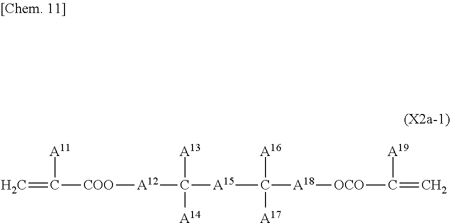

(wherein A¹¹ and A¹⁹ independently represent a hydrogen atom or a methyl group,

A¹² and A¹⁸ independently represent a single bond or an alkylene group having 1 to 15 carbon atoms (one or two or more methylene groups in the alkylene group are independently optionally substituted with an oxygen atom, —CO—, —COO—, or —OCO—, provided that oxygen atoms are not directly bonded to each other, and one or two or more hydrogen atoms in the alkylene group are independently optionally substituted with a fluorine atom, a methyl group, or an ethyl group),

A¹³ and A¹⁶ independently represent a linear alkyl group having 1 to 18 carbon atoms (one or two or more methylene groups in the linear alkyl group are independently optionally substituted with an oxygen atom, —CO—, —COO—, or —COO—, provided that oxygen atoms are not directly bonded to each other),

A¹⁴ and A¹⁷ independently represent a hydrogen atom or an alkyl group having 1 to 10 carbon atoms (one or two or more methylene groups in the alkyl group are independently optionally substituted with an oxygen atom, —CO—, —COO—, or —OCO—, provided that oxygen atoms are not directly bonded to each other, and one or two or more hydrogen atoms in the alkyl group are independently optionally substituted with a halogen atom or an alkyl group having 1 to 9 carbon atoms),

A¹⁵ represents an alkylene group having 9 to 16 carbon atoms (in at least one to five methylene groups in the alkylene group, one hydrogen atom in the methylene groups is independently optionally substituted with a linear or branched alkyl group having 1 to 10 carbon atoms, and one or two or more methylene groups in the alkylene group are independently optionally substituted with an oxygen atom, —CO—, —COO—, or —OCO—, provided that oxygen atoms are not directly bonded to each other)) a compound represented by the general formula (X2a-2),

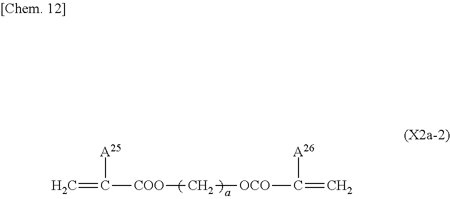

(wherein A²⁵ and A²⁶ independently represent a hydrogen atom or a methyl group, and a represents an integer in the range of 6 to 22) a compound represented by the general formula (X2a-3),

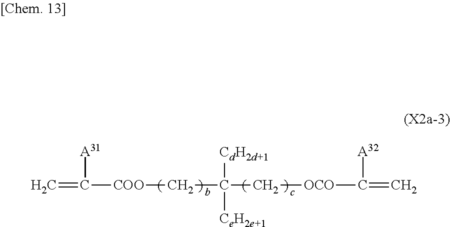

(wherein A³¹ and A³² independently represent a hydrogen atom or a methyl group, b, c, and d independently represent an integer in the range of 1 to 10, and e represents an integer in the range of 0 to 6)

and a compound represented by the general formula (X2a-4).

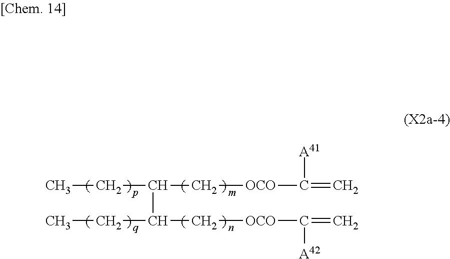

(wherein A⁴¹ and A⁴² independently represent a hydrogen atom or a methyl group, and m, n, p, and q independently represent an integer in the range of 1 to 10)

A compound represented by the general formula (X2a-1) can be produced by a known method described in “Tetrahedron Letters, Vol. 30, pp. 4985”, “Tetrahedron Letters, Vol. 23, No. 6, pp. 681-684”, and “Journal of Polymer Science: Part A: Polymer Chemistry, Vol. 34, pp. 217-225”.

Among the compounds represented by the general formula (X2a-1) produced in this manner, particularly preferred is a compound represented by the general formula (X2a-1-1).

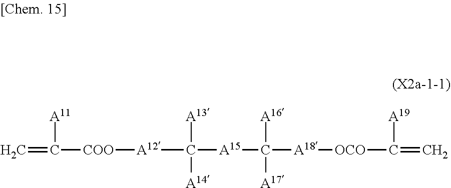

(wherein A¹¹ and A¹⁹ independently represent a hydrogen atom or a methyl group,

A^{12′} and A^{18′} independently represent a methylene group,

A^{13′} and A^{16′} independently represent a linear alkyl group having 2 to 18 carbon atoms (one or two or more methylene groups in the linear alkyl group are independently optionally substituted with an oxygen atom, —CO—, —COO—, or —OCO—, provided that oxygen atoms are not directly bonded to each other),

A^{14′} and A^{17′} independently represent an alkyl group having 1 to 10 carbon atoms, and

A¹⁵ represents an alkylene group having 9 to 16 carbon atoms (in at least one to five methylene groups in the alkylene group, one hydrogen atom in the methylene groups is independently optionally substituted with a linear or branched alkyl group having 1 to 10 carbon atoms, and one or two or more methylene groups in the alkylene group are independently optionally substituted with an oxygen atom, —CO—, —COO—, or —OCO—, provided that oxygen atoms are not directly bonded to each other))

In a compound represented by the general formula (X2a-1-1), the total number of —COO— and —OCO— in A¹⁵ is particularly preferably two or less, and the number of each of —COO— and —OCO— in A¹⁸ and A²¹ is particularly preferably one or less. More specifically, a compound represented by the general formula (X2a-1-1) may be a compound represented by one of the formulae (X2a-101) to (X2a-109).

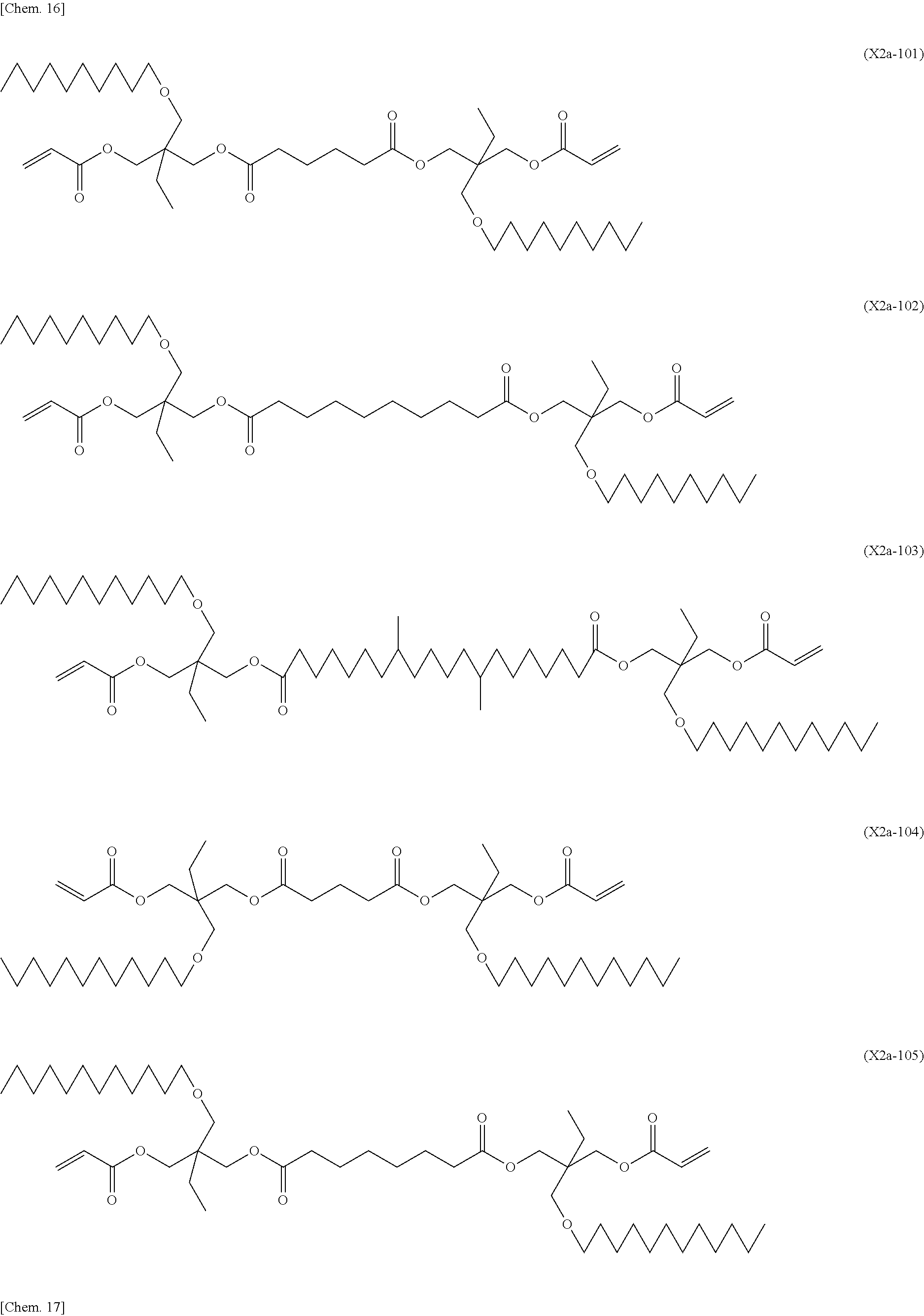

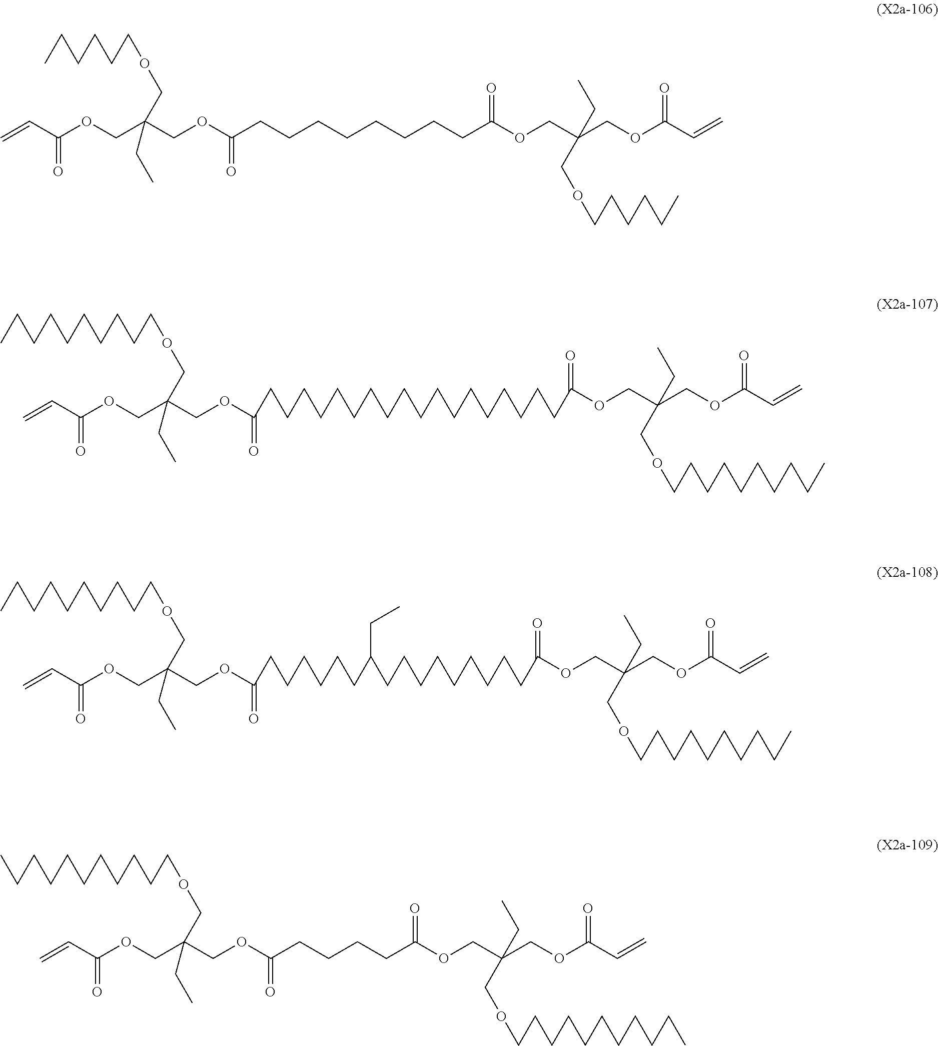

More specifically, a second polymerizable compound, a monofunctional polymerizable compound with a ring structure, may be a compound represented by the general formula (X2b):

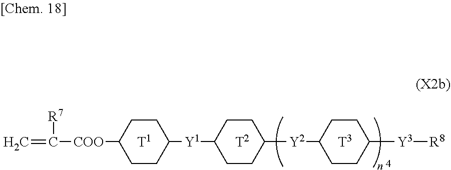

(wherein R⁷ represents a hydrogen atom or a methyl group,

6-membered rings T¹, T², and T³ independently represent one of the following (m represents an integer in the range of 1 to 4),

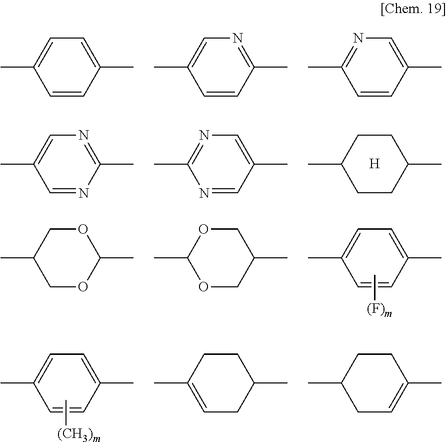

n⁴ represents 0 or 1,

Y¹ and Y² independently represent a single bond, —CH₂CH₂—, —CH₂O—, —OCH₂—, —COO—, —OCO—, —C≡C—, —CH═CH—, —CF═CF—, —(CH₂)₄—, —CH₂CH₂CH₂O—, —OCH₂CH₂CH₂—, —CH₂═CHCH₂CH₂—, or —CH₂CH₂CH═CH—,

Y³ represents a single bond, —O—, —COO—, or —OCO—, and

R⁸ represents a hydrocarbon group having 1 to 18 carbon atoms)

In a compound represented by the general formula (X2b), the 6-membered rings T¹, T², and T³ independently represent one of the following (m represents an integer in the range of 1 to 4): preferably a 1,4-phenylene ring, a 2-fluoro-1,4-phenylene ring, a 3-fluoro-1,4-phenylene ring, a 2,3-difluro-1,4-phenylene ring, a 2-methyl-1,4-phenylene ring, a 3-methyl-1,4-phenylene ring, or a 1,4-cyclohexylene ring.

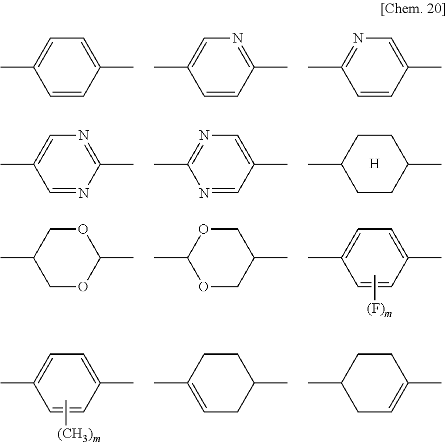

n⁴ represents 0 or 1, preferably 0. Y¹ and Y² independently represent a single bond, —CH₂CH₂—, —CH₂O—, —OCH₂—, —COO—, —OCO—, —C≡C—, —CH═CH—, —CF═CF—, —(CH₂)₄—, —CH₂CH₂CH₂O—, —OCH₂CH₂CH₂—, —CH₂═CHCH₂CH₂—, or —CH₂CH₂CH═CH—, preferably a single bond, —CH₂CH₂—, —COO—, —OCO—, or —C≡C—. Y³ represents a single bond, —COO—, or —OCO—, preferably a single bond. R⁸ represents a hydrocarbon group having 1 to 18 carbon atoms, preferably a hydrocarbon group having 1 to 5 carbon atoms.

More specifically, a second polymerizable compound, a trifunctional or higher functional polymerizable compound with a ring structure, may be a compound represented by the general formula (X2c):

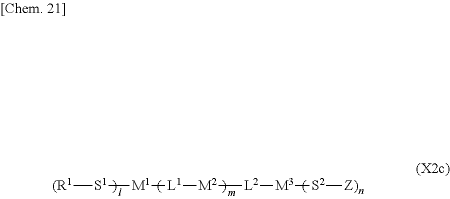

(wherein Z represents a hydrogen atom, an alkyl group having 1 to 8 carbon atoms, a halogenated alkyl group having 1 to 8 carbon atoms, an alkoxy group having 1 to 8 carbon atoms, a halogenated alkoxy group having 1 to 8 carbon atoms, halogen, a cyano group, a nitro group, or R², S¹ and S² independently represent an alkylene group having 1 to 12 carbon atoms or a single bond, and one —CH₂— or two or more nonadjacent —CH₂— groups in the alkylene group are optionally substituted with —O—, —COO—, —OCO—, or —OCOO—,

R¹ and R² independently represent a hydrogen atom or are independently represented by one of the formulae (R-1) to (R-15),

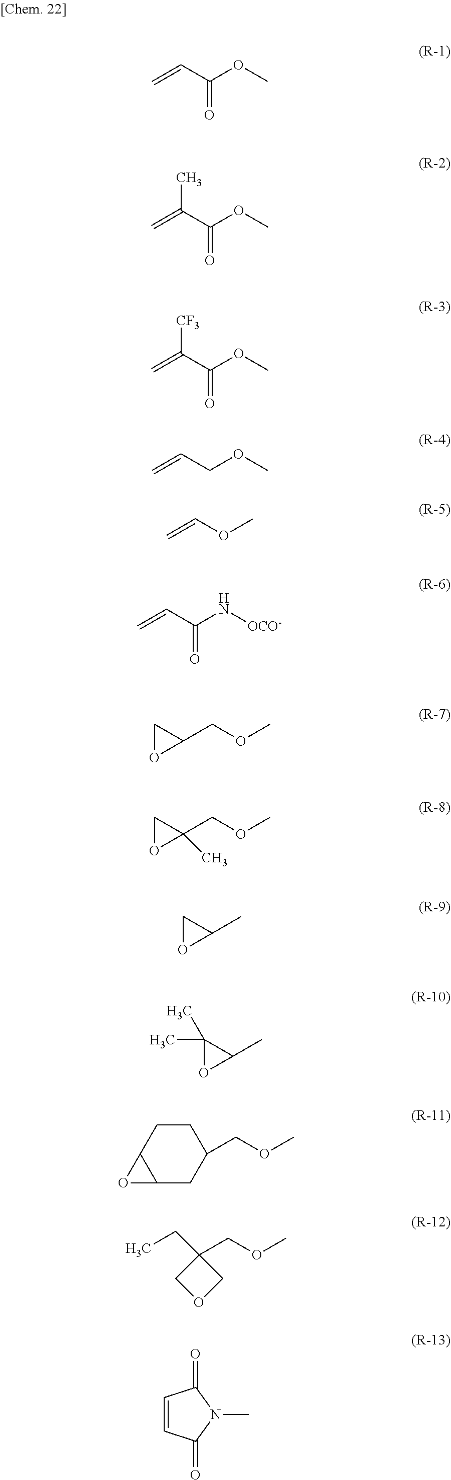

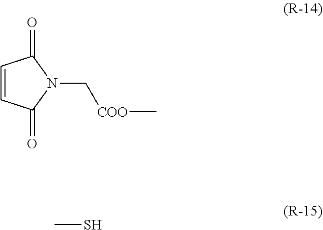

and L² independently represent a single bond, —O—, —S—, —CH₂—, —OCH₂—, —CH₂O—, —CO—, —C₂H₄—, —COO—, —OCO—, —OCOOCH₂—, —CH₂OCOO—, —OCH₂CH₂O—, —CO—NR^{a}—, —NR^{a}—CO—, —SCH₂—, —CH₂S—, —CH═CR^{a}—COO—, —CH═CR^{a}—OCO—, —COO—CR^{a}═CH—, —OCO—CR^{a}═CH—, —COO—CR^{a}═CH—COO—, —COO—CR^{a}═CH—OCO—, —OCO—CR^{a}═CH—COO—, —OCO—CR^{a}═CH—OCO—, —COOC₂H₄—, —OCOC₂H₄—, —C₂H₄OCO—, —(CH₂)ⱼ—C(═O)—O—, —(CH₂)ⱼ—O—(C═O)—, —O—(C═O)—(CH₂)ⱼ—, —(C═O)—O—(CH₂)ⱼ—, —CH₂OCO—, —COOCH₂—, —OCOCH₂—, —CH═CH—, —CF═CF—, —CF═CH—, —CH═CF—, —CF₂—, —CF₂O—, —OCF₂—, —CF₂CH₂—, —CH₂CF₂—, —CF₂CF₂—, or —C≡C— (wherein R^{a} independently represents a hydrogen atom or an alkyl group having 1 to 4 carbon atoms, and j represents an integer in the range of 1 to 4),

M¹ and M³ independently represent an aromatic ring or a aliphatic ring,

M² represents a 1,4-phenylene group, a 1,4-cyclohexylene group, a pyridine-2,5-diyl group, a pyrimidine-2,5-diyl group, a naphthalene-2,6-diyl group, a naphthalene-1,4-diyl group, a tetrahydronaphthalene-2,6-diyl group, or a 1,3-dioxane-2,5-diyl group,

M¹, M², and M³ are independently optionally unsubstituted or substituted with an alkyl group having 1 to 8 carbon atoms, a halogenated alkyl group having 1 to 8 carbon atoms, an alkoxy group having 1 to 8 carbon atoms, halogen, a cyano group, or a nitro group,

1 and n independently represent an integer of 0, 1, 2, or 3, and 1+n is an integer of 3 or more, if 1 is 0, then Z represents a group represented by one of the formulae (R-1) to (R-15), and if n is 0, then R¹ represents a group represented by one of the formulae (R-1) to (R-15), and

m represents an integer in the range of 0 to 4, pluralities of R¹s, R²s, Zs, S¹s, and S²s, if present, may be the same or different R¹s, R²s, Zs, S¹s, and S²s, respectively, and pluralities of L¹s and M²s, if present, may be the same or different L¹s and M²s, respectively, provided that at least one of L¹s represents a single bond)

In a compound represented by the general formula (X2c), Z represents a hydrogen atom, an alkyl group having 1 to 8 carbon atoms, a halogenated alkyl group having 1 to 8 carbon atoms, an alkoxy group having 1 to 8 carbon atoms, a halogenated alkoxy group having 1 to 8 carbon atoms, halogen, a cyano group, a nitro group, or R², preferably a hydrogen atom, an alkyl group having 1 to 3 carbon atoms, a halogenated alkyl group having 1 to 3 carbon atoms, an alkoxy group having 1 to 3 carbon atoms, a halogenated alkoxy group having 1 to 3 carbon atoms, halogen, a cyano group, or R², S¹ and S² independently represent an alkylene group having 1 to 12 carbon atoms or a single bond, one —CH₂— or two or more nonadjacent —CH₂— groups in the alkylene group are independently optionally substituted with —O—, —COO—, —OCO—, or —OCOO—, preferably an alkylene group having 1 to 3 carbon atoms, an alkylene group having 3 to 10 carbon atoms in which one —CH₂— or two or more nonadjacent —CH₂— groups in the alkylene group is substituted with —O—, or a single bond, more preferably a single bond, R¹ and R² independently represent a hydrogen atom or are independently represented by one of the formulae (R-1) to (R-15), preferably the formula (R-1) or (R-2), L¹ and L² independently represent a single bond, —O—, —S—, —CH₂—, —OCH₂—, —CH₂O—, —CO—, —C₂H₄—, —COO—, —OCO—, —OCOOCH₂—, —CH₂OCOO—, —OCH₂CH₂O—, —CO—NR^{a}—, —NR^{a}—CO—, —SCH₂—, —CH₂S—, —CH═CR^{a}—COO—, —CH═CR^{a}—OCO—, —COO—CR^{a}═CH—, —OCO—CR^{a}═CH—, —COO—CR^{a}═CH—COO—, —COO—CR^{a}═CH—OCO—, —OCO—CR^{a}═CH—COO—, —OCO—CR^{a}═CH—OCO—, —COOC₂H₄—, —OCOC₂H₄—, —C₂H₄OCO—, —(CH₂)ⱼ—C(═O)—O—, —(CH₂)ⱼ—O—(C═O)—, —O—(C═O)—(CH₂)ⱼ—, —(C═O)—O—(CH₂)ⱼ—, —CH₂OCO—, —COOCH₂—, —OCOCH₂—, —CH═CH—, —CF═CF—, —CF═CH—, —CH═CF—, —CF₂—, —CF₂O—, —OCF₂—, —CF₂CH₂—, —CH₂CF₂—, —CF₂CF₂—, or —C≡C— (wherein R^{a} independently represent a hydrogen atom or an alkyl group having 1 to 4 carbon atoms, and j represents an integer in the range of 1 to 4), preferably a single bond, —O—, —CH₂—, —OCH₂—, —CH₂O—, —C₂H₄—, —COO—, —OCO—, —CH═CH—COO—, —CH═CH—OCO—, —COO—CH═CH—, —OCO—CH═CH—, —COO—CH═CH—COO—, —COO—CH═CH—OCO—, —OCO—CH═CH—COO—, —OCO—CH═CH—OCO—, —COOC₂H₄—, —OCOC₂H₄—, —C₂H₄OCO— or —C≡C—, M¹ and M³ independently represent an aromatic ring or an aliphatic ring, preferably an aromatic ring, M² represents a 1,4-phenylene group, a 1,4-cyclohexylene group, a pyridine-2,5-diyl group, a pyrimidine-2,5-diyl group, a naphthalene-2,6-diyl group, a naphthalene-1,4-diyl group, a tetrahydronaphthalene-2,6-diyl group, or a 1,3-dioxane-2,5-diyl group, preferably a 1,4-phenylene group, a naphthalene-2,6-diyl group, or a naphthalene-1,4-diyl group, M¹, M², and M³ are preferably independently optionally unsubstituted or are preferably independently optionally substituted with an alkyl group having 1 or 2 carbon atoms or halogen, 1 and n independently represent an integer of 0, 1, 2, or 3, and 1+n is an integer of 1 or more, if 1 is 0, then Z represents a group represented by one of the formulae (R-1) to (R-15), preferably the formula (R-1) or (R-2), if n is 0, then R¹ represents a group represented by one of the formulae (R-1) to (R-15), preferably the formula (R-1) or (R-2), and preferably 1 and n are not 0.

More specifically, a compound represented by the general formula (X2c) may be a compound represented by one of the formulae (X2c-101) to (X2c-150).

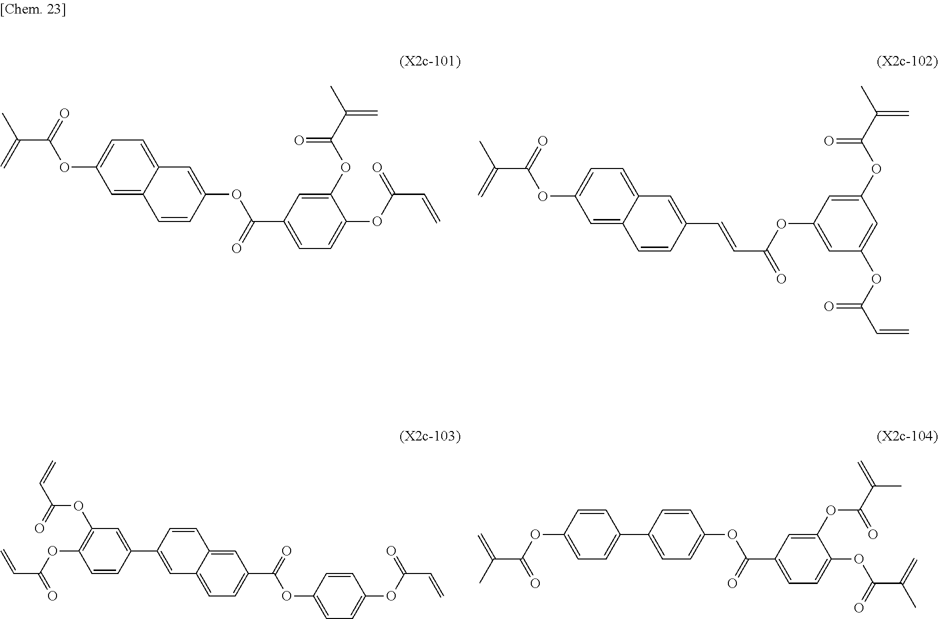

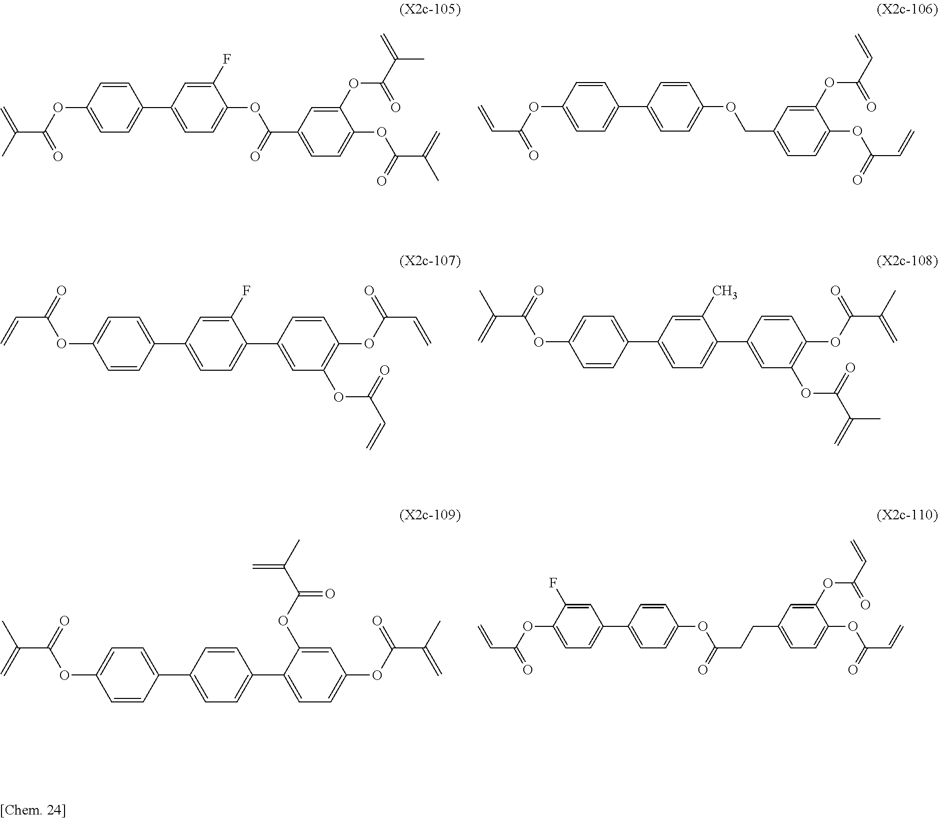

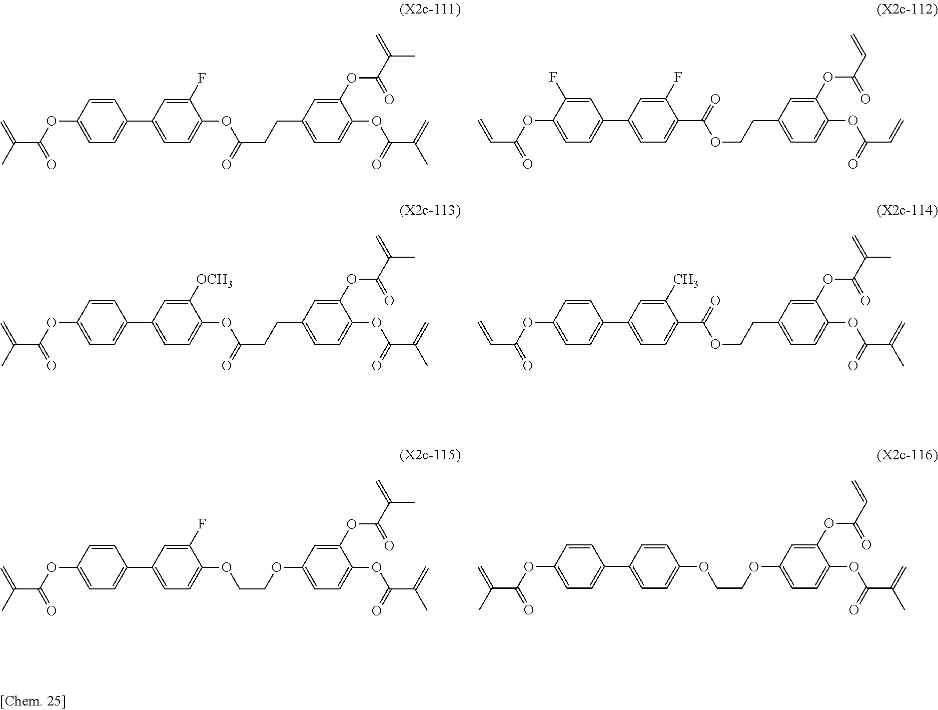

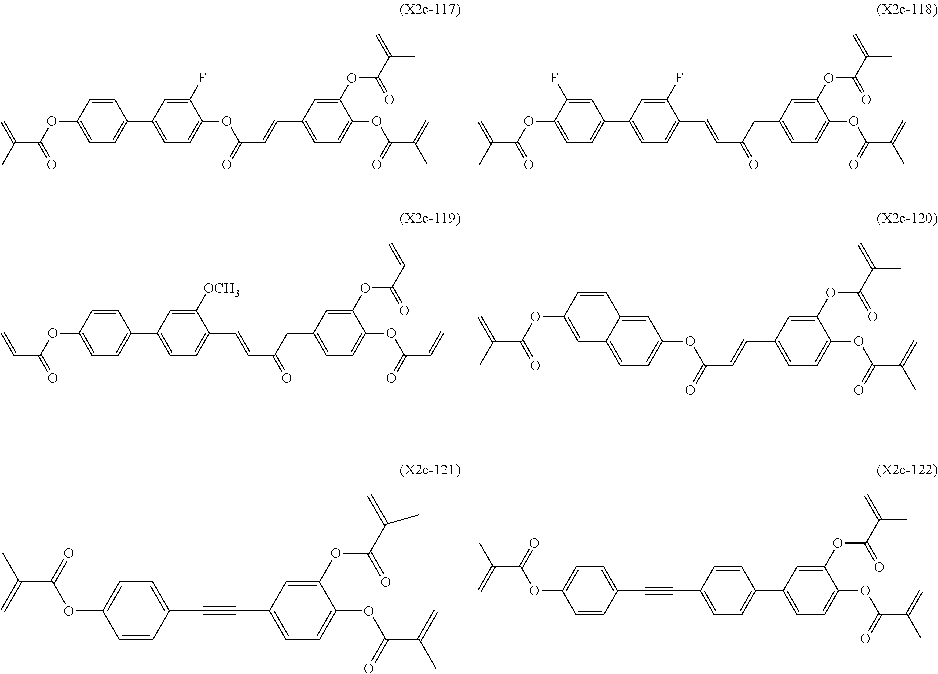

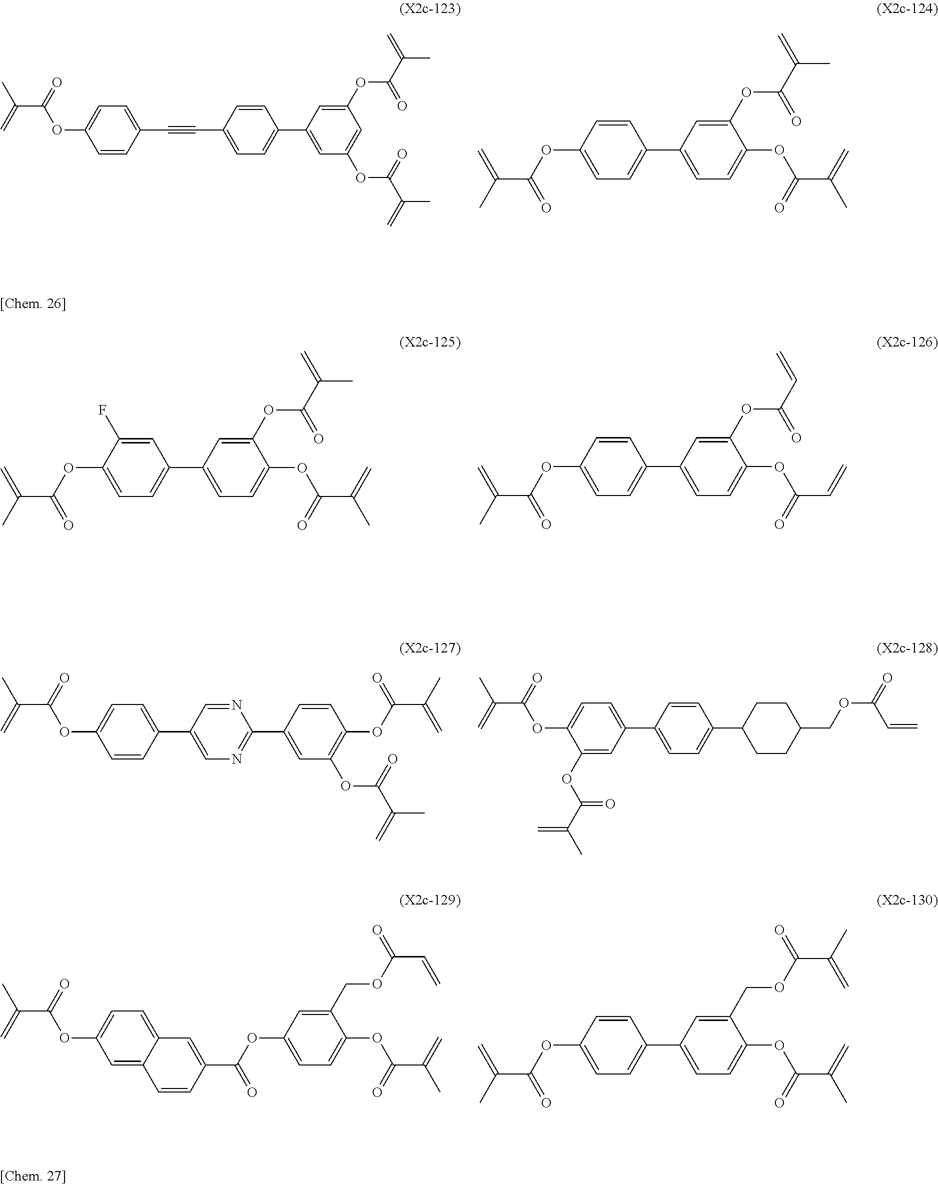

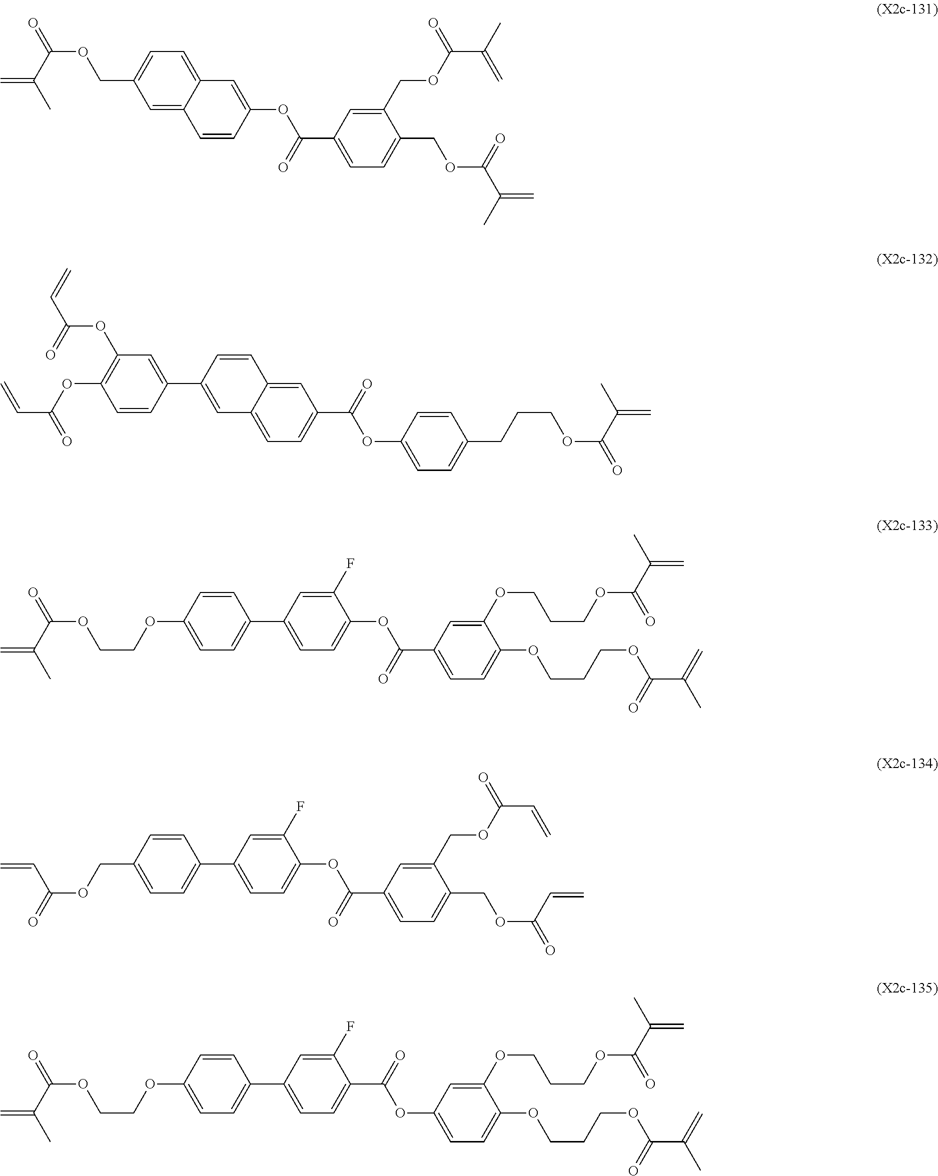

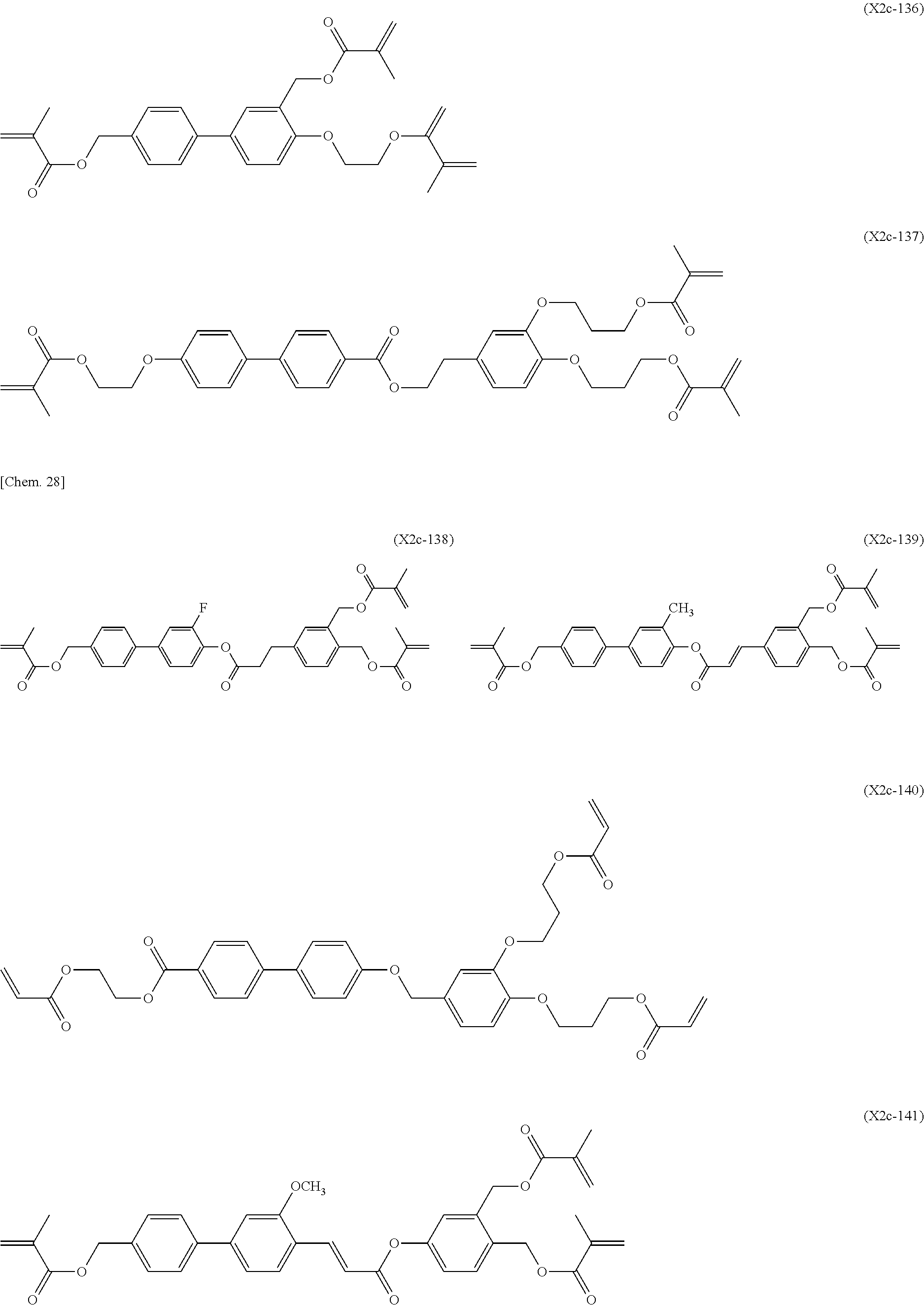

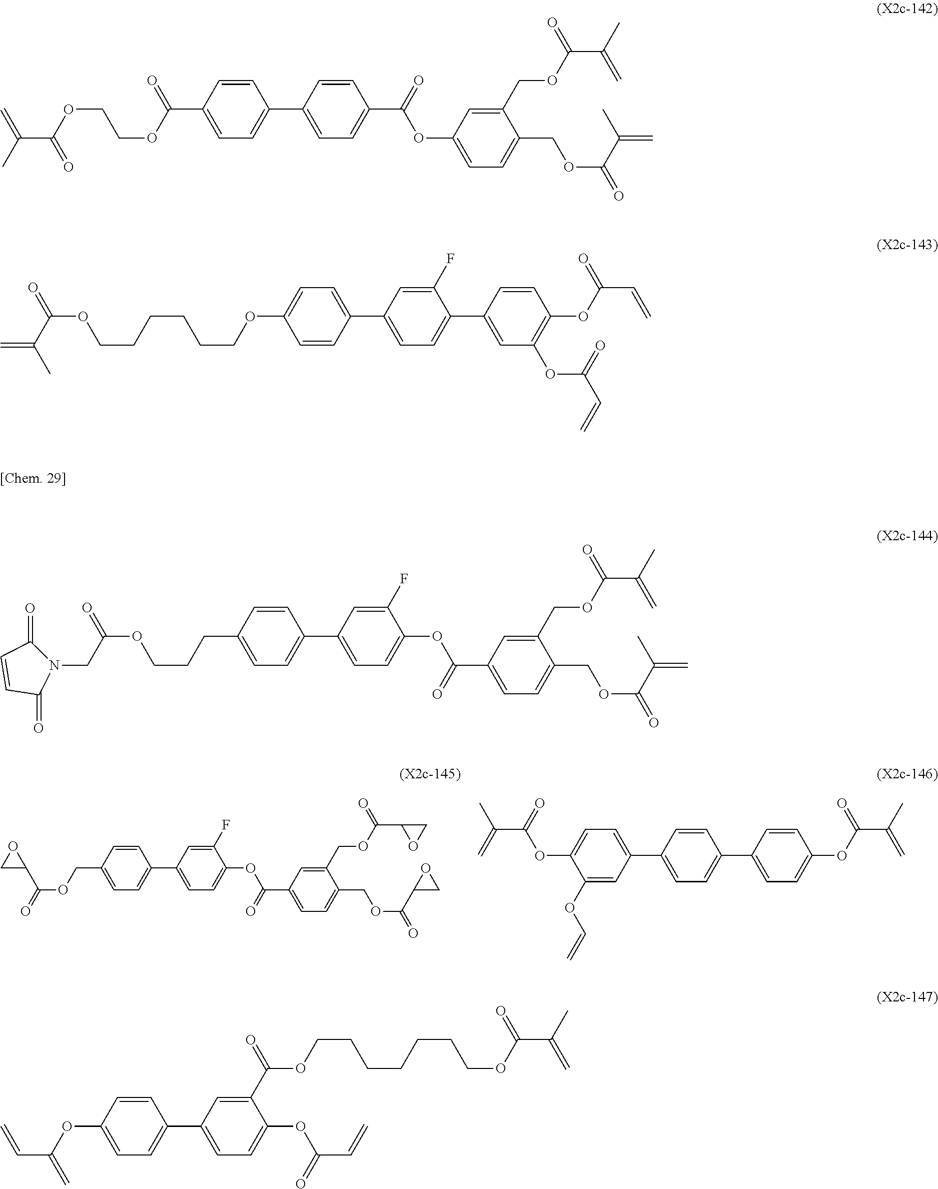

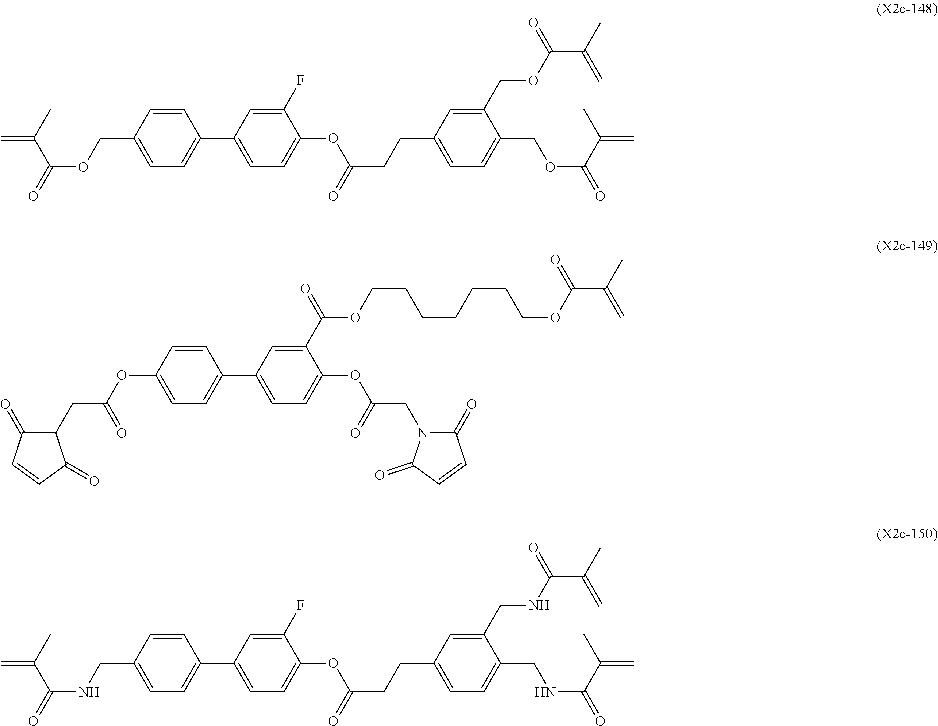

The two or more polymerizable compounds used to form an alignment control layer preferably include at least one polyfunctional polymerizable compound and at least one monofunctional polymerizable compound, more preferably 3 to 6 polymerizable compounds in order to suppress drop marks during the manufacture of a liquid crystal display device without adversely affecting the characteristics of the liquid crystal display device and the image-sticking characteristics of the liquid crystal display device.

More specifically, a second polymerizable compound, a fused ring polymerizable compound, may be a compound represented by the general formula (X2d):

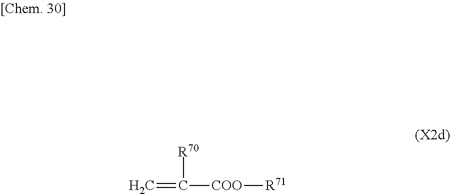

(wherein R⁷⁰ represents a hydrogen atom or a methyl group, and

R⁷¹ represents a hydrocarbon group having a fused ring)

In a compound represented by the general formula (X2d), the hydrocarbon group in R⁷¹ has a fused ring and may be composed of a fused ring alone or a fused ring and another hydrocarbon group.

The fused ring may be an aliphatic ring or an aromatic ring. The aliphatic ring may be a saturated aliphatic ring or an unsaturated aliphatic ring or may include both a saturated aliphatic ring and an unsaturated aliphatic ring. The number of rings constituting the fused ring is 2 or more, preferably 2 to 7.

The other hydrocarbon group other than the fused ring may be linear, branched, or cyclic, or may have both a chain (linear and/or branched) structure and a ring structure. A hydrocarbon group having a chain structure and a ring structure may be a saturated hydrocarbon group or an unsaturated hydrocarbon group. A hydrocarbon group having a ring structure may be an alicyclic hydrocarbon group or an aromatic hydrocarbon group.

R⁷¹ may preferably be a monovalent group produced by removing a hydrogen atom from a steroid, preferably a monovalent group produced by removing a hydroxy group from cholesterol.

The ratio of the at least one first polymerizable compound used to form an alignment control layer to the second polymerizable compound may be appropriately adjusted according to the number of types of polymerizable compounds, and the ratio of the first polymerizable compound to the liquid crystal composition preferably ranges from 0.001% to 5% by mass, more preferably 1.0% to 4.0% by mass. The ratio of the second polymerizable compound preferably ranges from 0.001% to 5% by mass, more preferably 1.0% to 4.0% by mass.

A liquid crystal composition for use in the present invention contains a compound represented by the general formula (III)

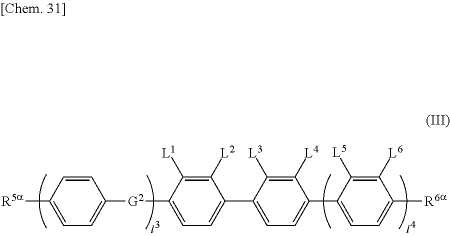

(wherein R^{5α} and R^{6α} independently represent an alkyl group having 1 to 8 carbon atoms, an alkenyl group having 2 to 8 carbon atoms, an alkoxy group having 1 to 8 carbon atoms, or an alkenyloxy group having 2 to 8 carbon atoms, 1³ and 1⁴ independently represent 0 or 1, G² represents a single bond, —CH₂CH₂—, —CH₂O—, —OCH₂—, —CF₂O—, or —OCF₂—, and L¹ to L⁶ independently represent a hydrogen atom or a fluorine atom) and a compound represented by the general formula (II).

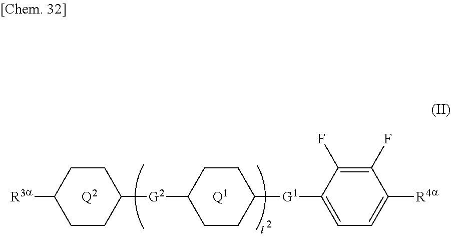

(wherein R^{3α} represents an alkyl group having 1 to 8 carbon atoms, an alkenyl group having 2 to 8 carbon atoms, an alkoxy group having 1 to 8 carbon atoms, or an alkenyloxy group having 2 to 8 carbon atoms, R^{4α} represents an alkyl group having 1 to 8 carbon atoms, an alkenyl group having 4 to 8 carbon atoms, an alkoxy group having 1 to 8 carbon atoms, or an alkenyloxy group having 3 to 8 carbon atoms, Q¹, if present, represents a 1,4-phenylene group or a trans-1,4-cyclohexylene group, Q² represents a trans-1,4-cyclohexylene group or a trans-1,4-cyclohexenylene group, G¹ represents —CH₂CH₂—, —CH₂O—, —OCH₂⁻, —CF₂O—, or —OCF₂—, G², if present, represents a single bond, —CH₂CH₂—, —CH₂O—, —OCH₂—, —CF₂O—, or —OCF₂—, 1² represents 0, 1, or 2, and if 1² is 2, then two Q¹s may be the same or different, and two G²s may be the same or different)

In a liquid crystal composition for use in a liquid crystal display device according to the present invention, the addition of compounds represented by the general formulae (II) and (III) greatly increase the polymerization reactivity of a polymerizable compound to form an alignment control layer, can thereby reduce the time required to form an alignment control layer, and results in little or no residual polymerizable compound. This can also easily achieve high refractive index anisotropy suitable for a panel for narrow cells and can reduce viscosity and rotational viscosity.

In the general formulae (II) and (III), R^{3α}, R^{5α}, and R^{6α} independently represent an alkyl group having 1 to 8 carbon atoms, an alkenyl group having 2 to 8 carbon atoms, an alkoxy group having 1 to 8 carbon atoms, or an alkenyloxy group having 2 to 8 carbon atoms, preferably an alkyl group having 1 to 5 carbon atoms, an alkenyl group having 2 to 5 carbon atoms, or an alkoxy group having 1 to 5 carbon atoms. R^{4α} represents an alkyl group having 1 to 8 carbon atoms, an alkenyl group having 4 to 8 carbon atoms, an alkoxy group having 1 to 8 carbon atoms, or an alkenyloxy group having 3 to 8 carbon atoms, preferably an alkyl group having 1 to 5 carbon atoms, an alkenyl group having 4 or 5 carbon atoms, an alkoxy group having 1 to 5 carbon atoms, or an alkenyloxy group having 3 to 5 carbon atoms. Q² represents a trans-1,4-cyclohexylene group or a trans-1,4-cyclohexenylene group, preferably a trans-1,4-cyclohexylene group. G¹ represents —CH₂CH₂—, —CH₂O—, —OCH₂—, —CF₂O—, or —OCF₂—, preferably —CH₂CH₂— or —CH₂O—. G², if present, represents a single bond, —CH₂CH₂—, —CH₂O—, —OCH₂—, —CF₂O—, or —OCF₂—, preferably —CH₂CH₂— or a single bond, more preferably a single bond. 1² represents 0, 1, or 2, preferably 0 or 1. L¹ to L⁶ independently represent a hydrogen atom or a fluorine atom, and L¹, L², L⁵, and L⁶ preferably represent a hydrogen atom.

Examples of preferred compounds represented by the general formula (III) include a compound represented by the general formula (III-1),

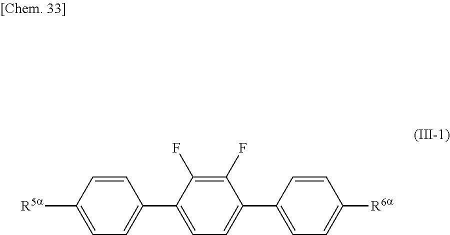

(wherein R^{5α} and R^{6α} are described above) a compound represented by the general formula (III-2),

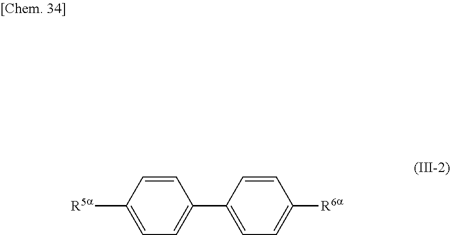

(wherein R^{5α} and R^{6α} are described above) a compound represented by the general formula (III-3), and

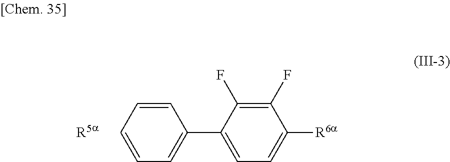

(wherein R^{5α} and R^{6α} are described above) a compound represented by the general formula (III-4).

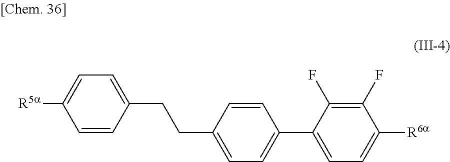

(wherein R^{5α} and R^{6α} are described above)

Examples of preferred compounds represented by the general formula (II) include compounds represented by the general formulae (II-1) to (II-4).

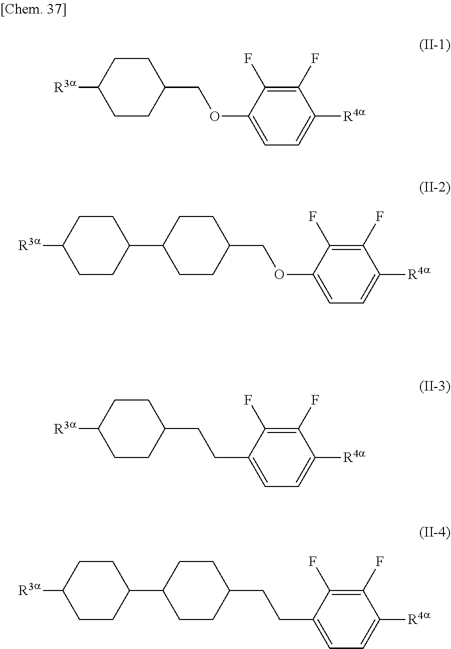

(wherein R^{3α} and R^{4α} are described above)

The total amount of compounds represented by the general formula (III) in the liquid crystal composition preferably ranges from 5% to 60% by mass, more preferably 10% to 60% by mass, still more preferably 15% to 60% by mass.

The total amount of compounds represented by the general formula (II) in the liquid crystal composition preferably ranges from 15% to 60% by mass, more preferably 20% to 55% by mass, still more preferably 25% to 50% by mass.

The liquid crystal composition preferably contains a compound represented by the general formula (I), in addition to compounds represented by the general formulae (III) and (II).

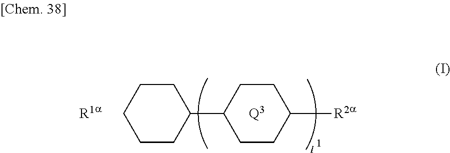

(wherein R^{1α} and R^{2α} independently represent an alkyl group having 1 to 8 carbon atoms, an alkenyl group having 2 to 8 carbon atoms, an alkoxy group having 1 to 8 carbon atoms, or an alkenyloxy group having 2 to 8 carbon atoms, Q³ represents a 1,4-phenylene group or a trans-1,4-cyclohexylene group, 1¹ represents 1 or 2, and if 1¹ is 2, two Q³s may be the same or different)

In the general formula (I), an alkyl group having 1 to 8 carbon atoms in R^{1α} and R^{2α} may be linear, branched, or cyclic, preferably linear or branched, for example, a methyl group, an ethyl group, a n-propyl group, an isopropyl group, a n-butyl group, an isobutyl group, a sec-butyl group, a tert-butyl group, a n-pentyl group, an isopentyl group, a neopentyl group, a tert-pentyl group, a 1-methylbutyl group, a n-hexyl group, a 2-methylpentyl group, a 3-methylpentyl group, a 2,2-dimethylbutyl group, a 2,3-dimethylbutyl group, a n-heptyl group, a 2-methylhexyl group, a 3-methylhexyl group, a 2,2-dimethylpentyl group, a 2,3-dimethylpentyl group, a 2,4-dimethylpentyl group, a 3,3-dimethylpentyl group, a 3-ethylpentyl group, a 2,2,3-trimethylbutyl group, a n-octyl group, or an isooctyl group.

The alkyl group in R^{1α} and R^{2α} preferably has 1 to 6 carbon atoms.

In the general formula (I), an alkenyl group having 2 to 8 carbon atoms in R^{1α} and R^{2α} may be a monovalent group, such as an ethenyl group (vinyl group) or a 2-propenyl group (allyl group), produced by substituting a single bond (C—C) between carbon atoms in the alkyl group having 2 to 8 carbon atoms in R^{1α} and R^{2α} with a double bond (C═C).

The alkenyl group in R^{1α} and R^{2α} preferably has 2 to 6 carbon atoms and more preferably has the following structure.

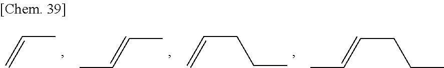

(wherein the rightmost carbon atom in the alkenyl group is bonded to a ring structure)

In the general formula (I), the alkoxy group having 1 to 8 carbon atoms in R^{1α} and R^{2α} may be a monovalent group, such as a methoxy group or an ethoxy group, produced by the alkyl group having 1 to 8 carbon atoms in R^{1α} and R^{2α} bonding to an oxygen atom.

The alkoxy group in R^{1α} and R^{2α} preferably has 1 to 6 carbon atoms, more preferably 1 to 5 carbon atoms, particularly preferably 1 to 3 carbon atoms.

In the general formula (I), the alkenyloxy group having 2 to 8 carbon atoms in R^{1α} and R^{2α} may be a monovalent group, such as an ethenyloxy group or a 2-propenyloxy group, produced by the alkenyl group having 2 to 8 carbon atoms in R^{1α} and R^{2α} bonding to an oxygen atom.

The alkenyloxy group in R^{1α} and R^{2α} preferably has 2 to 6 carbon atoms.

In preferred compounds represented by the general formula (I), a combination of R^{1α} and R^{2α} may be the alkyl groups, the alkyl group and the alkoxy group, or the alkyl group and the alkenyl group.

Examples of preferred compounds represented by the general formula (I) include compounds represented by the following general formulae (I-1) to (I-4).

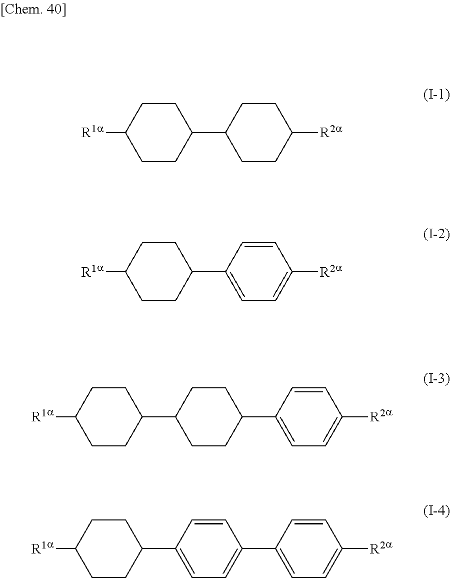

(wherein R^{1α} and R^{2α} are described above) The total amount of compounds represented by the general formula (I) in the liquid crystal composition preferably ranges from 30% to 60% by mass, more preferably 35% to 55% by mass.

A compound represented by the general formula (V) may also be contained.

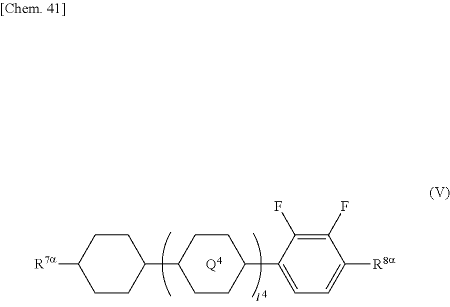

(wherein R^{7α} and R^{8α} independently represent an alkyl group having 1 to 8 carbon atoms, an alkenyl group having 2 to 8 carbon atoms, an alkoxy group having 1 to 8 carbon atoms, or an alkenyloxy group having 2 to 8 carbon atoms, Q⁴ represents a 1,4-phenylene group or a trans-1,4-cyclohexylene group, and 1⁴ represents 0 or 1)

In the general formula (V), the alkyl group having 1 to 8 carbon atoms in R^{7α} and R^{8α} may be linear, branched, or cyclic, preferably linear or branched, for example, a methyl group, an ethyl group, a n-propyl group, an isopropyl group, a n-butyl group, an isobutyl group, a sec-butyl group, a tert-butyl group, a n-pentyl group, an isopentyl group, a neopentyl group, a tert-pentyl group, a 1-methylbutyl group, a n-hexyl group, a 2-methylpentyl group, a 3-methylpentyl group, a 2,2-dimethylbutyl group, a 2,3-dimethylbutyl group, a n-heptyl group, a 2-methylhexyl group, a 3-methylhexyl group, a 2,2-dimethylpentyl group, a 2,3-dimethylpentyl group, a 2,4-dimethylpentyl group, a 3,3-dimethylpentyl group, a 3-ethylpentyl group, a 2,2,3-trimethylbutyl group, a n-octyl group, an isooctyl group, a nonyl group, a decyl group, an undecyl group, a dodecyl group, a tridecyl group, a tetradecyl group, a pentadecyl group, a hexadecyl group, a heptadecyl group, or an octadecyl group.

The alkyl group in R^{7α} and R^{8α} preferably has 1 to 10 carbon atoms, more preferably 1 to 6 carbon atoms.

In the general formula (V), the alkenyl group having 2 to 8 carbon atoms in R^{7α} and R^{8α} may be a monovalent group produced by substituting a single bond (C—C) between carbon atoms in the alkyl group having 2 to 8 carbon atoms in R^{7α} and R^{8α} with a double bond (C═C).

The alkenyl group in R^{7α} and R^{8α} preferably has 2 to 6 carbon atoms.

In the general formula (V), the alkoxy group having 1 to 8 carbon atoms in R^{7α} and R^{8α} may be a monovalent group, such as a methoxy group or an ethoxy group, produced by the alkyl group having 1 to 8 carbon atoms in R^{7α} and R^{8α} bonding to an oxygen atom.

The alkoxy group in R^{7α} and R^{8α} preferably has 1 to 7 carbon atoms, more preferably 1 to 5 carbon atoms.

In the general formula (V), the alkenyloxy group having 2 to 8 carbon atoms in R^{7α} and R^{8α} may be a monovalent group, such as an ethenyloxy group or a 2-propenyloxy group, produced by the alkenyl group having 2 to 8 carbon atoms in R^{7α} and R^{8α} bonding to an oxygen atom.

Examples of preferred compounds represented by the general formula (V) include compounds represented by the general formulae (V-1) to (V-3).

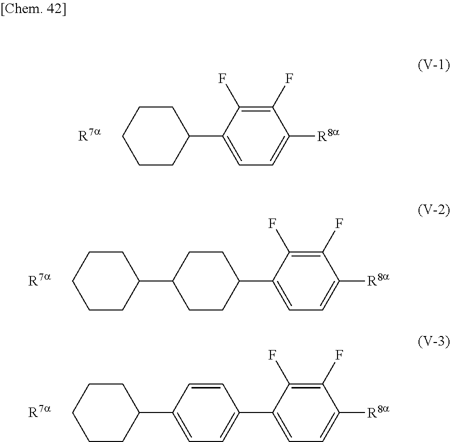

The amount of compounds represented by the general formula (V) in the liquid crystal composition preferably ranges from 10% to 50% by mass, more preferably 15% to 40% by mass.

The total amount of compounds represented by the general formulae (I), (II), (III), and (V) in the liquid crystal composition preferably ranges from 90% to 98% by mass, more preferably 95% to 98% by mass.

A liquid crystal composition for use in the present invention has a dielectric constant anisotropy (Δε) in the range of −2.0 to −8.0, preferably −2.0 to −6.0, more preferably −2.0 to −5.0, particularly preferably −2.5 to −4.0, at 25° C.

A liquid crystal composition for use in the present invention has a refractive index anisotropy (Δn) in the range of 0.08 to 0.14, preferably 0.09 to 0.13, particularly preferably 0.09 to 0.12, at 20° C. More specifically, the refractive index anisotropy (Δn) preferably ranges from 0.10 to 0.13 for a small cell gap and 0.08 to 0.10 for a large cell gap.

A liquid crystal composition for use in the present invention has a viscosity (i) in the range of 10 to 30 mPa·s, preferably 10 to 25 mPa·s, particularly preferably 10 to 22 mPa·s, at 20° C.

A liquid crystal composition for use in the present invention has a rotational viscosity (γ₁) in the range of 60 to 130 mPa·s, preferably 60 to 110 mPa·s, particularly preferably 60 to 100 mPa·s, at 20° C.

A liquid crystal composition for use in the present invention has a ratio (γ₁/K₃₃) of rotational viscosity (γ₁) to elastic constant (K₃₃) in the range of 3.5 to 9.0 mPa·s·pN⁻¹, preferably 3.5 to 8.0 mPa·s·pN⁻¹, particularly preferably 3.5 to 7.0 mPa·s·pN⁻¹, at 20° C.

A liquid crystal composition for use in the present invention has a nematic phase-isotropic liquid phase transition temperature (Tₙᵢ) in the range of 60° C. to 120° C., preferably 70° C. to 100° C., particularly preferably 70° C. to 85° C.

Although a polymerizable compound that forms an alignment control layer according to the present invention can be polymerized in the absence of a polymerization initiator, a polymerization initiator may be contained to promote polymerization. Examples of the polymerization initiator include benzoin ethers, benzophenones, acetophenones, benzil ketals, and acylphosphine oxides. A stabilizer may also be added to improve storage stability. Examples of the stabilizer to be used include hydroquinones, hydroquinone monoalkyl ethers, tert-butylcatechols, pyrogallols, thiophenols, nitro compounds, β-naphthylamines, β-naphthols, and nitroso compounds.

A liquid crystal composition according to the present invention may further contain a compound represented by the general formula (Q):

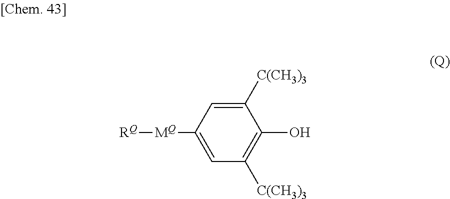

wherein R^{Q} represents a linear or branched alkyl group having 1 to 22 carbon atoms, and one CH₂ group or two or more nonadjacent CH₂ groups in the alkyl group are optionally substituted with —O—, —CH═CH—, —CO—, —OCO—, —COO—, —C≡C—, —CF₂O—, or —OCF₂—.

M^{Q} represents a trans-1,4-cyclohexylene group, a 1,4-phenylene group, or a single bond.

More specifically, a compound represented by the general formula (Q) is preferably a compound represented by one of the general formulae (Q-a) to (Q-e).

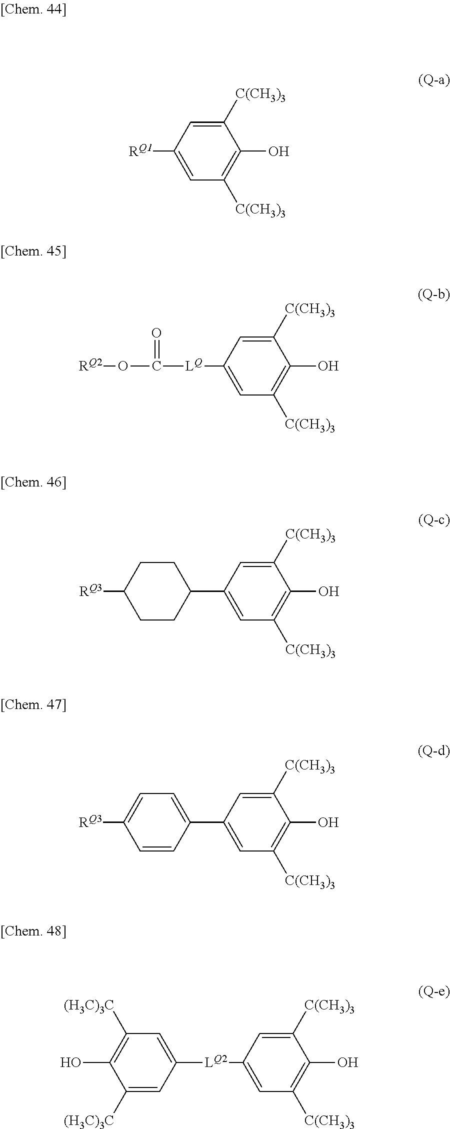

In the formulae, R^{Q1} is preferably a linear or branched alkyl group having 1 to 10 carbon atoms.

R^{Q2} is preferably a linear or branched alkyl group having 1 to 20 carbon atoms.

R^{Q3} is preferably a linear or branched alkyl group or a linear or branched alkoxy group each having 1 to 8 carbon atoms.

L^{Q} is preferably a linear or branched alkylene group having 1 to 8 carbon atoms.

L^{Q2} is preferably a linear or branched alkylene group having 2 to 12 carbon atoms.

Among the compounds represented by the general formulae (Q-a) to (Q-e), more preferred are compounds represented by the general formulae (Q-c), (Q-d), and (Q-e).

The number of types of compounds represented by the general formula (Q), if present, in a liquid crystal composition according to the present invention is 1 or 2 or more, preferably 1 to 5, more preferably 1 to 3, particularly preferably 1. The amount of compound(s) represented by the general formula (Q) preferably ranges from 0.001% to 1% by mass, more preferably 0.001% to 0.1% by mass, particularly preferably 0.001% to 0.05% by mass.

The liquid crystal display device 10 may further have a passivation film (not shown) between the first substrate 11 and the liquid crystal layer 13 and/or between the second substrate 12 and the liquid crystal layer 13. The passivation film protects an adjacent surface of the first substrate 11 or the second substrate 12.

The liquid crystal display device 10 may further have a planarizing film (not shown) between the first substrate 11 and the liquid crystal layer 13 and/or between the second substrate 12 and the liquid crystal layer 13. When this film has a flat surface, such a passivation film may be considered to be a planarizing film.

The passivation film and the planarizing film may be a known film.

In a liquid crystal display device according to the present invention, unlike known liquid crystal display devices, the use of a liquid crystal composition containing a combination of particular compounds represented by the general formulae (III) and (II) as liquid crystal molecules in combination with an alignment control layer formed of two or more polymerizable compounds allows the liquid crystal molecules to be almost vertically aligned on the substrate face when no voltage is applied, without an alignment film between the first substrate and the liquid crystal layer and between the second substrate and the liquid crystal layer. Image-sticking and drop marks during manufacture are suppressed without adversely affecting characteristics such as dielectric constant anisotropy, viscosity, nematic phase upper limit temperature, and rotational viscosity (γ₁).

### <Method for Manufacturing Liquid Crystal Display Device>

For example, the liquid crystal display device 10 illustrated in FIG. 1 can be manufactured by the following method.

First, the first substrate 11 is placed on the second substrate 12. A polymerizable-compound-containing liquid crystal composition to form the liquid crystal layer 13 and an alignment control layer in a process described later is placed between these substrates. The polymerizable-compound-containing liquid crystal composition contains as essential components a compound represented by the general formula (III), a compound represented by the general formula (II), and two or more polymerizable compounds described above.

More specifically, a spacer protrusion, for example, plastic beads, to provide a cell gap is spread on one of the facing surfaces of the first substrate 11 and the second substrate 12. A seal portion is printed (formed) by screen printing, for example, with an epoxy adhesive. The surface of the first substrate 11 facing the second substrate 12 is a surface on which the common electrode 14 and the color filter 18 are disposed. The surface of the second substrate 12 facing the first substrate 11 is a surface on which the pixel electrode 15 is disposed.

The first substrate 11 and the second substrate 12 are then bonded together with the spacer protrusion and the seal portion interposed therebetween. The liquid-crystal-containing polymerizable composition is then injected into the space thus formed. The seal portion is cured, for example, by heating to hold the polymerizable-compound-containing liquid crystal composition between the first substrate 11 and the second substrate 12.

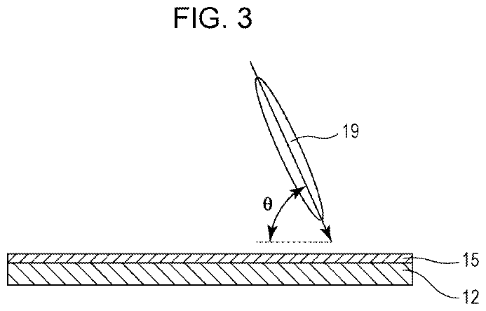

A voltage is then applied between the common electrode 14 and the pixel electrode 15 by a voltage application means. For example, the voltage ranges from 5 to 30 V. This produces an electric field at a predetermined angle relative to the surface of the first substrate 11 adjacent to the polymerizable-compound-containing liquid crystal composition (the surface facing the liquid-crystal-containing polymerizable composition) and the surface of the second substrate 12 adjacent to the polymerizable-compound-containing liquid crystal composition (the surface facing the liquid-crystal-containing polymerizable composition). Liquid crystal molecules (a compound represented by the general formula (III), a compound represented by the general formula (II)) 19 in the polymerizable-compound-containing liquid crystal composition are aligned at a predetermined angle relative to the direction normal to the first substrate 11 and the second substrate 12. Thus, as illustrated in FIG. 3, the liquid crystal molecules 19 have a pretilt angle θ. The pretilt angle θ can be controlled by adjusting the voltage.

While the voltage is applied, the polymerizable-compound-containing liquid crystal composition is then irradiated with an active energy beam, such as ultraviolet light, for example, from the outside of the first substrate 11 to polymerize the two or more polymerizable compounds. The active energy beam may also be emitted from the outside of the second substrate 12 or from both the outside of the first substrate 11 and the outside of the second substrate 12.

Active energy beam irradiation allows the two or more polymerizable compounds in the polymerizable-compound-containing liquid crystal composition to react. The polymerizable-compound-containing liquid crystal composition becomes a liquid crystal composition having a desired composition and constitutes the liquid crystal layer 13. Simultaneously, an alignment control layer is formed between the first substrate 11 and the liquid crystal layer 13 and between the second substrate 12 and the liquid crystal layer 13.

In the stopped state, the alignment control layer thus formed provides a pretilt angle θ for the liquid crystal molecules 19 in the liquid crystal layer 13 near the first substrate 11 and near the second substrate 12.

The active energy beam irradiation intensity may or may not be constant. When irradiation intensity is changed, any irradiation time can be chosen for each irradiation intensity. In an irradiation process composed of two or more steps, irradiation intensity in the second and later steps is preferably lower than irradiation intensity in the first step. The total irradiation time in the second and later steps is preferably longer than the irradiation time in the first step, and the total irradiation energy in the second and later steps is preferably higher than the irradiation energy in the first step. When irradiation intensity is discontinuously changed, the average irradiation intensity in the first half of the total irradiation process time is preferably higher than the average irradiation intensity in the second half. More preferably, irradiation intensity is highest immediately after the start of irradiation. Still more preferably, irradiation intensity decreases continuously to a certain level with the irradiation time. The active energy beam irradiation intensity in this case preferably ranges from 2 to 100 mW/cm². More preferably, the highest irradiation intensity in the first step of multistep irradiation or in the whole irradiation process when irradiation intensity is discontinuously changed ranges from 10 to 100 mW/cm², and the lowest irradiation intensity in the second and later steps of multistep irradiation or when irradiation intensity is discontinuously changed ranges from 2 to 50 mW/cm². The total irradiation energy preferably ranges from 10 to 300 J, more preferably 50 to 250 J, still more preferably 100 to 250 J.

The applied voltage may be an alternating current or a direct current.

The active energy beam to be emitted preferably has a plurality of spectra and is preferably ultraviolet light with a plurality of spectra. Irradiation with an active energy beam with a plurality of spectra allows the two or more polymerizable compounds to be polymerized by an active energy beam with a spectrum (wavelength) suitable for their respective types, thereby efficiently forming an alignment control layer.

An alignment control layer that is formed of a polymer of the polymerizable compounds is not necessarily formed clearly between the first substrate 11 and the liquid crystal layer 13, for example. It is assumed that in the vicinity of the first substrate 11, an alignment control layer may also be formed from a surface of the first substrate 11 adjacent to the liquid crystal layer 13 (a surface facing the liquid crystal layer 13) into the liquid crystal layer 13. This is the same in the vicinity of the second substrate 12. An alignment control layer is not necessarily formed clearly between the second substrate 12 and the liquid crystal layer 13. In the vicinity of the second substrate 12, an alignment control layer may also be formed from a surface of the second substrate 12 adjacent to the liquid crystal layer 13 (a surface facing the liquid crystal layer 13) into the liquid crystal layer 13.

Active energy beam irradiation allows polymerizable compounds with similar structures in the two or more polymerizable compounds to be preferentially polymerized, allows liquid crystal molecules to be arranged in the vicinity of the substrate, and controls alignment with the pretilt direction being defined in a predetermined direction.

### EXAMPLES

Although the present invention will be more specifically described in the following examples and comparative examples, the present invention is not limited to these examples. The term “wt %” in the following examples and comparative examples refers to % by mass.

In the following examples and comparative examples, T_{NI}, Δn, Δε, and γ₁ are defined as follows:

T_{NI}: nematic phase-isotropic liquid phase transition temperature (° C.)

Δn: refractive index anisotropy at 20° C.

Δε: dielectric constant anisotropy at 20° C.

γ₁: rotational viscosity (mPa·s) at 20° C.

Residual monomers in liquid crystal display devices manufactured in the following examples and comparative examples were determined by the following method.

### (Measurement of Residual Monomer)

The proportion (ppm) of residual monomer to the amount of monomer in a liquid crystal composition before UV light irradiation was determined by chromatographically measuring the amount of monomer in a device manufactured by irradiation with UV light from a high-pressure mercury lamp for 1000 seconds.

The high-pressure mercury lamp was USH-500BY1 manufactured by Ushio Inc.

### Example 1

A first substrate (common electrode substrate) and a second substrate (pixel electrode substrate) were manufactured. The first substrate had a transparent electrode layer composed of a transparent common electrode and a color filter layer. The second substrate had a transparent pixel electrode that was driven by an active device. The pixel electrode had a slit for pixel division that forms four regions with different pretilt directions.

A liquid crystal composition LC-1 was prepared, which contained compounds corresponding to compounds represented by the general formulae (III) and (II) at ratios described below.

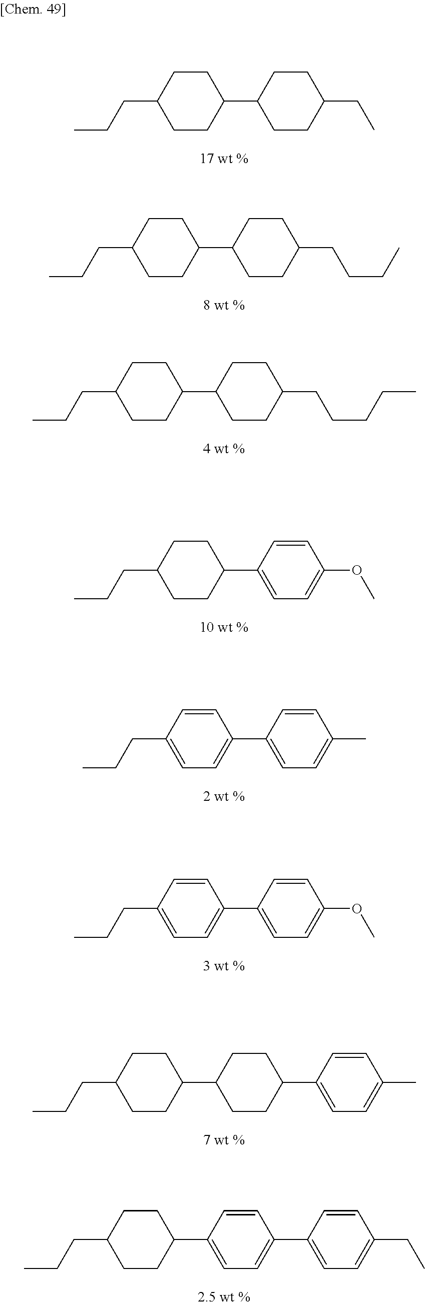

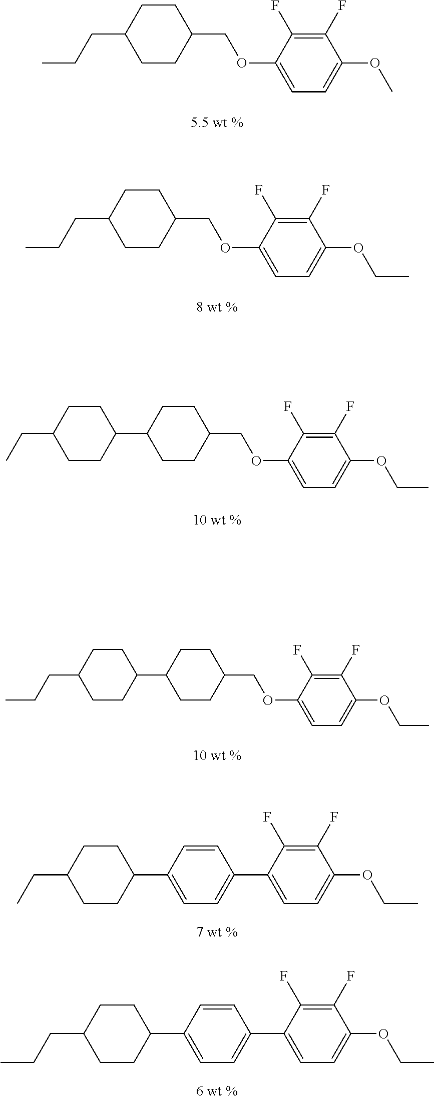

A compound represented by the following formula (0.4% by mass), which is a first polymerizable compound represented by the general formula (X1a),

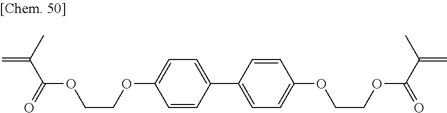

and a compound represented by the following formula (1.5% by mass), which is a second polymerizable compound represented by the general formula (X2a),

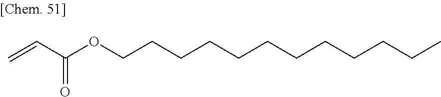

were then added to the liquid crystal composition LC-1 (98.0% by mass). A photopolymerization initiator “Igacure 651” (0.1% by mass) was also added to and uniformly dissolved in the liquid crystal composition LC-1 to prepare a polymerizable-compound-containing liquid crystal composition CLC-1.

The first substrate and the second substrate without an alignment film were then bonded together with a seal portion interposed therebetween. The polymerizable-compound-containing liquid crystal composition CLC-1 was then injected. The seal portion was cured to hold the polymerizable-compound-containing liquid crystal composition CLC-1. A spacer 3.9 μm in thickness was used to form a liquid crystal composition layer 3.9 μm in thickness.

The first polymerizable compound and the second polymerizable compound were then polymerized by irradiating the polymerizable-compound-containing liquid crystal composition with ultraviolet light while a voltage is applied. “USH-250BY” manufactured by Ushio Inc. was used as an ultraviolet irradiation apparatus. The ultraviolet light irradiation was performed at 100 mW for 1000 seconds.

A liquid crystal display device was thus manufactured.

Table 1 lists the physical properties and evaluation results of the liquid crystal display device. Table 1 shows that the amount of residual monomer in the liquid crystal display device was 0 ppm, and the polymerization was completed by UV irradiation for 1000 seconds. This proved that the polymerization was fast enough.

TABLE 1

| | |
|---|---|
| TNI/° C. | 75.3 |
| Δn | 0.092 |
| ne | 1.575 |
| no | 1.483 |
| ε// | 3.47 |
| ε⊥ | 6.72 |
| Δε | −3.25 |
| γ1/mPa · s | 109 |
| Residual monomer/ppm | 0 |

### Comparative Example 1

A first substrate (common electrode substrate) and a second substrate (pixel electrode substrate) were manufactured. The first substrate had a transparent electrode layer composed of a transparent common electrode and a color filter layer. The second substrate had a transparent pixel electrode that was driven by an active device. The pixel electrode had a slit for pixel division that forms four regions with different pretilt directions.

A liquid crystal composition LC-2 was prepared, which contained no compound represented by the general formula (III).

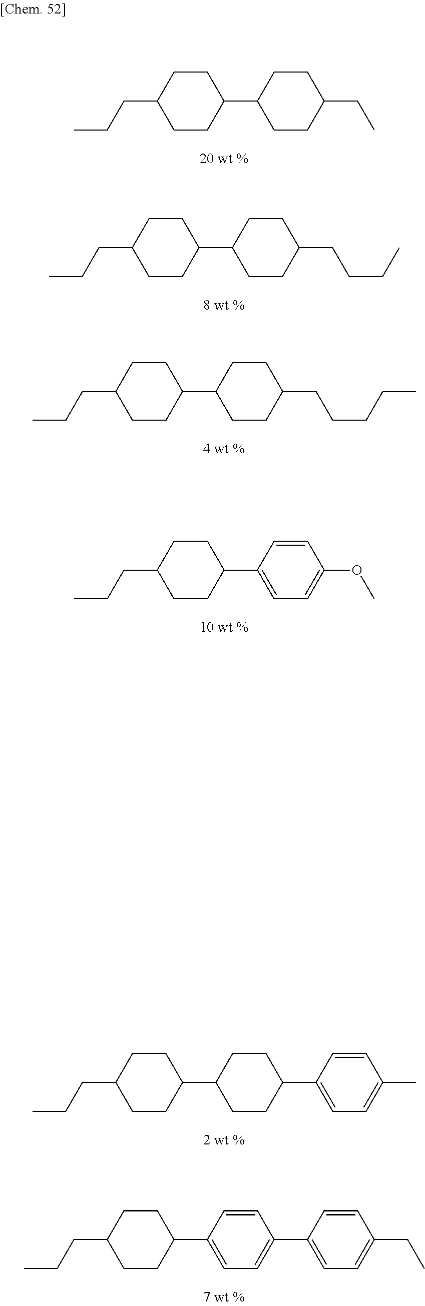

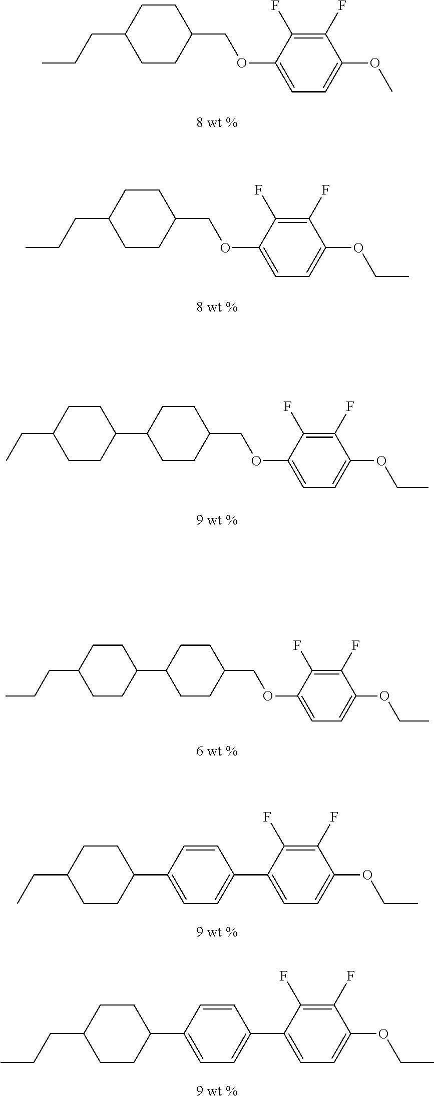

In the same manner as in Example 1, a compound represented by the following formula (0.4% by mass), which is a first polymerizable compound represented by the general formula (X1a),

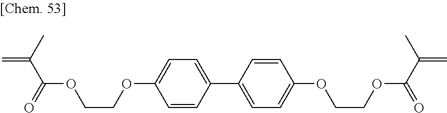

and a compound represented by the following formula (1.5% by mass), which is a second polymerizable compound represented by the general formula (X2a),

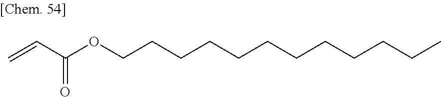

were then added to the liquid crystal composition LC-2 (98.0% by mass). A photopolymerization initiator “Igacure 651” (0.1% by mass) was also added to and uniformly dissolved in the liquid crystal composition LC-2 to prepare a polymerizable-compound-containing liquid crystal composition CLC-2.

The first substrate and the second substrate without an alignment film were then bonded together with a seal portion interposed therebetween. The polymerizable-compound-containing liquid crystal composition CLC-2 was then injected. The seal portion was cured to hold the polymerizable-compound-containing liquid crystal composition CLC-2. A spacer 3.9 μm in thickness was used to form a liquid crystal composition layer 3.9 μm in thickness.

The first polymerizable compound and the second polymerizable compound were then polymerized by irradiating the polymerizable-compound-containing liquid crystal composition with ultraviolet light while a voltage is applied. “USH-250BY” manufactured by Ushio Inc. was used as an ultraviolet irradiation apparatus. The ultraviolet light irradiation was performed at 100 mW for 1000 seconds.

A liquid crystal display device was thus manufactured.

Table 2 lists the physical properties and evaluation results of the liquid crystal display device. Table 2 shows that the amount of residual monomer in the liquid crystal display device was 1140 ppm. This indicates that the polymerizable compounds remained after UV irradiation for 1000 seconds, and polymerization was slower than in Example 1.

TABLE 2

| | |
|---|---|
| TNI/° C. | 74.5 |
| Δn | 0.092 |
| ne | 1.574 |
| no | 1.482 |
| ε// | 3.54 |
| ε⊥ | 6.86 |
| Δε | −3.32 |
| γ1/mPa · s | 113 |
| Residual monomer/ppm | 1140 |

### Example 2

A compound represented by the following formula (0.4% by mass), which is a first polymerizable compound represented by the general formula (X1a),

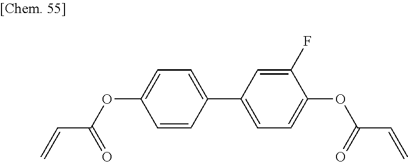

and a compound represented by the following formula (1.5% by mass), which is a second polymerizable compound represented by the general formula (X2a),

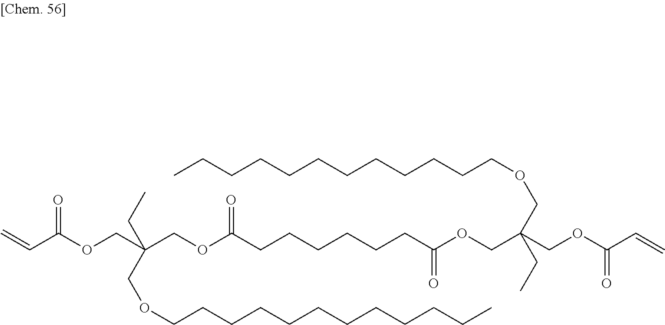

were added to the liquid crystal composition LC-1 (98.0% by mass) prepared in Example 1. A photopolymerization initiator “Igacure 651” (0.1% by mass) was also added to and uniformly dissolved in the liquid crystal composition LC-1 to prepare a polymerizable-compound-containing liquid crystal composition CLC-la. A liquid crystal display device was manufactured by the method described in Example 1.

Table 3 lists the physical properties and evaluation results of the liquid crystal display device. Table 3 shows that the amount of residual monomer in the liquid crystal display device was 0 ppm, and the polymerization was completed by UV irradiation for 1000 seconds. This proved that the polymerization was fast enough.

TABLE 3

| | |
|---|---|
| TNI/° C. | 75.3 |
| Δn | 0.092 |
| ne | 1.575 |
| no | 1.483 |
| ε// | 3.47 |
| ε⊥ | 6.72 |
| Δε | −3.25 |
| γ1/mPa · s | 109 |
| Residual monomer/ppm | 0 |

### Example 3

A compound represented by the following formula (0.4% by mass), which is a first polymerizable compound represented by the general formula (X1a),

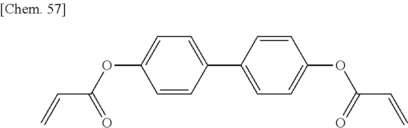

and a compound represented by the following formula (1.0% by mass), which is a second polymerizable compound represented by the general formula (X2b),

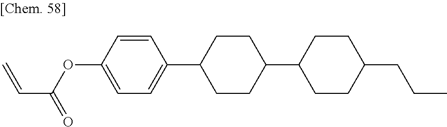

were added to the liquid crystal composition LC-1 (98.5% by mass) prepared in Example 1. A photopolymerization initiator “Igacure 651” (0.1% by mass) was also added to and uniformly dissolved in the liquid crystal composition LC-1 to prepare a polymerizable-compound-containing liquid crystal composition CLC-lb. A liquid crystal display device was manufactured by the method described in Example 1.

Table 4 lists the physical properties and evaluation results of the liquid crystal display device. Table 4 shows that the amount of residual monomer in the liquid crystal display device was 0 ppm, and the polymerization was completed by UV irradiation for 1000 seconds. This proved that the polymerization was fast enough.

TABLE 4

| | |
|---|---|
| TNI/° C. | 75.3 |
| Δn | 0.092 |
| ne | 1.575 |
| no | 1.483 |
| ε// | 3.47 |
| ε⊥ | 6.72 |
| Δε | −3.25 |
| γ1/mPa · s | 109 |
| Residual monomer/ppm | 0 |

### Example 4

A compound represented by the following formula (0.4% by mass), which is a first polymerizable compound represented by the general formula (X1a),

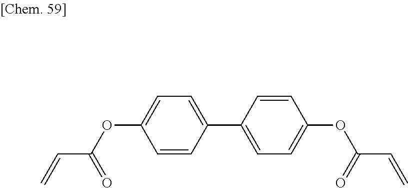

and a compound represented by the following formula (1.2% by mass), which is a second polymerizable compound represented by the general formula (X2d),

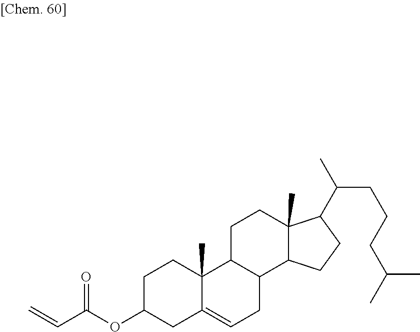

were added to the liquid crystal composition LC-1 (98.3% by mass) prepared in Example 1. A photopolymerization initiator “Igacure 651” (0.1% by mass) was also added to and uniformly dissolved in the liquid crystal composition LC-1 to prepare a polymerizable-compound-containing liquid crystal composition CLC-1c. A liquid crystal display device was manufactured by the method described in Example 1.

Table 5 lists the physical properties and evaluation results of the liquid crystal display device. Table 5 shows that the amount of residual monomer in the liquid crystal display device was 0 ppm, and the polymerization was completed by UV irradiation for 1000 seconds. This proved that the polymerization was fast enough.

TABLE 5

| | |
|---|---|
| TNI/° C. | 75.3 |
| Δn | 0.092 |
| ne | 1.575 |
| no | 1.483 |
| ε// | 3.47 |
| ε⊥ | 6.72 |
| Δε | −3.25 |
| γ1/mPa · s | 109 |
| Residual monomer/ppm | 0 |

### Example 5

A compound represented by the following formula (0.4% by mass), which is a first polymerizable compound represented by the general formula (X1a),

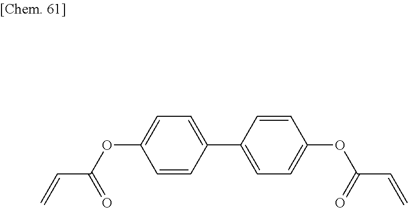

and a compound represented by the following formula (1.5% by mass), which is a second polymerizable compound represented by the general formula (X2a),

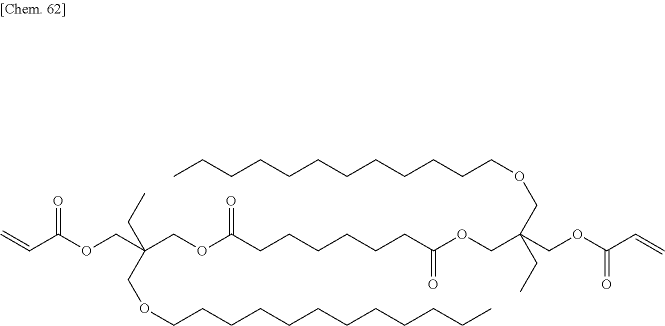

were added to the liquid crystal composition LC-1 (98.0% by mass) prepared in Example 1. A photopolymerization initiator “Igacure 651” (0.1% by mass) was also added to and uniformly dissolved in the liquid crystal composition LC-1 to prepare a polymerizable-compound-containing liquid crystal composition CLC-1d. A liquid crystal display device was manufactured by the method described in Example 1.

Table 6 lists the physical properties and evaluation results of the liquid crystal display device. Table 6 shows that the amount of residual monomer in the liquid crystal display device was 0 ppm, and the polymerization was completed by UV irradiation for 1000 seconds. This proved that the polymerization was fast enough.

TABLE 6

| | |
|---|---|
| TNI/° C. | 75.3 |
| Δn | 0.092 |
| ne | 1.575 |
| no | 1.483 |
| ε// | 3.47 |
| ε⊥ | 6.72 |
| Δε | −3.25 |
| γ1/mPa · s | 109 |
| Residual monomer/ppm | 0 |

### Example 6

A compound represented by the following formula (0.3% by mass), which is a first polymerizable compound represented by the general formula (X1a),

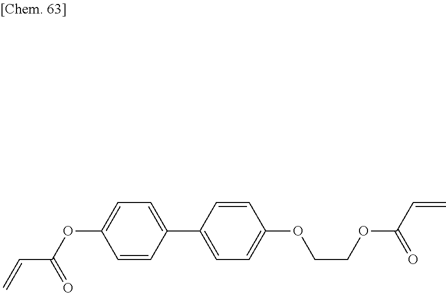

and a compound represented by the following formula (1.5% by mass), which is a second polymerizable compound represented by the general formula (X2a),

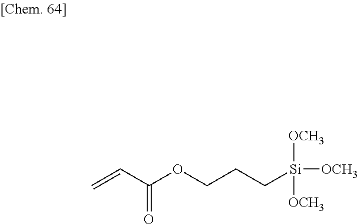

were added to the liquid crystal composition LC-1 (98.1% by mass) prepared in Example 1. A photopolymerization initiator “Igacure 651” (0.1% by mass) was also added to and uniformly dissolved in the liquid crystal composition LC-1 to prepare a polymerizable-compound-containing liquid crystal composition CLC-1e. A liquid crystal display device was manufactured by the method described in Example 1.

Table 7 lists the physical properties and evaluation results of the liquid crystal display device. Table 7 shows that the amount of residual monomer in the liquid crystal display device was 0 ppm, and the polymerization was completed by UV irradiation for 1000 seconds. This proved that the polymerization was fast enough.

TABLE 7

| | |
|---|---|
| TNI/° C. | 75.3 |
| Δn | 0.092 |
| ne | 1.575 |
| no | 1.483 |
| ε// | 3.47 |
| ε⊥ | 6.72 |
| Δε | −3.25 |
| γ1/mPa · s | 109 |
| Residual monomer/ppm | 0 |

### Example 7

A compound represented by the following formula (0.4% by mass), which is a first polymerizable compound represented by the general formula (X1a),

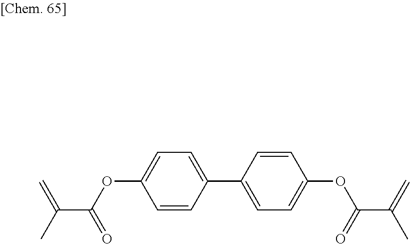

and a compound represented by the following formula (1.5% by mass), which is a second polymerizable compound represented by the general formula (X2a),

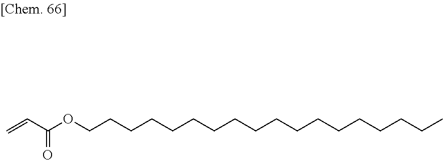

were added to the liquid crystal composition LC-1 (98.0% by mass) prepared in Example 1. A photopolymerization initiator “Igacure 651” (0.1% by mass) was also added to and uniformly dissolved in the liquid crystal composition LC-1 to prepare a polymerizable-compound-containing liquid crystal composition CLC-1f. A liquid crystal display device was manufactured by the method described in Example 1.

Table 8 lists the physical properties and evaluation results of the liquid crystal display device. Table 8 shows that the amount of residual monomer in the liquid crystal display device was 0 ppm, and the polymerization was completed by UV irradiation for 1000 seconds. This proved that the polymerization was fast enough.

TABLE 8

| | |
|---|---|
| TNI/° C. | 75.3 |
| Δn | 0.092 |
| ne | 1.575 |
| no | 1.483 |
| ε// | 3.47 |
| ε⊥ | 6.72 |
| Δε | −3.25 |
| γ1/mPa · s | 109 |
| Residual monomer/ppm | 0 |

### Example 8

A compound represented by the following formula (0.4% by mass), which is a first polymerizable compound represented by the general formula (X1a),

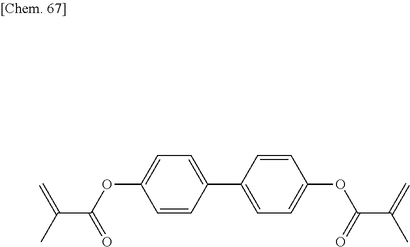

and a compound represented by the following formula (1.5% by mass), which is a second polymerizable compound represented by the general formula (X2a),

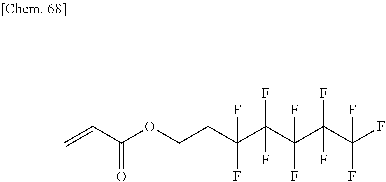

were added to the liquid crystal composition LC-1 (98.1% by mass) prepared in Example 1. A photopolymerization initiator “Igacure 651” (0.1% by mass) was also added to and uniformly dissolved in the liquid crystal composition LC-1 to prepare a polymerizable-compound-containing liquid crystal composition CLC-lg. A liquid crystal display device was manufactured by the method described in Example 1.

Table 9 lists the physical properties and evaluation results of the liquid crystal display device. Table 9 shows that the amount of residual monomer in the liquid crystal display device was 0 ppm, and the polymerization was completed by UV irradiation for 1000 seconds. This proved that the polymerization was fast enough.

TABLE 9

| | |
|---|---|
| TNI/° C. | 75.3 |
| Δn | 0.092 |
| ne | 1.575 |
| no | 1.483 |
| ε// | 3.47 |
| ε⊥ | 6.72 |
| Δε | −3.25 |
| γ1/mPa · s | 109 |
| Residual | 0 |
| monomer/ppm | |

### Example 9

A first substrate (common electrode substrate) and a second substrate (pixel electrode substrate) were manufactured. The first substrate had a transparent electrode layer composed of a transparent common electrode and a color filter layer. The second substrate had a transparent pixel electrode that was driven by an active device. The pixel electrode had a slit for pixel division that forms four regions with different pretilt directions.

A liquid crystal composition LC-3 was prepared, which contained compounds corresponding to compounds represented by the general formulae (III) and (II) at ratios described below.

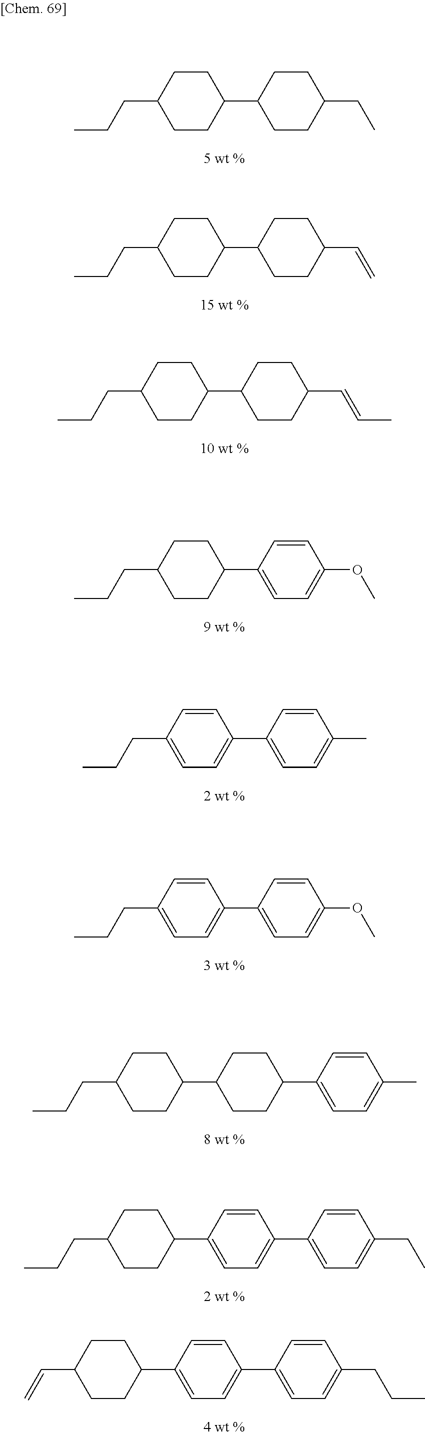

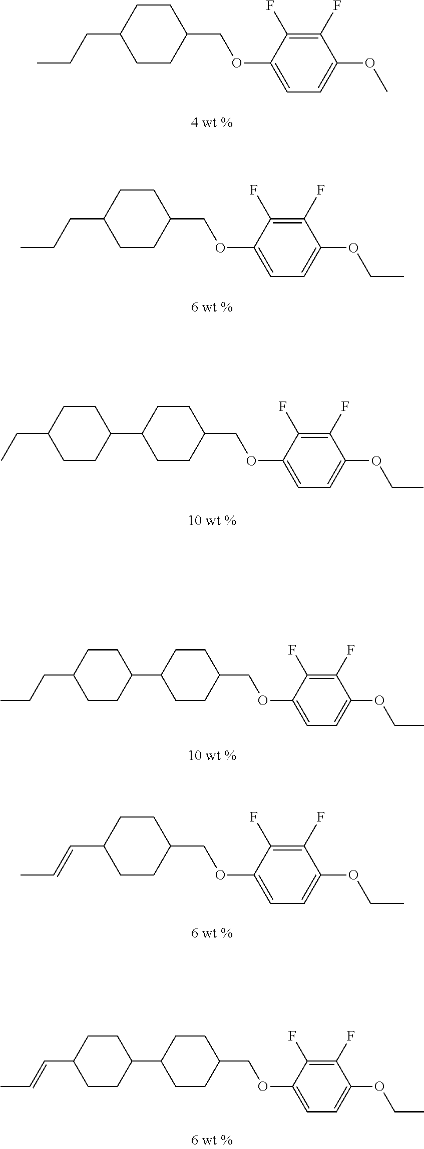

A compound represented by the following formula (0.4% by mass), which is a first polymerizable compound represented by the general formula (X1a),

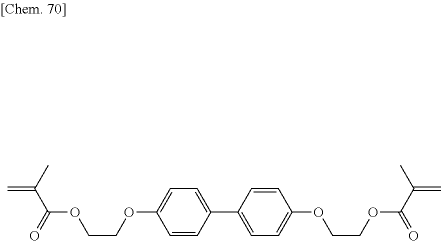

and a compound represented by the following formula (1.5% by mass), which is a second polymerizable compound represented by the general formula (X2a),

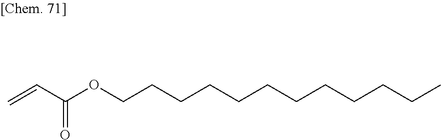

were then added to the liquid crystal composition LC-3 (98.0% by mass). A photopolymerization initiator “Igacure 651” (0.1% by mass) was also added to and uniformly dissolved in the liquid crystal composition LC-3 to prepare a polymerizable-compound-containing liquid crystal composition CLC-3.

The first substrate and the second substrate without an alignment film were then bonded together with a seal portion interposed therebetween. The polymerizable-compound-containing liquid crystal composition CLC-3 was then injected. The seal portion was cured to hold the polymerizable-compound-containing liquid crystal composition CLC-3. A spacer 3.9 μm in thickness was used to form a liquid crystal composition layer 3.9 μm in thickness.

The first polymerizable compound and the second polymerizable compound were then polymerized by irradiating the polymerizable-compound-containing liquid crystal composition with ultraviolet light while a voltage is applied. “USH-250BY” manufactured by Ushio Inc. was used as an ultraviolet irradiation apparatus. The ultraviolet light irradiation was performed at 100 mW for 1000 seconds.

A liquid crystal display device was thus manufactured.

Table 10 lists the physical properties and evaluation results of the liquid crystal display device. Table 10 shows that the amount of residual monomer in the liquid crystal display device was 0 ppm, and the polymerization was completed by UV irradiation for 1000 seconds. This proved that the polymerization was fast enough.

TABLE 10

| | |
|---|---|
| TNI/° C. | 76.0 |
| Δn | 0.092 |
| ne | 1.575 |
| no | 1.483 |
| ε// | 3.47 |
| ε⊥ | 6.68 |
| Δε | −3.21 |
| γ1/mPa · s | 105 |
| Residual | 0 |
| monomer/ppm | |

### Comparative Example 2

A first substrate (common electrode substrate) and a second substrate (pixel electrode substrate) were manufactured. The first substrate had a transparent electrode layer composed of a transparent common electrode and a color filter layer. The second substrate had a transparent pixel electrode that was driven by an active device. The pixel electrode had a slit for pixel division that forms four regions with different pretilt directions.

A liquid crystal composition LC-4 was prepared, which contained no compound represented by the general formula (III).

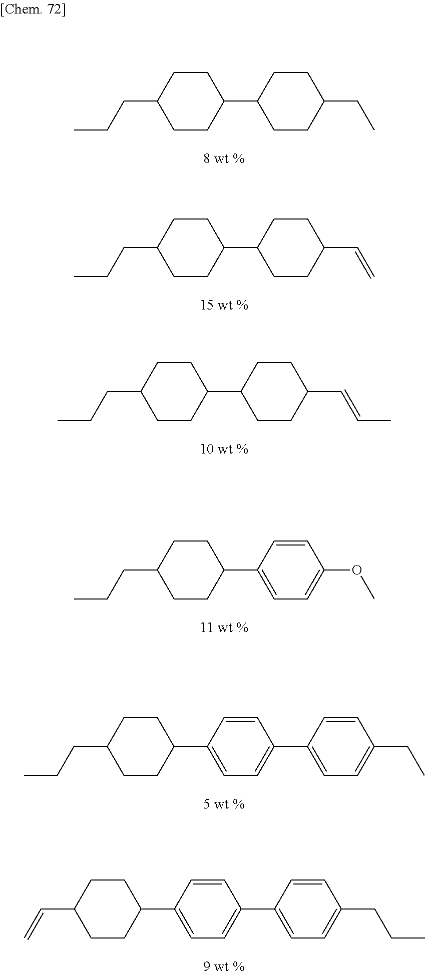

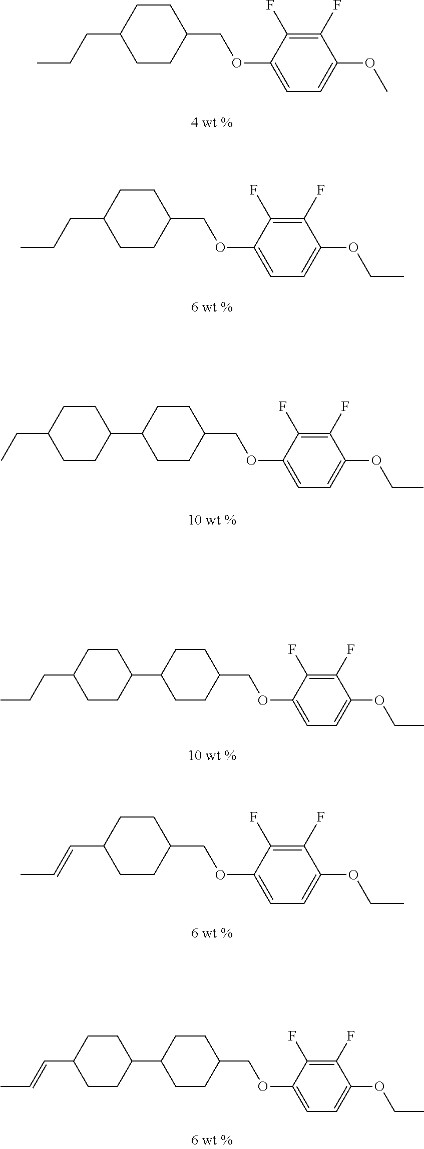

A compound represented by the following formula (0.4% by mass), which is a first polymerizable compound represented by the general formula (X1a),

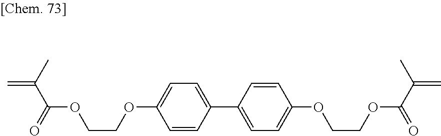

and a compound represented by the following formula (1.5% by mass), which is a second polymerizable compound represented by the general formula (X2a),

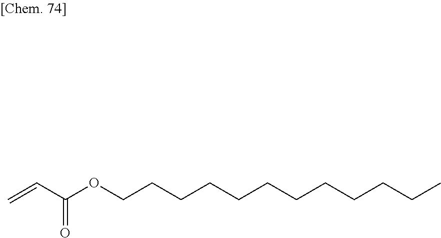

were then added to the liquid crystal composition LC-4 (98.0% by mass). A photopolymerization initiator “Igacure 651” (0.1% by mass) was also added to and uniformly dissolved in the liquid crystal composition LC-4 to prepare a polymerizable-compound-containing liquid crystal composition CLC-4.

The first substrate and the second substrate without an alignment film were then bonded together with a seal portion interposed therebetween. The polymerizable-compound-containing liquid crystal composition CLC-4 was then injected. The seal portion was cured to hold the polymerizable-compound-containing liquid crystal composition CLC-4. A spacer 3.9 μm in thickness was used to form a polymerizable-compound-containing liquid crystal composition 3.9 μm in thickness.

The first polymerizable compound and the second polymerizable compound were then polymerized by irradiating the polymerizable-compound-containing liquid crystal composition with ultraviolet light while a voltage is applied. “USH-250BY” manufactured by Ushio Inc. was used as an ultraviolet irradiation apparatus. The ultraviolet light irradiation was performed at 100 mW for 1000 seconds.

A liquid crystal display device was thus manufactured.

Table 11 lists the physical properties and evaluation results of the liquid crystal display device. Table 11 shows that the amount of residual monomer in the liquid crystal display device was 1900 ppm. This indicates that the polymerizable compounds remained after UV irradiation for 1000 seconds, and polymerization was slower than in Example 9.

TABLE 11

| | |
|---|---|
| TNI/° C. | 75.8 |
| Δn | 0.091 |
| ne | 1.574 |
| no | 1.483 |
| ε// | 3.49 |
| ε⊥ | 6.64 |
| Δε | −3.15 |
| γ1/mPa · s | 101 |
| Residual | |
| monomer/ppm | 1900 |

### Example 10

A compound represented by the following formula (0.4% by mass), which is a first polymerizable compound represented by the general formula (X1a),

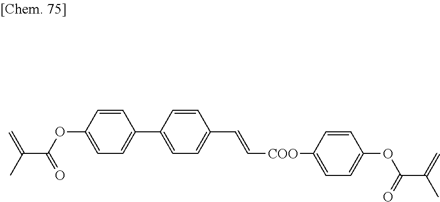

and a compound represented by the following formula (1.0% by mass), which is a second polymerizable compound represented by the general formula (X2b),

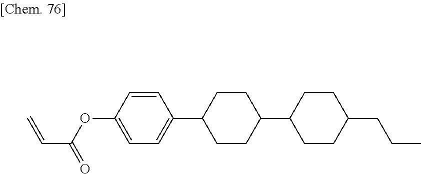

were added to the liquid crystal composition LC-3 (98.5% by mass) prepared in Example 9. A photopolymerization initiator “Igacure 651” (0.1% by mass) was also added to and uniformly dissolved in the liquid crystal composition LC-3 to prepare a polymerizable compound liquid crystal composition CLC-3a. A liquid crystal display device was manufactured by the method described in Example 9.

Table 12 lists the physical properties and evaluation results of the liquid crystal display device. Table 12 shows that the amount of residual monomer in the liquid crystal display device was 0 ppm, and the polymerization was completed by UV irradiation for 1000 seconds. This proved that the polymerization was fast enough.

TABLE 12

| | |
|---|---|
| TNI/° C. | 76.0 |
| Δn | 0.092 |
| ne | 1.575 |
| no | 1.483 |
| ε// | 3.47 |
| ε⊥ | 6.68 |
| Δε | −3.21 |
| γ1/mPa · s | 105 |
| Residual | 0 |
| monomer/ppm | |

### Example 11

A compound represented by the following formula (0.4% by mass), which is a first polymerizable compound represented by the general formula (X1a),

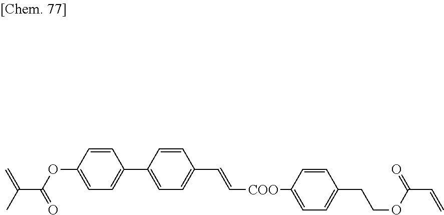

and a compound represented by the following formula (1.0% by mass), which is a second polymerizable compound represented by the general formula (X2a),

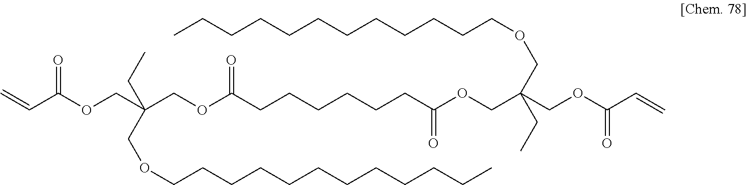

were added to the liquid crystal composition LC-3 (98.5% by mass) prepared in Example 9. A photopolymerization initiator “Igacure 651” (0.1% by mass) was also added to and uniformly dissolved in the liquid crystal composition LC-3 to prepare a polymerizable-compound-containing liquid crystal composition CLC-3b. A liquid crystal display device was manufactured by the method described in Example 9.

Table 13 lists the physical properties and evaluation results of the liquid crystal display device. Table 13 shows that the amount of residual monomer in the liquid crystal display device was 0 ppm, and the polymerization was completed by UV irradiation for 1000 seconds. This proved that the polymerization was fast enough.

TABLE 13

| | |
|---|---|
| TNI/° C. | 76.0 |
| Δn | 0.092 |
| ne | 1.575 |
| no | 1.483 |
| ε// | 3.47 |
| ε⊥ | 6.68 |
| Δε | −3.21 |
| γ1/mPa · s | 105 |
| Residual | 0 |
| monomer/ppm | |

### Example 12

A compound represented by the following formula (0.4% by mass), which is a first polymerizable compound represented by the general formula (X1a),

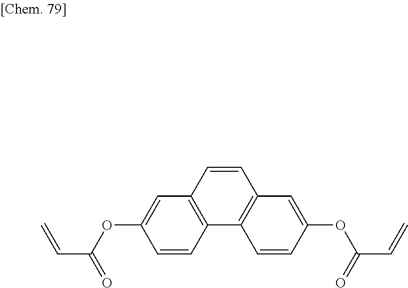

and a compound represented by the following formula (1.2% by mass), which is a second polymerizable compound represented by the general formula (X2d),

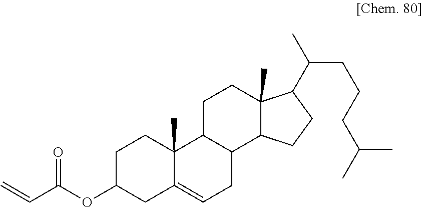

were added to the liquid crystal composition LC-3 (98.3% by mass) prepared in Example 9. A photopolymerization initiator “Igacure 651” (0.1% by mass) was also added to and uniformly dissolved in the liquid crystal composition LC-3 to prepare a polymerizable-compound-containing liquid crystal composition CLC-3c. A liquid crystal display device was manufactured by the method described in Example 9.

Table 14 lists the physical properties and evaluation results of the liquid crystal display device. Table 14 shows that the amount of residual monomer in the liquid crystal display device was 0 ppm, and the polymerization was completed by UV irradiation for 1000 seconds. This proved that the polymerization was fast enough.

TABLE 14

| | |
|---|---|
| TNI/° C. | 76.0 |
| Δn | 0.092 |
| ne | 1.575 |
| no | 1.483 |
| ε// | 3.47 |
| ε⊥ | 6.68 |
| Δε | −3.21 |
| γ1/mPa · s | 105 |
| Residual | 0 |
| monomer/ppm | |

### Example 13

A compound represented by the following formula (0.3% by mass), which is a first polymerizable compound represented by the general formula (X1a),

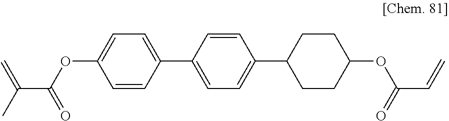

and a compound represented by the following formula (1.5% by mass), which is a second polymerizable compound represented by the general formula (X2a),

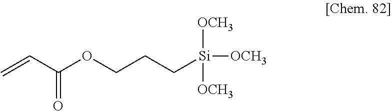

were added to the liquid crystal composition LC-3 (98.1% by mass) prepared in Example 9. A photopolymerization initiator “Igacure 651” (0.1% by mass) was also added to and uniformly dissolved in the liquid crystal composition LC-3 to prepare a polymerizable compound liquid crystal composition CLC-3d. A liquid crystal display device was manufactured by the method described in Example 9.

Table 15 lists the physical properties and evaluation results of the liquid crystal display device. Table 15 shows that the amount of residual monomer in the liquid crystal display device was 0 ppm, and the polymerization was completed by UV irradiation for 1000 seconds. This proved that the polymerization was fast enough.

TABLE 15

| | |
|---|---|
| TNI/° C. | 76.0 |
| Δn | 0.092 |
| ne | 1.575 |
| no | 1.483 |
| ε// | 3.47 |
| ε⊥ | 6.68 |
| Δε | −3.21 |
| γ1/mPa · s | 105 |
| Residual | 0 |
| monomer/ppm | |

### Example 14

A compound represented by the following formula (0.3% by mass), which is a first polymerizable compound represented by the general formula (X1a),

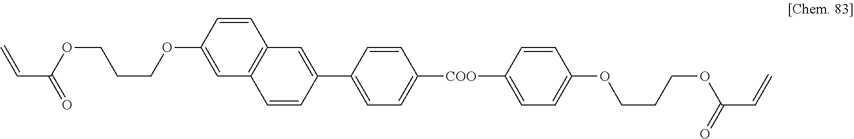

and a compound represented by the following formula (1.5% by mass), which is a second polymerizable compound represented by the general formula (X2a),

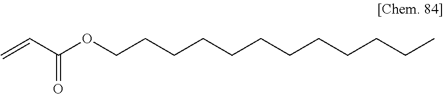

were added to the liquid crystal composition LC-3 (98.1% by mass) prepared in Example 9. A photopolymerization initiator “Igacure 651” (0.1% by mass) was also added to and uniformly dissolved in the liquid crystal composition LC-3 to prepare a polymerizable-compound-containing liquid crystal composition CLC-3e. A liquid crystal display device was manufactured by the method described in Example 9.

Table 16 lists the physical properties and evaluation results of the liquid crystal display device. Table 16 shows that the amount of residual monomer in the liquid crystal display device was 0 ppm, and the polymerization was completed by UV irradiation for 1000 seconds. This proved that the polymerization was fast enough.

TABLE 16

| | |
|---|---|
| TNI/° C. | 76.0 |
| Δn | 0.092 |
| ne | 1.575 |
| no | 1.483 |
| ε// | 3.47 |
| ε⊥ | 6.68 |
| Δε | −3.21 |
| γ1/mPa · s | 105 |
| Residual | 0 |
| monomer/ppm | |

### Example 15

A compound represented by the following formula (0.4% by mass), which is a first polymerizable compound represented by the general formula (X1a),

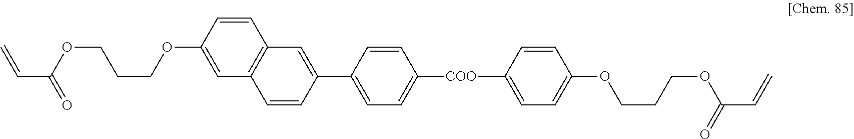

and a compound represented by the following formula (1.5% by mass), which is a second polymerizable compound represented by the general formula (X2a),

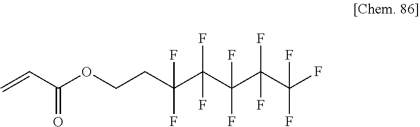

were added to the liquid crystal composition LC-3 (98.0% by mass) prepared in Example 9. A photopolymerization initiator “Igacure 651” (0.1% by mass) was also added to and uniformly dissolved in the liquid crystal composition LC-3 to prepare a polymerizable-compound-containing liquid crystal composition CLC-3f. A liquid crystal display device was manufactured by the method described in Example 9.

Table 17 lists the physical properties and evaluation results of the liquid crystal display device. Table 17 shows that the amount of residual monomer in the liquid crystal display device was 0 ppm, and the polymerization was completed by UV irradiation for 1000 seconds. This proved that the polymerization was fast enough.

TABLE 17

| | |
|---|---|
| TNI/° C. | 76.0 |
| Δn | 0.092 |
| ne | 1.575 |
| no | 1.483 |
| ε// | 3.47 |
| ε⊥ | 6.68 |
| Δε | −3.21 |
| γ1/mPa · s | 105 |
| Residual | 0 |
| monomer/ppm | |

### Example 16

A compound represented by the following formula (0.4% by mass), which is a first polymerizable compound represented by the general formula (X1a),

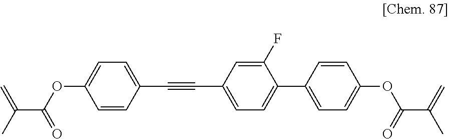

and a compound represented by the following formula (1.5% by mass), which is a second polymerizable compound represented by the general formula (X1b),

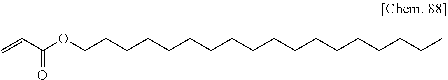

were added to the liquid crystal composition LC-3 (98.0% by mass) prepared in Example 9. A photopolymerization initiator “Igacure 651” (0.1% by mass) was also added to and uniformly dissolved in the liquid crystal composition LC-3 to prepare a polymerizable-compound-containing liquid crystal composition CLC-3g. A liquid crystal display device was manufactured by the method described in Example 9.

Table 18 lists the physical properties and evaluation results of the liquid crystal display device. Table 18 shows that the amount of residual monomer in the liquid crystal display device was 0 ppm, and the polymerization was completed by UV irradiation for 1000 seconds. This proved that the polymerization was fast enough.

TABLE 18

| | |
|---|---|
| TNI/° C. | 76.0 |
| Δn | 0.092 |
| ne | 1.575 |
| no | 1.483 |
| ε// | 3.47 |
| ε⊥ | 6.68 |
| Δε | −3.21 |
| γ1/mPa · s | 105 |
| Residual | 0 |
| monomer/ppm | |

### Example 17

A first substrate (common electrode substrate) and a second substrate (pixel electrode substrate) were manufactured. The first substrate had a transparent electrode layer composed of a transparent common electrode and a color filter layer. The second substrate had a transparent pixel electrode that was driven by an active device. The pixel electrode had a slit for pixel division that forms four regions with different pretilt directions.

A liquid crystal composition LC-5 was prepared, which contained compounds corresponding to compounds represented by the general formulae (III) and (II) at ratios described below.

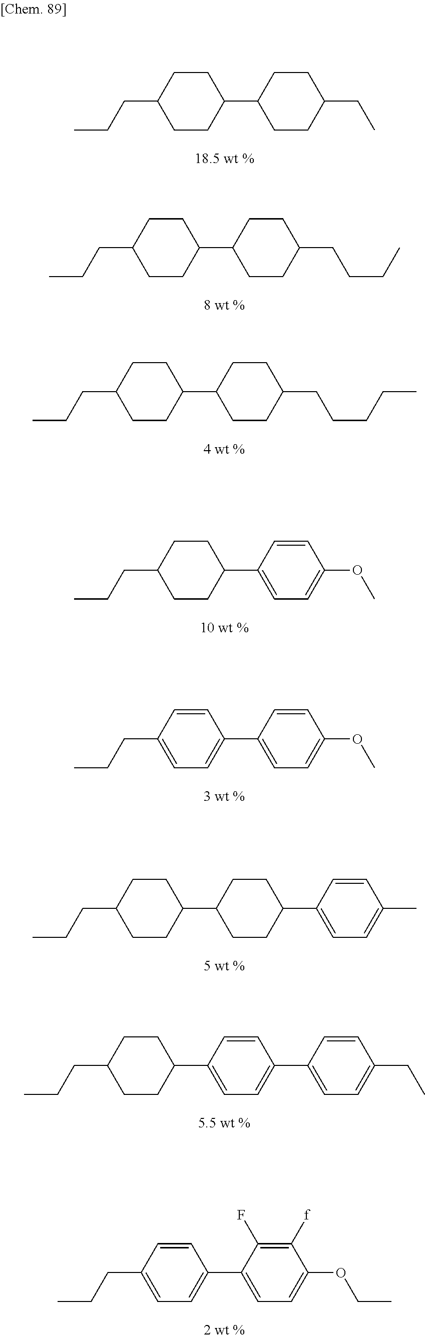

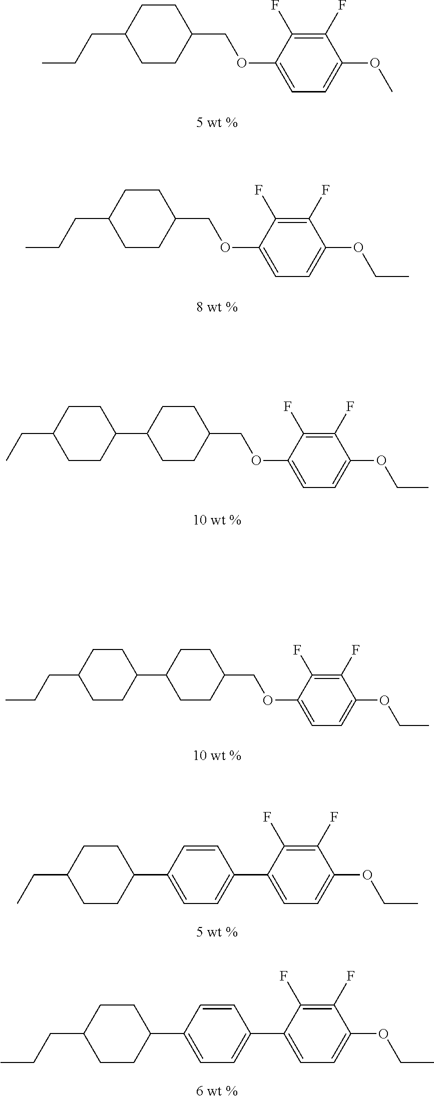

A compound represented by the following formula (0.4% by mass), which is a first polymerizable compound represented by the general formula (X1a),

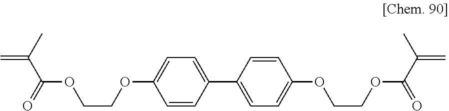

and a compound represented by the following formula (1.5% by mass), which is a second polymerizable compound represented by the general formula (X2a),

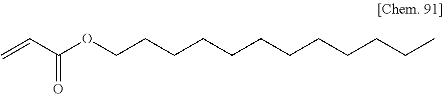

were then added to the liquid crystal composition LC-5 (98.0% by mass). A photopolymerization initiator “Igacure 651” (0.1% by mass) was also added to and uniformly dissolved in the liquid crystal composition LC-5 to prepare a polymerizable-compound-containing liquid crystal composition CLC-5.

The first substrate and the second substrate without an alignment film were then bonded together with a seal portion interposed therebetween. The polymerizable-compound-containing liquid crystal composition CLC-5 was then injected. The seal portion was cured to hold the polymerizable-compound-containing liquid crystal composition CLC-5. A spacer 3.9 μm in thickness was used to form a liquid crystal composition layer 3.9 μm in thickness.

The first polymerizable compound and the second polymerizable compound were then polymerized by irradiating the liquid crystal composition with ultraviolet light while a voltage is applied. “USH-250BY” manufactured by Ushio Inc. was used as an ultraviolet irradiation apparatus. The ultraviolet light irradiation was performed at 100 mW for 1000 seconds.

A liquid crystal display device was thus manufactured.

Table 19 lists the physical properties and evaluation results of the liquid crystal display device. Table 19 shows that the amount of residual monomer in the liquid crystal display device was 0 ppm, and the polymerization was completed by UV irradiation for 1000 seconds. This proved that the polymerization was fast enough.

TABLE 19

| | |
|---|---|
| TNI/° C. | 74.7 |
| Δn | 0.092 |
| ne | 1.575 |
| no | 1.483 |
| ε// | 3.47 |
| ε⊥ | 6.67 |
| Δε | −3.20 |
| γ1/mPa · s | 112 |
| Residual | 0 |
| monomer/ppm | |

### Example 18

A first substrate (common electrode substrate) and a second substrate (pixel electrode substrate) were manufactured. The first substrate had a transparent electrode layer composed of a transparent common electrode and a color filter layer. The second substrate had a transparent pixel electrode that was driven by an active device. The pixel electrode had a slit for pixel division that forms four regions with different pretilt directions.

A liquid crystal composition LC-6 was prepared, which contained compounds corresponding to compounds represented by the general formulae (III) and (II) at ratios described below.

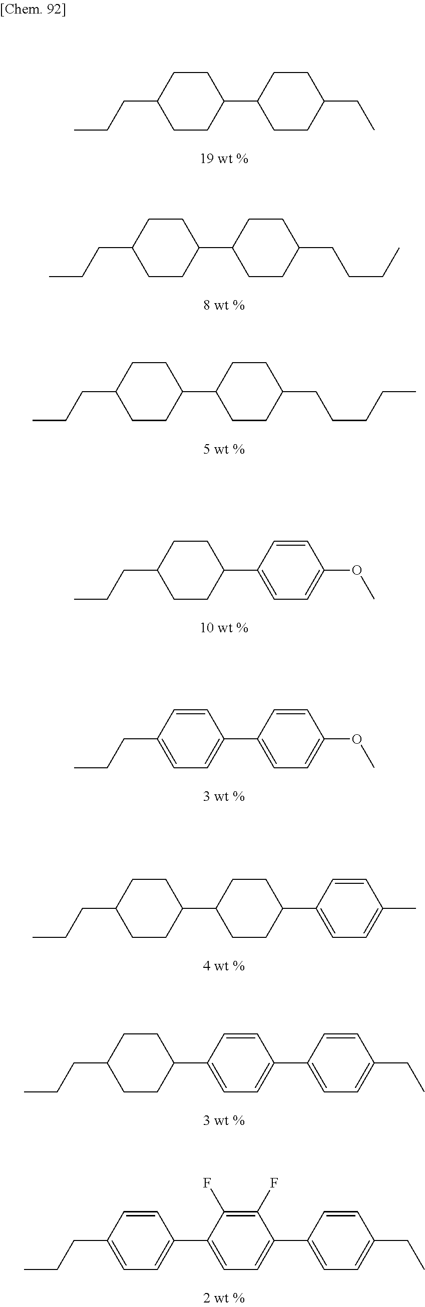

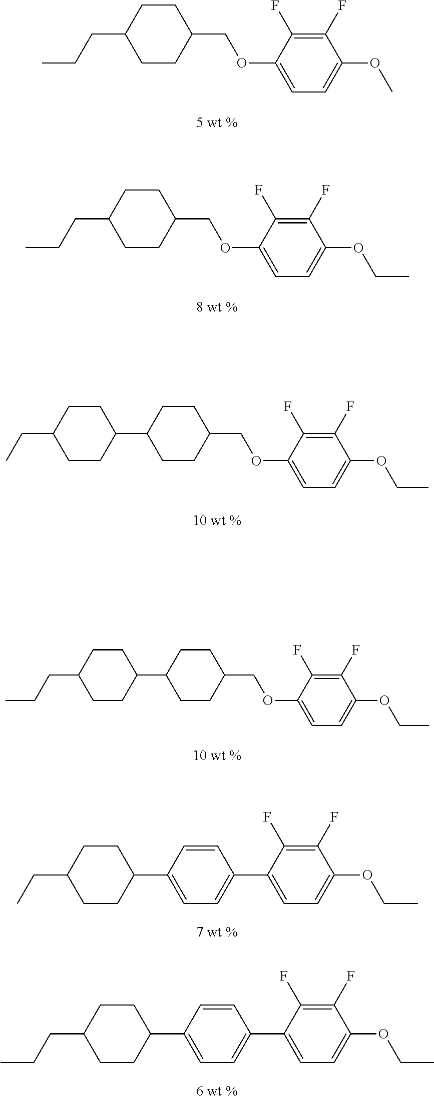

A compound represented by the following formula (0.4% by mass), which is a first polymerizable compound represented by the general formula (X1a),

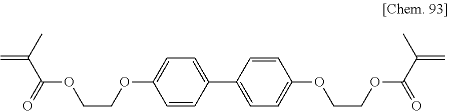

and a compound represented by the following formula (1.5% by mass), which is a second polymerizable compound represented by the general formula (X2a),

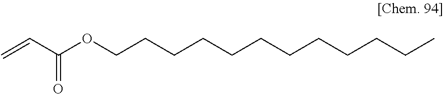

were then added to the liquid crystal composition LC-6 (98.0% by mass). A photopolymerization initiator “Igacure 651” (0.1% by mass) was also added to and uniformly dissolved in the liquid crystal composition LC-6 to prepare a polymerizable-compound-containing liquid crystal composition CLC-6.

The first substrate and the second substrate without an alignment film were then bonded together with a seal portion interposed therebetween. Without an alignment film, the polymerizable-compound-containing liquid crystal composition CLC-6 was then injected, and the seal portion was cured to hold the polymerizable-compound-containing liquid crystal composition CLC-6. A spacer 3.9 μm in thickness was used to form a liquid crystal composition layer 3.9 μm in thickness.

The first polymerizable compound and the second polymerizable compound were then polymerized by irradiating the polymerizable-compound-containing liquid crystal composition with ultraviolet light while a voltage is applied. “USH-250BY” manufactured by Ushio Inc. was used as an ultraviolet irradiation apparatus. The ultraviolet light irradiation was performed at 100 mW for 1000 seconds.

A liquid crystal display device was thus manufactured.

Table 20 lists the physical properties and evaluation results of the liquid crystal display device. Table 20 shows that the amount of residual monomer in the liquid crystal display device was 0 ppm, and the polymerization was completed by UV irradiation for 1000 seconds. This proved that the polymerization was fast enough.

TABLE 20

| | |
|---|---|
| TNI/° C. | 74.9 |
| Δn | 0.092 |
| ne | 1.574 |
| no | 1.482 |
| ε// | 3.48 |
| ε⊥ | 672.00 |
| Δε | −3.24 |
| γ1/mPa · s | 113 |
| Residual | 0 |
| monomer/ppm | |

### Example 19

A first substrate (common electrode substrate) and a second substrate (pixel electrode substrate) were manufactured. The first substrate had a transparent electrode layer composed of a transparent common electrode and a color filter layer. The second substrate had a transparent pixel electrode that was driven by an active device. The pixel electrode had a slit for pixel division that forms four regions with different pretilt directions.

A liquid crystal composition LC-7 was prepared, which contained compounds corresponding to compounds represented by the general formulae (III) and (II) at ratios described below.

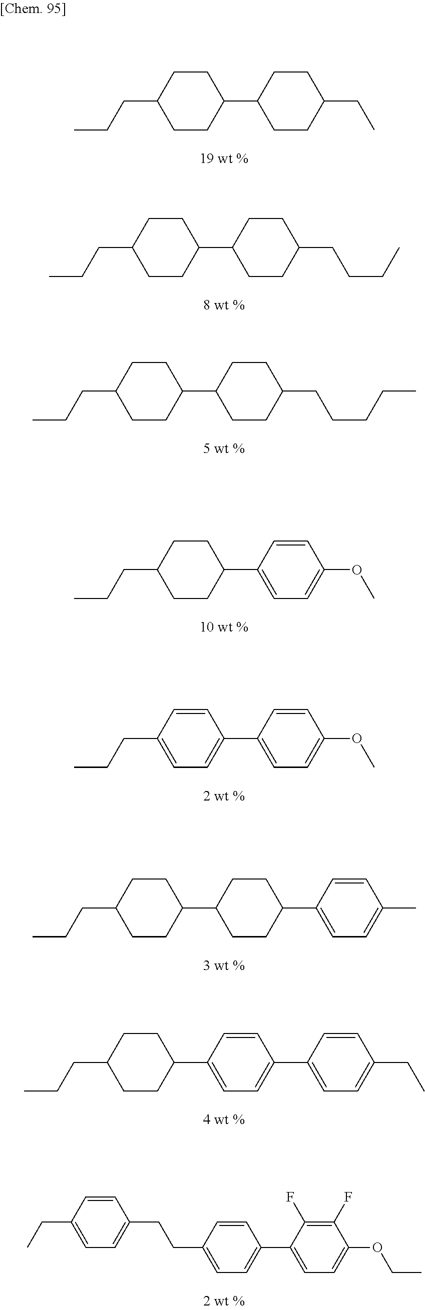

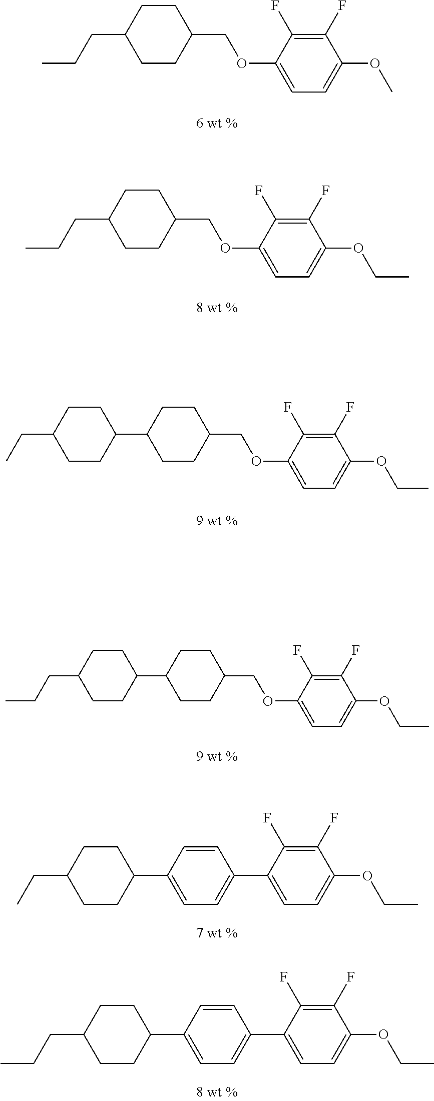

A compound represented by the following formula (0.4% by mass), which is a first polymerizable compound represented by the general formula (X1a),

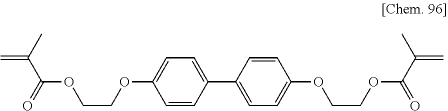

and a compound represented by the following formula (1.5% by mass), which is a second polymerizable compound represented by the general formula (X2a),

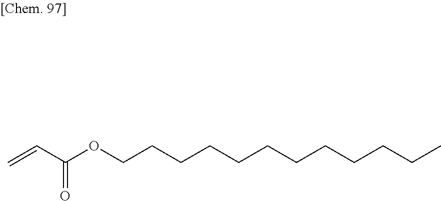

were then added to the liquid crystal composition LC-7 (98.0% by mass). A photopolymerization initiator “Igacure 651” (0.1% by mass) was also added to and uniformly dissolved in the liquid crystal composition LC-7 to prepare a polymerizable-compound-containing liquid crystal composition CLC-7.

The first substrate and the second substrate without an alignment film were then bonded together with a seal portion interposed therebetween. Without an alignment film, the polymerizable-compound-containing liquid crystal composition CLC-7 was then injected, and the seal portion was cured to hold the polymerizable-compound-containing liquid crystal composition CLC-7. A spacer 3.9 μm in thickness was used to form a liquid crystal composition layer 3.9 μm in thickness.

The first polymerizable compound and the second polymerizable compound were then polymerized by irradiating the polymerizable-compound-containing liquid crystal composition with ultraviolet light while a voltage is applied. “USH-250BY” manufactured by Ushio Inc. was used as an ultraviolet irradiation apparatus. The ultraviolet light irradiation was performed at 100 mW for 1000 seconds.

A liquid crystal display device was thus manufactured.

Table 21 lists the physical properties and evaluation results of the liquid crystal display device. Table 21 shows that the amount of residual monomer in the liquid crystal display device was 0 ppm, and the polymerization was completed by UV irradiation for 1000 seconds. This proved that the polymerization was fast enough.

TABLE 21

| | |
|---|---|
| TNI/° C. | 74.8 |
| Δn | 0.092 |
| ne | 1.574 |
| no | 1.482 |
| ε// | 3.48 |
| ε⊥ | 6.72 |
| Δε | −3.24 |
| γ1/mPa · s | 113 |
| Residual | 0 |
| monomer/ppm | |

### Example 20

A first substrate (common electrode substrate) and a second substrate (pixel electrode substrate) were manufactured. The first substrate had a transparent electrode layer composed of a transparent common electrode and a color filter layer. The second substrate had a transparent pixel electrode that was driven by an active device. The pixel electrode had a slit for pixel division that forms four regions with different pretilt directions.

A liquid crystal composition LC-8 was prepared, which contained compounds corresponding to compounds represented by the general formulae (III) and (II) at ratios described below.

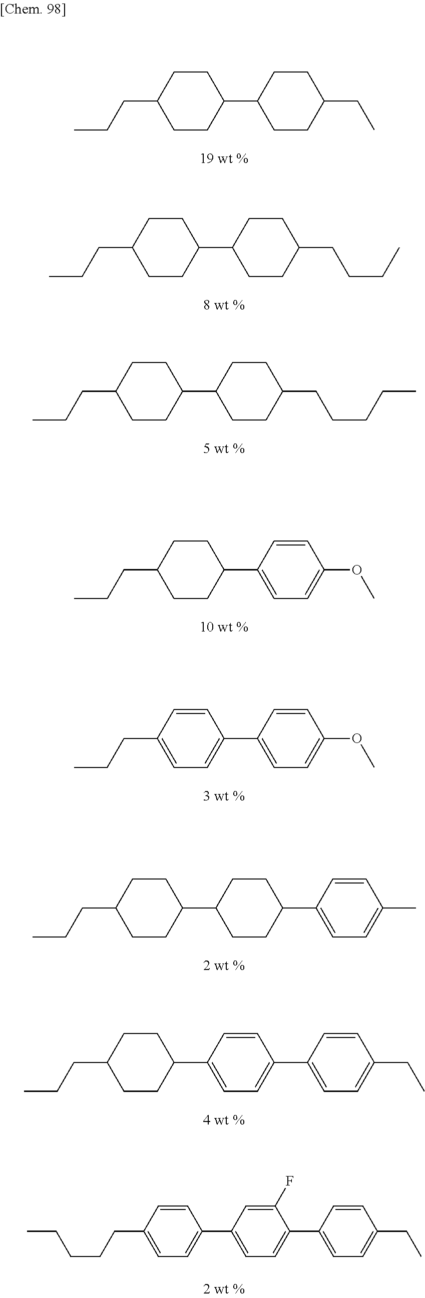

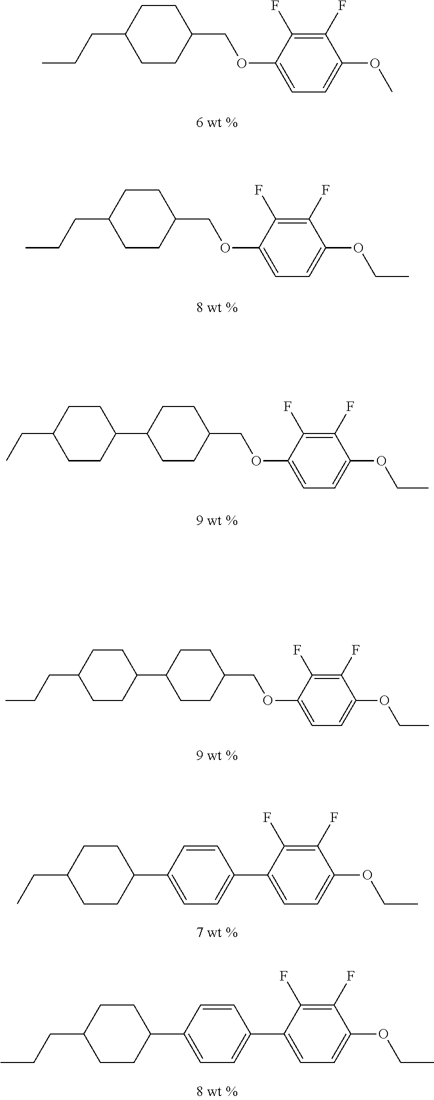

A compound represented by the following formula (0.4% by mass), which is a first polymerizable compound represented by the general formula (X1a),

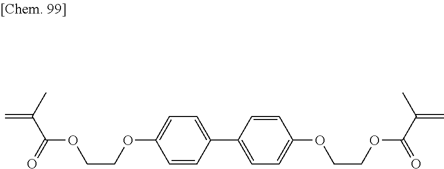

and a compound represented by the following formula (1.5% by mass), which is a second polymerizable compound represented by the general formula (X2a),

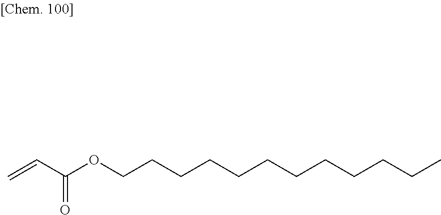

were then added to the liquid crystal composition LC-8 (98.0% by mass). A photopolymerization initiator “Igacure 651” (0.1% by mass) was also added to and uniformly dissolved in the liquid crystal composition LC-8 to prepare a polymerizable-compound-containing liquid crystal composition CLC-8.

The first substrate and the second substrate without an alignment film were then bonded together with a seal portion interposed therebetween. Without an alignment film, the polymerizable-compound-containing liquid crystal composition CLC-8 was then injected, and the seal portion was cured to hold the polymerizable-compound-containing liquid crystal composition CLC-8. A spacer 3.9 μm in thickness was used to form a liquid crystal composition layer 3.9 μm in thickness.

The first polymerizable compound and the second polymerizable compound were then polymerized by irradiating the polymerizable-compound-containing liquid crystal composition with ultraviolet light while a voltage is applied. “USH-250BY” manufactured by Ushio Inc. was used as an ultraviolet irradiation apparatus. The ultraviolet light irradiation was performed at 100 mW for 1000 seconds.

A liquid crystal display device was thus manufactured.

Table 22 lists the physical properties and evaluation results of the liquid crystal display device. Table 22 shows that the amount of residual monomer in the liquid crystal display device was 0 ppm, and the polymerization was completed by UV irradiation for 1000 seconds. This proved that the polymerization was fast enough.

TABLE 22

| | |
|---|---|
| TNI/° C. | 73.7 |
| Δn | 0.094 |
| ne | 1.577 |
| no | 1.483 |
| ε// | 3.50 |
| ε⊥ | 6.71 |
| Δε | −3.21 |
| γ1/mPa · s | 113 |
| Residual | 0 |
| monomer/ppm | |

### Example 21

A compound represented by the following formula (0.4% by mass), which is a first polymerizable compound represented by the general formula (X2a),

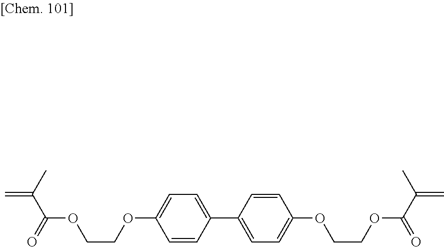

and a compound represented by the following formula (1.5% by mass), which is a second polymerizable compound represented by the general formula (X2a),

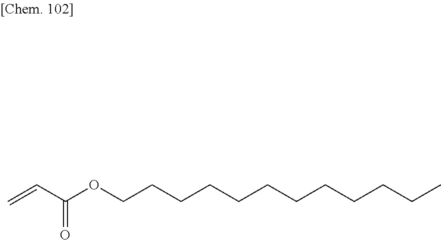

were added to the liquid crystal composition LC-1 (98.1% by mass) prepared in Example 1 and were uniformly dissolved to prepare a polymerizable-compound-containing liquid crystal composition CLC-1h.

The first substrate and the second substrate without an alignment film were then bonded together with a seal portion interposed therebetween. Without an alignment film, the polymerizable-compound-containing liquid crystal composition CLC-1h was then injected, and the seal portion was cured to hold the polymerizable-compound-containing liquid crystal composition CLC-1h. A spacer 3.9 μm in thickness was used to form a liquid crystal composition layer 3.9 μm in thickness.

The first polymerizable compound and the second polymerizable compound were then polymerized by irradiating the polymerizable-compound-containing liquid crystal composition with ultraviolet light while a voltage is applied. “USH-250BY” manufactured by Ushio Inc. was used as an ultraviolet irradiation apparatus. The ultraviolet light irradiation was performed at 100 mW for 1000 seconds.

A liquid crystal display device was thus manufactured.

Table 23 lists the physical properties and evaluation results of the liquid crystal display device. Table 23 shows that the amount of residual monomer in the liquid crystal display device was 0 ppm, and the polymerization was completed by UV irradiation for 1000 seconds. This proved that the polymerization was fast enough.

TABLE 23

| | |
|---|---|
| TNI/° C. | 75.3 |
| Δn | 0.092 |
| ne | 1.575 |
| no | 1.483 |
| ε// | 3.47 |
| ε⊥ | 6.72 |
| Δε | −3.25 |
| γ1/mPa · s | 109 |
| Residual | 0 |
| monomer/ppm | |

### REFERENCE SIGNS LIST

10 liquid crystal display device, 11 first substrate, second substrate, 13 liquid crystal layer, 14 common electrode, 15 pixel electrode, 18 color filter, 19 liquid crystal molecule

1. A liquid crystal display device comprising a liquid crystal layer between a first substrate and a second substrate, the first substrate having a common electrode, the second substrate having a plurality of pixels and having a pixel electrode in each pixel, the liquid crystal layer containing a liquid crystal composition,
wherein the liquid crystal display device has no alignment film on one or both of the first substrate and the second substrate but has an alignment control layer formed of a polymer of two or more polymerizable compounds, and
the liquid crystal composition contains a compound represented by a general formula (III) 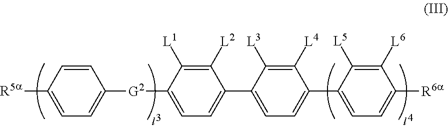
(wherein R^{5α} and R^{6α} independently represent an alkyl group having 1 to 8 carbon atoms, an alkenyl group having 2 to 8 carbon atoms, an alkoxy group having 1 to 8 carbon atoms, or an alkenyloxy group having 2 to 8 carbon atoms, 1³ and 1⁴ independently represent 0 or 1, G² represents a single bond, —CH₂CH₂—, —CH₂O—, —OCH₂—, —CF₂O—, or —OCF₂—, and L¹ to L⁶ independently represent a hydrogen atom or a fluorine atom)
and a compound represented by a general formula (II). 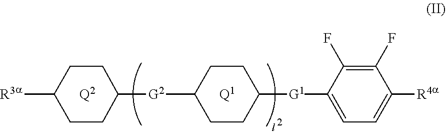
(wherein R^{3α} represents an alkyl group having 1 to 8 carbon atoms, an alkenyl group having 2 to 8 carbon atoms, an alkoxy group having 1 to 8 carbon atoms, or an alkenyloxy group having 2 to 8 carbon atoms, R^{4α} represents an alkyl group having 1 to 8 carbon atoms, an alkenyl group having 4 to 8 carbon atoms, an alkoxy group having 1 to 8 carbon atoms, or an alkenyloxy group having 3 to 8 carbon atoms, Q¹, if present, represents a 1,4-phenylene group or a trans-1,4-cyclohexylene group, Q² represents a trans-1,4-cyclohexylene group or a trans-1,4-cyclohexenylene group, G¹ represents —CH₂CH₂—, —CH₂O—, —OCH₂—, —CF₂O—, or —OCF₂—, G², if present, represents a single bond, —CH₂CH₂—, —CH₂O—, —OCH₂—, —CF₂O—, or —OCF₂—, 1² represents 0, 1, or 2, and if 1² is 2, then two Q's may be the same or different, and two G²s may be the same or different)

2. The liquid crystal display device according to claim 1, wherein the two or more polymerizable compounds includes at least one compound represented by a general formula (X1a) 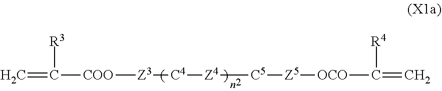
(wherein R³ and R⁴ independently represent a hydrogen atom or a methyl group,
C⁴ and C⁵ independently represent a 1,4-phenylene group, a 1,4-cyclohexylene group, a pyridine-2,5-diyl group, a pyrimidine-2,5-diyl group, a pyridazine-3,6-diyl group, a 1,3-dioxane-2,5-diyl group, a cyclohexene-1,4-diyl group, a decahydronaphthalene-2,6-diyl group, a 1,2,3,4-tetrahydronaphthalene-2,6-diyl group, a phenanthrene-2,7-diyl group, an anthracene-2,6-diyl group, a 2,6-naphthylene group, or an indan-2,5-diyl group (among these groups, one or two or more hydrogen atoms in the 1,4-phenylene group, the 1,2,3,4-tetrahydronaphthalene-2,6-diyl group, the 2,6-naphthylene group, and the indan-2,5-diyl group are independently optionally substituted with a fluorine atom, a chlorine atom, a methyl group, a trifluoromethyl group, or a trifluoromethoxy group),
Z³ and Z⁵ independently represent a single bond or an alkylene group having 1 to 15 carbon atoms (one or two or more methylene groups in the alkylene group are independently optionally substituted with an oxygen atom, —CO—, —COO—, or —OCO—, provided that oxygen atoms are not directly bonded to each other, and one or two or more hydrogen atoms in the alkylene group are independently optionally substituted with a fluorine atom, a methyl group, or an ethyl group),
Z⁴ represents a single bond, —CH₂CH₂—, —CH₂O—, —OCH₂—, —CH₂CH₂O—, —OCH₂CH₂—, —CH₂CH₂CH₂O—, —OCH₂CH₂CH₂—, —CH₂CH₂OCO—, —COOCH₂CH₂—, —CH₂CH₂COO—, —OCOCH₂CH₂—, —CH═CH—, —CH═CHCOO—, —OCOCH═CH—, —COO—, or —OCO—, and
n² represents 0, 1, or 2, and if n² is 2, then pluralities of C⁴s and Z⁴s may be the same or different C⁴s and Z⁴s, respectively)
and at least one selected from the group consisting of
a compound represented by the general formula (X2a), 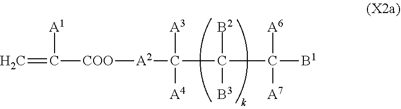
(wherein A¹ represents a hydrogen atom or a methyl group,
A² represents a single bond or an alkylene group having 1 to 15 carbon atoms (one or two or more methylene groups in the alkylene group are independently optionally substituted with an oxygen atom, —CO—, —COO—, or —OCO—, provided that oxygen atoms are not directly bonded to each other, and one or two or more hydrogen atoms in the alkylene group are independently optionally substituted with a fluorine atom, a methyl group, or an ethyl group),
A³ and A⁶ independently represent a hydrogen atom, a halogen atom, or an alkyl group having 1 to 18 carbon atoms (one or two or more methylene groups in the alkyl group are independently optionally substituted with an oxygen atom, —CO—, —COO—, or —OCO—, provided that oxygen atoms are not directly bonded to each other, and one or two or more hydrogen atoms in the alkyl group are independently optionally substituted with a halogen atom or an alkyl group having 1 to 17 carbon atoms),
A⁴ and A⁷ independently represent a hydrogen atom, a halogen atom, or an alkyl group having 1 to 10 carbon atoms (one or two or more methylene groups in the alkyl group are independently optionally substituted with an oxygen atom, —CO—, —COO—, or —OCO—, provided that oxygen atoms are not directly bonded to each other, and one or two or more hydrogen atoms in the alkyl group are independently optionally substituted with a halogen atom or an alkyl group having 1 to 9 carbon atoms),
k represents 1 to 40, and
B¹, B², and B³ independently represent a hydrogen atom, a linear or branched alkyl group having 1 to 10 carbon atoms (one or two or more methylene groups in the alkyl group are independently optionally substituted with an oxygen atom, —CO—, —COO—, or —OCO—, provided that oxygen atoms are not directly bonded to each other, and one or two or more hydrogen atoms in the alkyl group are independently optionally substituted with a halogen atom or a trialkoxysilyl group having 3 to 6 carbon atoms), or a group represented by a general formula (I-b), 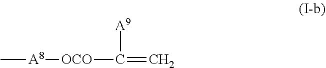
(wherein A⁹ represents a hydrogen atom or a methyl group, and
A⁸ represents a single bond or an alkylene group having 1 to 15 carbon atoms (one or two or more methylene groups in the alkylene group are independently optionally substituted with an oxygen atom, —CO—, —COO—, or —OCO—, provided that oxygen atoms are not directly bonded to each other, and one or two or more hydrogen atoms in the alkylene group are independently optionally substituted with a fluorine atom, a methyl group, or an ethyl group))
provided that the number of groups represented by the general formula (I-b) in B¹, B², and B³, if present, is 0 or 1)
a compound represented by the general formula (X2b), 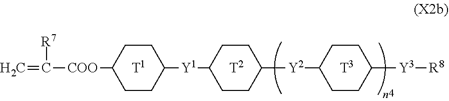
(wherein R⁷ represents a hydrogen atom or a methyl group, and
6-membered rings T¹, T², and T³ independently represent one of the following (m represents an integer in the range of 1 to 4), 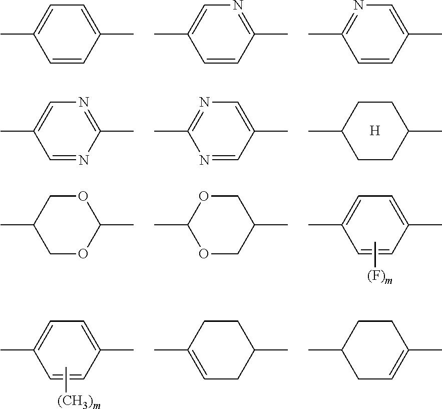
n⁴ represents 0 or 1,
Y¹ and Y² independently represent a single bond, —CH₂CH₂—, —CH₂O—, —OCH₂—, —COO—, —OCO—, —C≡C—, —CH═CH—, —CF═CF—, —(CH₂)₄—, —CH₂CH₂CH₂O—, —OCH₂CH₂CH₂—, —CH₂═CHCH₂CH₂—, or —CH₂CH₂CH═CH—,
Y³ represents a single bond, —O—, —COO—, or —OCO—, and
R⁸ represents a hydrocarbon group having 1 to 18 carbon atoms)
a compound represented by the general formula (X2c), and 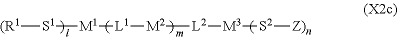
(wherein Z represents a hydrogen atom, an alkyl group having 1 to 8 carbon atoms, a halogenated alkyl group having 1 to 8 carbon atoms, an alkoxy group having 1 to 8 carbon atoms, a halogenated alkoxy group having 1 to 8 carbon atoms, halogen, a cyano group, a nitro group, or R², S¹ and S² independently represent an alkylene group having 1 to 12 carbon atoms or a single bond, and one —CH₂— or two or more nonadjacent —CH₂— groups in the alkylene group are optionally substituted with —O—, —COO—, —OCO—, or —OCOO—,
R¹ and R² independently represent a hydrogen atom or are independently represented by one of the formulae (R-1) to (R-15), 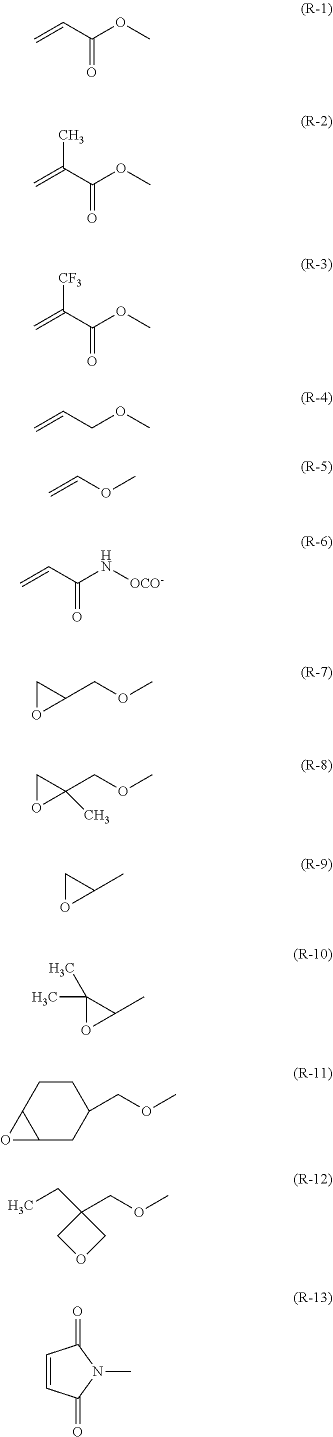 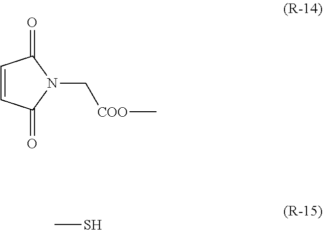
L¹ and L² independently represent a single bond, —O—, —S—, —CH₂—, —OCH₂—, —CH₂O—, —CO—, —C₂H₄—, —COO—, —OCO—, —OCOOCH₂—, —CH₂OCOO—, —OCH₂CH₂O—, —CO—NR^{a}—, —NR^{a}—CO—, —SCH₂—, —CH₂S—, —CH═CR^{a}—COO—, —CH═CR^{a}—OCO—, —COO—CR^{a}═CH—, —OCO—CR^{a}═CH—, —COO—CR^{a}═CH—COO—, —COO—CR^{a}═CH—OCO—, —OCO—CR^{a}═CH—COO—, —OCO—CR^{a}═CH—OCO—, —COOC₂H₄—, —OCOC₂H₄—, —C₂H₄OCO—, —(CH₂)ⱼ—C(═O)—O—, —(CH₂)ⱼ—O—(C═O)—, —O—(C═O)—(CH₂)ⱼ—, —(C═O)—O—(CH₂)ⱼ—, —CH₂OCO—, —COOCH₂—, —OCOCH₂—, —CH═CH—, —CF═CF—, —CF═CH—, —CH═CF—, —CF₂—, —CF₂O—, —OCF₂—, —CF₂CH₂—, —CH₂CF₂—, —CF₂CF₂—, or —C≡C— (wherein R^{a} independently represents a hydrogen atom or an alkyl group having 1 to 4 carbon atoms, and j represents an integer in the range of 1 to 4),
M¹ and M³ independently represent an aromatic ring or a aliphatic ring,
M² represents a 1,4-phenylene group, a 1,4-cyclohexylene group, a pyridine-2,5-diyl group, a pyrimidine-2,5-diyl group, a naphthalene-2,6-diyl group, a naphthalene-1,4-diyl group, a tetrahydronaphthalene-2,6-diyl group, or a 1,3-dioxane-2,5-diyl group,
M¹, M², and M³ are independently optionally unsubstituted or substituted with an alkyl group having 1 to 8 carbon atoms, a halogenated alkyl group having 1 to 8 carbon atoms, an alkoxy group having 1 to 8 carbon atoms, halogen, a cyano group, or a nitro group,
1 and n independently represent an integer of 0, 1, 2, or 3, and 1+n is an integer of 3 or more, if 1 is 0, then Z represents a group represented by one of the formulae (R-1) to (R-15), and if n is 0, then R¹ represents a group represented by one of the formulae (R-1) to (R-15), and
m represents an integer in the range of 0 to 4, pluralities of R¹s, R²s, Zs, S¹s, and S²s, if present, may be the same or different R¹s, R²s Zs, S¹s, and S²s, respectively, and pluralities of L¹s and M²s, if present, may be the same or different L¹s and M²s, respectively, provided that at least one of L¹s represents a single bond)
a compound represented by the general formula (X2d). 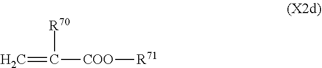
(wherein R⁷⁰ represents a hydrogen atom or a methyl group, and
R⁷¹ represents a hydrocarbon group having a fused ring)

3. The liquid crystal display device according to claim 1, wherein the pixel electrode has a slit.

4. The liquid crystal display device according to claim 1, wherein at least one of the first substrate and the second substrate has a structure that defines a pretilt direction.

5. The liquid crystal display device according to claim 1, further comprising a passivation film between the first substrate and the liquid crystal layer and/or between the second substrate and the liquid crystal layer.

6. The liquid crystal display device according to claim 1, further comprising a planarizing film between the first substrate and the liquid crystal layer and/or between the second substrate and the liquid crystal layer.

7. A method for manufacturing a liquid crystal display device including a liquid crystal layer between a first substrate and a second substrate, the first substrate having a common electrode and a color filter layer, the second substrate having a plurality of pixels and having a pixel electrode in each pixel, the liquid crystal layer containing a liquid crystal composition, each of the pixels having two or more regions with different pretilt directions,
wherein the liquid crystal display device has no alignment film on one or both of the first substrate and the second substrate but contains a polymerizable-compound-containing liquid crystal composition between the first substrate and the second substrate, the polymerizable-compound-containing liquid crystal composition containing a compound represented by a general formula (III) 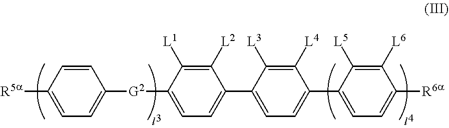
(wherein R^{5α} and R^{6α} independently represent an alkyl group having 1 to 8 carbon atoms, an alkenyl group having 2 to 8 carbon atoms, an alkoxy group having 1 to 8 carbon atoms, or an alkenyloxy group having 2 to 8 carbon atoms, 1³ and 1⁴ independently represent 0 or 1, G² represents a single bond, —CH₂CH₂—, —CH₂O—, —OCH₂—, —CF₂O—, or —OCF₂—, and L¹ to L⁶ independently represent a hydrogen atom or a fluorine atom)
and a compound represented by a general formula (II) 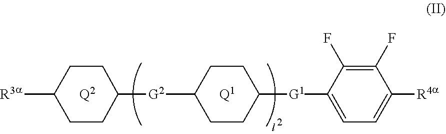
(wherein R^{3α} represents an alkyl group having 1 to 8 carbon atoms, an alkenyl group having 2 to 8 carbon atoms, an alkoxy group having 1 to 8 carbon atoms, or an alkenyloxy group having 2 to 8 carbon atoms, R^{4α} represents an alkyl group having 1 to 8 carbon atoms, an alkenyl group having 4 to 8 carbon atoms, an alkoxy group having 1 to 8 carbon atoms, or an alkenyloxy group having 3 to 8 carbon atoms, Q¹, if present, represents a 1,4-phenylene group or a trans-1,4-cyclohexylene group, Q² represents a trans-1,4-cyclohexylene group or a trans-1,4-cyclohexenylene group, G¹ represents —CH₂CH₂—, —CH₂O—, —OCH₂—, —CF₂O—, or —OCF₂—, G², if present, represents a single bond, —CH₂CH₂—, —CH₂O—, —OCH₂—, —CF₂O—, or —OCF₂—, 1² represents 0, 1, or 2, and if 1² is 2, then two Q's may be the same or different, and two G²s may be the same or different)
and containing two or more polymerizable compounds, and
the method comprising polymerizing the two or more polymerizable compounds by active energy beam irradiation while a voltage for providing a pretilt angle for liquid crystal molecules in the polymerizable-compound-containing liquid crystal composition is applied between the pixel electrode and the common electrode, and forming an alignment control layer between the first substrate and the second substrate and the liquid crystal layer using the polymerizable-compound-containing liquid crystal composition as the liquid crystal composition.

8. The method for manufacturing a liquid crystal display device according to claim 7, wherein the active energy beam is ultraviolet light with a plurality of spectra.

9. The method for manufacturing a liquid crystal display device according to claim 7, wherein the pixel electrode has a slit, or at least one of the first substrate and the second substrate has a structure that defines a pretilt direction.
